(19) United States
(12) Patent Application Publication
(10) Pub. No.: US 2010/0274592 A1
(43) Pub. Date: Oct. 28, 2010

(54) THERAPY MANAGEMENT SYSTEM

(75) Inventors: Tamir Nitzan, Canyon Country, CA (US); Jon Plummer, Los Angeles, CA (US); Joel Goldsmith, Studio City, CA (US); John J. Mastrototaro, Los Angeles, CA (US); Alan O. Marcus, Laguna Niguel, CA (US); Andrew C. Hayes, Simi Valley, CA (US); Matt Glidden, Simi Valley, CA (US); Gabe Cortina, Camarillo, CA (US)

Correspondence Address: Pillsbury Winthrop Shaw Pittman LLP, P.O. Box 10500, McLean, VA, 22102, US

(73) Assignee: MEDTRONIC MINIMED, INC., Northridge, CA (US)

(21) Appl. No.: 12/823,888

(22) Filed: Jun. 25, 2010

Related U.S. Application Data
(62) Division of application No. 11/581,664, filed on Oct. 16, 2006.
Application No. 11/581,664 is a continuation-in-part of application No. 11/145,485, filed on Jun. 3, 2005.

(51) Int. Cl. G06Q 50/00

(52) U.S. Cl. 705/3

(57) ABSTRACT

A diabetes data management system selects variable parameters and one or more devices with data that are utilized in a report. The diabetes data management system analyzes data during a selected period. The system generates reports which highlight data from one or more device during the selected period including carbohydrate, insulin, and glucose data, reports which highlight data around and during meal events and other user-defined events, reports which overlay multiple data based on time of day and other factors, and automatically prepared logbook reports.

### RELATED APPLICATION DATA

This is a divisional of patent application Ser. No. 11/581,664, filed Oct. 16, 2006, which is a continuation-in-part of application Ser. No. 11/145,485, filed on Jun. 3, 2005, which are herein incorporated by reference.

### FIELD OF THE INVENTION

This invention is directed to a selection of configurable parameters in a medical information management system. Specifically, this invention is directed to selection of devices for reading data into a software-based therapy management system and selection of parameters configurable for report generation. The invention is also directed to the generation of a series of clinically useful reports that combine data from multiple devices, such as insulin pumps, glucose meters, and continuous glucose monitoring sensors.

### BACKGROUND OF THE INVENTION

Traditionally, many modern programmable medical devices, for example, medical infusion pumps and analyte monitors, include internal memory for generating and storing data representing actual device operation over a period of time. The stored data may be reviewed from the medical device on a periodic basis by medical personnel, so that the subject's condition and treatment regimen can be closely monitored, and the medical device may be reprogrammed as needed. However, to retrieve data from certain prior medical devices, the subject would have been required to make regular visits to a medical treatment facility.

To overcome this drawback, raw data has been transferred from an infusion pump to another data storage and/or processing device. An example of a data transfer system for an infusion pump is disclosed in U.S. Pat. No. 5,376,070 issued Dec. 27, 1994 to Purvis et al. and is entitled “Data transfer System for an Infusion Pump,” which is herein incorporated by reference. This device relates to a relatively simple and effective data transfer system that is designed for retrieving data from, and sending program data to, a medication infusion pump. The data transfer system is particularly suited for remote data transfer and/or reprogramming of the infusion pump.

Another communication system for use with an infusion pump, analyte monitor, analyte meter or the like is described in published PCT application PCT/US99/22993, filed Sep. 30, 1999, filed Sep. 30, 1999 and entitled “Communication System and Software for Interfacing with an Infusion Pump, Analyze Monitor, Analyte Meter, or the Like,” which is herein incorporated by reference. That system includes a communication station having a cradle for receiving a pump, meter or monitor, and for interfacing with a personal computer or the like. By connecting the pump, meter or monitor in communication with a personal computer, programming and instructions may be communicated from the computer to the medical device and data may be transferred from the medical device to the computer.

### SUMMARY OF THE INVENTION

Embodiments of the invention relate to a diabetes data management system or a medical data management systems and processes for managing data relating to one or more medical or biological conditions of at least one (or a plurality of) subject(s). Examples of such systems and processes may be configured for diabetes subjects, cardiac subjects, cancer subjects, HIV subjects, subjects with other disease, infection or other controllable condition.

Embodiments of such systems and processes provide various functions for subject-users, and healthcare provider-users for improved treatment and medical data management for individual subjects and/or groups of subjects. For example, embodiments of the system allow collection and analysis of aggregate data from many subject sources, for improving overall healthcare practices for individual patients and/or groups of subjects.

According to embodiments of the present invention, a diabetes data management system may be configured with a group of software modules running on a computing device. Subject-users or healthcare provider-users may connect subject support devices (such as infusion pumps, meters, biological sensors, pacemakers, other electronic cardiactric aids or the like) to their user-side computers, for communicating information between the subject support devices and the diabetes data management system. In this manner, the system may collect and manage data from at least one user (and, in more comprehensive embodiments, from a plurality of users) and provide a number of services individually or inter-related to each other.

By utilizing the diabetes data management system, healthcare providers and subjects may readily store and later access medical information relating to the subjects, for example, to analyze historical information regarding a subject's biological condition, operation of the subject support device, treatment, treatment results, personal habits, or the like. Based on such historical data, the healthcare provider and/or subject may be able to recognize trends, beneficial practices, detrimental practices or the like and, thereby, adjust or design treatment plans that take advantage of beneficial trends and practices and avoids detrimental trends and practices.

The diabetes data management system may include software for generating or otherwise providing reports containing information received from a subject, a group of subjects or multiple groups of subjects. In this manner, a subject or a subject's healthcare provider may readily access formatted reports of information regarding the subject's condition, historical condition, the subject support device operation or condition, or the like, or similar information regarding one or more defined groups of subjects. The reports may be formatted in various pre-defined formats provided by the system. Alternatively or in addition, the system may allow users to design their own report format (including determining what type of information to include in the report and how the information is displayed). Systems have been developed for retrieving subject information from a subject's medical device, and presenting this information to users. Embodiments of the invention are directed a more comprehensive system capable of collecting and managing subject information for multiple subjects, the multiple subjects with a plurality of different types of medical devices (different manufacturers, different models from the same manufacturer or different functional devices).

Embodiments of the invention are directed to a system that allows for multiple blood glucose or sensor glucose target ranges to be established and modified, preferably for each meal event and other important timeframes. Embodiments of the invention are directed to establishing an adjustable target glucose range for a breakfast event, a lunch event, and/or a dinner event. Embodiments of the invention are directed to establishing an adjustable target glucose range for an evening timeframe and a sleeping timeframe.

Embodiments of the invention are directed to a system that allows a subject-user to establish adjustable analysis timeframes for analyzing subject data at different times before and after meal events (such as breakfast, lunch, or dinner). Embodiments of the invention are directed to generating reports that display the adjustable analysis timeframes for the different meal events. Embodiments of the invention are directed to generating glucose statistics for the analysis timeframes to allow the subject-user to better monitor his or her therapy.

Embodiments of the invention are directed to a system that allows a subject-user to select one or more devices, from which a therapy management system, such as a diabetes data management system, will receive data for report generation. In embodiments of the invention, the data is transformed into clinically useful information regarding a patient, for example, carbohydrate information indicating carbohydrates ingested by the patient, insulin information indicating insulin delivered to the patient, and glucose information indicating glucose readings from the patient. Embodiments of the invention are directed to generating reports that display the data from one or more devices. Embodiments of the invention are directed to generating reports that display information from infusion pumps, analyte meters, and continuous analyte sensors for a selected period in one report. Embodiments of the invention are directed to generating reports that overlay 24-hour information from one or more devices over a selected period of time. Embodiments of the invention are directed to generating reports that overlay information from one or more devices during meal events or other user-defined events, such as bedtime to wake-up events.

Embodiments of the invention are directed to generating reports that display types of boluses given to a patient during a particular period of time. Embodiments of the invention are directed to generating reports that display priming events of an infusion pump during a particular period of time. Embodiments of the invention are directed to generating automatic logbooks for a particular period of time.

### BRIEF DESCRIPTION OF THE DRAWINGS

FIG. 1 illustrates a computing device including a display housing a diabetes data management system according to an embodiment of the present invention;

FIG. 2(a) illustrates a flowchart for operation of a diabetes data management system according to an embodiment of the present invention;

FIG. 2(b) illustrates a flowchart for generating reports and selecting options in the diabetes data management system according to an embodiment of the present invention;

FIG. 2(c) illustrates a flowchart for generating reports and selecting options in a diabetes data management system according to an embodiment of the present invention;

FIG. 3 illustrates a parameter selection menu according to an embodiment of the invention;

FIG. 4 illustrates a close-up view of an advanced adjustable or configurable parameter selection section according to an embodiment of the present invention;

FIG. 5 illustrates a report to display sensor readings corresponding to meal events according to an embodiment of the present invention;

FIG. 5(a) illustrates a top section of the sensor overlay by meal event report according to an embodiment of the present invention;

FIG. 5(b) illustrates a bottom section of the sensor overlay by meal report according to an embodiment of the present invention;

FIG. 6 illustrates a sensor weekly logbook report according to an embodiment of the present invention; and

FIGS. 7(a) and 7(b) illustrates a top half and a bottom half of a sensor daily overlay report according to an embodiment of the present invention;

FIG. 8 illustrates an initial “login” menu or page of a medical data management system according to an embodiment of the present invention;

FIG. 9 illustrates a confirmation screen according to an embodiment of the present invention;

FIG. 10 illustrates a terms and privacy screen according to an embodiment of the present invention;

FIG. 11 illustrates an enrollment form menu according to an embodiment of the present invention;

FIG. 12 illustrates two menus for confirming enrollment and changing a password according to an embodiment of the invention;

FIGS. 13(a) and 13(b) shows a “reports available” menu that may be provided in response to a user's selection of an icon for generating or otherwise accessing reports according to an embodiment of the invention;

FIGS. 14 and 15 illustrate a pump settings report according to an embodiment of the present invention;

FIG. 16 is a representative example of a “daily summary” report according to an embodiment of the present invention;

FIG. 17 illustrates a hourly standard day glucose report according to an embodiment of the present invention;

FIG. 18 illustrates a period standard day glucose report according to an embodiment of the present invention;

FIG. 19 illustrates a trend summary report according to an embodiment of the present invention;

FIG. 20 illustrates a data table report according to an embodiment of the present invention;

FIG. 21 illustrates an initial upload menu according to an embodiment of the present invention;

FIG. 22 shows two further upload instruction pages in the series that may be provided to the user according to an embodiment of the present invention;

FIG. 23 shows another upload instruction menu or page in the series that may be provided to the user according to an embodiment of the present invention;

FIG. 24 illustrates a further upload instruction menu and an instruction menu according to an embodiment of the present invention;

FIG. 25 illustrates a further upload instruction menu or page and an connection instruction menu according to an embodiment of the present invention;

FIG. 26 illustrates a message menu displayed during system configuration and an instruction menu for selecting a communications port according to an embodiment of the present invention;

FIG. 27 illustrates meter selection menus according to an embodiment of the present invention;

FIG. 28 illustrates a further upload instruction menu or page and a meter manufacturer selection menu according to an embodiment of the present invention;

FIG. 29 illustrates an upload instruction menu displayed if a user selects a meter manufacturer icon and selection of a meter according to an embodiment of the present invention;

FIG. 30 illustrates a logbook menu and an “add carbohydrates entries” menu according to an embodiment of the present invention;

FIG. 31 illustrates an “update carbohydrates menu” and a “delete carbohydrates menu” according to an embodiment of the present invention;

FIG. 32 illustrates an “add exercise entries” menu and an “add HbAlc test result entry” menu according to an embodiment of the present invention;

FIG. 33 illustrates an infusion set change entry menu according to an embodiment of the present invention;

FIG. 34 illustrates a my info page menu according to an embodiment of the present invention;

FIG. 35 illustrates an earlier version of the parameter selection menu according to an embodiment of the present invention;

FIG. 36 illustrates a parameter selection menu according to an embodiment of the present invention;

FIG. 37 illustrates a parameter selection menu according to an embodiment of the present invention;

FIG. 38 illustrates a parameter selection menu according to an embodiment of the present invention;

FIG. 39 illustrates a parameter selection menu according to an embodiment of the present invention;

FIG. 40 illustrates a report parameter selection menu according to an embodiment of the present invention;

FIG. 41 illustrates a report generation parameter selection menu according to an embodiment of the present invention;

FIG. 42 illustrates an overview report according to an embodiment of the present invention;

FIG. 43A illustrates a daily detail report according to an embodiment of the present invention;

FIG. 43B illustrates a daily detail report according to an embodiment of the present invention;

FIG. 44 illustrates an adherence report according to an embodiment of the present invention;

FIG. 45 illustrates a logbook report according to an embodiment of the present invention;

FIG. 46 illustrates a sensor report according to an embodiment of the present invention;

FIG. 47 illustrates a pump settings snapshot report according to an embodiment of the present invention.

### DETAILED DESCRIPTION OF THE INVENTION

Embodiments of the invention are described below with reference to flowchart and menu illustrations of methods, apparatus, and computer program products. It will be understood that each block of the flowchart illustrations, and combinations of blocks in the flowchart illustrations, can be implemented by computer program instructions (as can any menu screens described in the Figures). These computer program instructions may be loaded onto a computer or other programmable data processing apparatus to produce a machine, such that the instructions which execute on the computer (or other programmable data processing apparatus) create instructions for implementing the functions specified in the flowchart block or blocks. These computer program instructions may also be stored in a computer-readable memory that can direct a computer (or other programmable data processing apparatus) to function in a particular manner, such that the instructions stored in the computer-readable memory produce an article of manufacture including instructions which implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks, and/or menus presented herein.

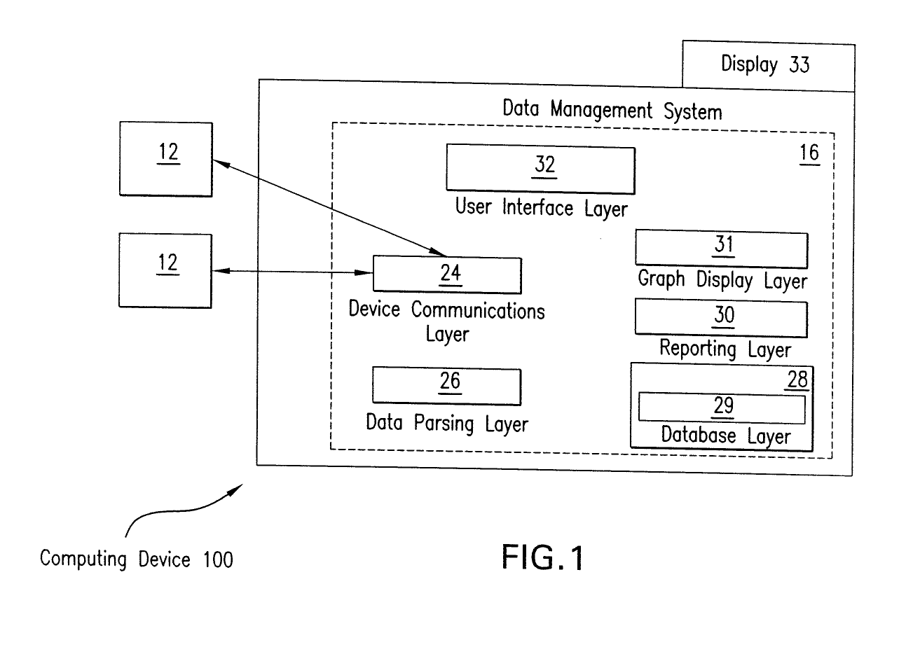

FIG. 1 illustrates a computing device including a display housing a diabetes data management system according to an embodiment of the present invention. The diabetes data management system (DDMS) may be referred to as the Medtronic MiniMed Carelink™ system or as a medical data management system (MDMS) in some embodiments of the invention. The DDMS may be housed on a server or a plurality of servers which a subject user or a health care professional may access via a communications network via the Internet or the World Wide Web. This model of the DDMS which is described as an MDMS is described in pending patent application Ser. No. 10/913,149 filed on Aug. 6, 2004, attorney docket number PF01137 US; F&L 047711-0336, which is incorporated by reference.

While description of embodiments of the invention below are made in regard to monitoring medical or biological conditions for subjects having diabetes, the systems and processes below are applicable to monitoring medical or biological conditions for cardiac subjects, cancer subjects, HIV subjects, subjects with other disease, infection, or controllable conditions, or various combinations thereof.

In an embodiment of the invention, the DDMS may be installed in a computing device in a health care provider's office, such as a doctor's office, a nurse's office, a clinic, an emergency room, an urgent care office. Health care providers may be reluctant to utilize a system where their confidential patient data is to be stored in a computing device such as a server on the Internet.

The DDMS may be installed on a computing device 100. The computing device 100 may be coupled to a display 33. In an embodiment of the invention, the computing device 100 may be in a physical device separate from the display (such as in a personal computer, a mini-computer, etc.) In an embodiment of the invention, the computing device 100 may be in a single physical enclosure or device with the display 33. such as a laptop where the display 33 is integrated into the computing device. In an embodiment of the invention, the computing device 100 hosting the DDMS may be, but is not limited to, a desktop computer, a laptop computer, a server, a network computer, a personal digital assistant (PDA), a portable telephone including computer functions, a pager with a large visible display, an insulin pump including a display, a glucose sensor including a display, a glucose meter including a display, and/or a combination insulin pump/glucose sensor having a display. The computing device may also be an insulin pump coupled to a display, a glucose meter coupled to a display, or a glucose sensor coupled to a display. The computing device 100 may also be a server located on the Internet that is accessible via a browser installed on a laptop computer, desktop computer, a network computer, or a PDA. The computing device 100 may also be a server located in a Doctor's office that is accessible via a browser installed on a portable computing device, e.g., laptop, PDA, network computer, portable phone, which has wireless capabilities and can communicate via one of the wireless communication protocols such as Bluetooth and IEEE 802.11 protocols.

In the embodiment shown in FIG. 1, the data management system 16 comprises a group of interrelated software modules or layers that specialize in different tasks. The system software includes a device communication layer 24, a data parsing layer 26, a database layer 28, database storage devices 29, a reporting layer 30, a graph display layer 31, and a user interface layer 32. The diabetes data management system may communicate with a plurality of subject support devices 12, two of which are illustrated in FIG. 1. Although the different reference numerals refer to a number of layers, (e.g., a device communication layer, a data parsing layer, a database layer), each layer may include a single software module or a plurality of software modules. For example, the device communications layer 24 may include a number of interacting software modules, libraries, etc. In an embodiment of the invention, the data management system 16 may be installed onto a non-volatile storage area (memory such as flash memory, hard disk, removable hard, DVD-RW, CD-RW) of the computing device 100. If the data management system 16 is selected or initiated, the system 16 may be loaded into a volatile storage (memory such as DRAM, SRAM, RAM, DDRAM) for execution.

The device communication layer 24 is responsible for interfacing with at least one, and, in further embodiments, to a plurality of different types of subject support devices 12, such as, for example, blood glucose meters, sensor glucose sensors, or an infusion pump. In one embodiment, the device communication layer 24 may be configured to communicate with a single type of subject support device 12. However, in more comprehensive embodiments, the device communication layer 24 is configured to communicate with multiple different types of subject support devices 12, such as devices made from multiple different manufacturers, multiple different models from a particular manufacturer and/or multiple different devices that provide different functions (such as infusion functions, sensing functions, metering functions, or combinations thereof). As described in more detail below, by providing an ability to interface with multiple different types of subject support devices 12, the diabetes data management system 16 may be collect data from a significantly greater number of discrete sources. Such embodiments may provide expanded and improved data analysis capabilities by including a greater number of subjects and groups of subjects in statistical or other forms of analysis that can benefit from larger amounts of sample data and/or greater diversity in sample data, and, thereby, improve capabilities of determining appropriate treatment parameters, diagnostics, or the like.

The device communication layer 24 allows the DDMS 16 to receive information from and transmit information to or from each subject support device 12 in the system 10. Depending upon the embodiment and context of use, the type of information that may be communicated between the system 16 and device 12 may include, but is not limited to, data, programs, updated software, education materials, warning messages, notifications, or the like. The device communication layer 24 may include suitable routines for detecting the type of subject support device 12 in communication with the system 16 and implementing appropriate communication protocols for that type of device 12. Alternatively or in addition, the subject support device 12 may communicate information in packets or other data arrangements, where the communication includes a preamble or other portion that includes device identification information for identifying the type of the subject support device. Alternatively, or in addition, the subject support device 12 may include suitable user-operable interfaces for allowing a user to enter information, such as by selecting an optional icon or text or other device identifier, that corresponds to the type of subject support device used by that user. Such information may be communicated to the system 16, through a network connection. In yet further embodiments, the system 16 may detect the type of subject support device 12 it is communicating with in the manner described above and then may send a message requiring the user to verify that the system 16 properly detected the type of subject support device being used by the user. For systems 16 that are capable of communicating with multiple different types of subject support devices 12, the device communication layer 24 may be capable of implementing multiple different communication protocols and selects a protocol that is appropriate for the detected type of subject support device.

The data-parsing layer 26 is responsible for validating the integrity of device data received and for inputting it correctly into a database 29. A cyclic redundancy check CRC process for checking the integrity of the received data may be employed. Alternatively, or in addition, data may be received in packets or other data arrangements, where preambles or other portions of the data include device type identification information. Such preambles or other portions of the received data may further include device serial numbers or other identification information that may be used for validating the authenticity of the received information. In such embodiments, the system 16 may compare received identification information with pre-stored information to evaluate whether the received information is from a valid source.

The database layer 28 may include a centralized database repository that is responsible for warehousing and archiving stored data in an organized format for later access, and retrieval. The database layer 28 operates with one or more data storage device(s) 29 suitable for storing and providing access to data in the manner described herein. Such data storage device(s) 29 may comprise, for example, one or more hard discs, optical discs, tapes, digital libraries or other suitable digital or analog storage media and associated drive devices, drive arrays or the like.

Data may be stored and archived for various purposes, depending upon the embodiment and environment of use. As described below, information regarding specific subjects and patent support devices may be stored and archived and made available to those specific subjects, their authorized healthcare providers and/or authorized healthcare payor entities for analyzing the subject's condition. Also, certain information regarding groups of subjects or groups of subject support devices may be made available more generally for healthcare providers, subjects, personnel of the entity administering the system 16 or other entities, for analyzing group data or other forms of conglomerate data.

Embodiments of the database layer 28 and other components of the system 16 may employ suitable data security measures for securing personal medical information of subjects, while also allowing non-personal medical information to be more generally available for analysis. Embodiments may be configured for compliance with suitable government regulations, industry standards, policies or the like, including, but not limited to the Health Insurance Portability and Accountability Act of 1996 (HIPAA).

The database layer 28 may be configured to limit access of each user to types of information pre-authorized for that user. For example, a subject may be allowed access to his or her individual medical information (with individual identifiers) stored by the database layer 28, but not allowed access to other subject's individual medical information (with individual identifiers). Similarly, a subject's authorized healthcare provider or payor entity may be provided access to some or all of the subject's individual medical information (with individual identifiers) stored by the database layer 28, but not allowed access to another individual's personal information. Also, an operator or administrator-user (on a separate computer communicating with the computing device 100) may be provided access to some or all subject information, depending upon the role of the operator or administrator. On the other hand, a subject, healthcare provider, operator, administrator or other entity, may be authorized to access general information of unidentified individuals, groups or conglomerates (without individual identifiers) stored by the database layer 28 in the data storage devices 29.

In embodiments of the invention, the database layer 28 may store preference profiles. In the database layer 28, for example, each user may store information regarding specific parameters that correspond to the subject-user. Illustratively, these parameters could include target blood glucose or sensor glucose levels, what type of equipment the users utilize (insulin pump, glucose sensor, blood glucose meter, etc.) and could be stored in a record, a file, or a memory location in the data storage device(s) 29 in the database layer. Illustratively, these parameters could also include analysis times for each of the meal events.

The DDMS 16 may measure, analyze, and track either blood glucose (BG) or sensor glucose (SG) readings for a subject-user. In embodiments of the invention, the medical data management system may measure, track, or analyze both BG and SG readings for the subject-user. Accordingly, although certain reports may mention or illustrate BG or SG only, the reports may monitor and display results for the other one of the glucose readings or for both of the glucose readings.

The reporting layer 30 may include a report wizard program that pulls data from selected locations in the database 28 and generates report information from the desired parameters of interest. The reporting layer 30 may be configured to generate multiple different types of reports, each having different information and/or showing information in different formats (arrangements or styles), where the type of report may be selectable by the user. A plurality of pre-set types of report (with pre-defined types of content and format) may be available and selectable by a user. At least some of the pre-set types of reports may be common, industry standard report types with which many healthcare providers should be familiar.

In an embodiment of the invention, the database layer 28 may calculate values for various medical information that is to be displayed on the reports generated by the report or reporting layer 30. For example, the database layer 28, may calculate average blood glucose or sensor glucose readings for specified timeframes. In an embodiment of the invention, the reporting layer 30 may calculate values for medical or physical information that is to be displayed on the reports. For example, a subject-user may select parameters which are then utilized by the reporting layer 30 to generate medical information values corresponding to the selected parameters. In other embodiments of the invention, the subject-user may select a parameter profile that previously existed in the database layer 28.

Alternatively, or in addition, the report wizard may allow a user to design a custom type of report. For example, the report wizard may allow a user to define and input parameters (such as parameters specifying the type of content data, the time period of such data, the format of the report, or the like) and may select data from the database and arrange the data in a printable or displayable arrangement, based on the user-defined parameters. In further embodiments, the report wizard may interface with or provide data for use by other programs that may be available to users, such as common report generating, formatting or statistical analysis programs such as, but not limited to, EXCEL™, or the like. In this manner, users may import data from the system 16 into further reporting tools familiar to the user. The reporting layer 30 may generate reports in displayable form to allow a user to view reports on a standard display device, printable form to allow a user to print reports on standard printers, or other suitable forms for access by a user. Embodiments may operate with conventional file format schemes for simplifying storing, printing and transmitting functions, including, but not limited to PDF, JPEG, or the like. Illustratively, a subject-user may select a type of report and parameters for the report and the reporting layer 30 may create the report in a .pdf format. A .pdf plug-in may be initiated to help create the report and also to allow the subject-user to view the report. Under these operating conditions, the subject-user may print the report utilizing the .pdf plug-in. In certain embodiments in which security measures are implemented, for example, to meet government regulations, industry standards or policies that restrict communication of subject's personal information, some or all reports may be generated in a form (or with suitable software controls) to inhibit printing, or electronic transfer (such as a non-printable and/or non-capable format). In yet further embodiments, the system 16 may allow a user generating a report to designate the report as non-printable and/or non-transferable, whereby the system 16 will provide the report in a form that inhibits printing and/or electronic transfer.

The reporting layer 30 may transfer selected reports to the graph display layer 31. The graph display layer 31 receives information regarding the selected reports and converts the data into a format that can be displayed or shown on a display 33.

In an embodiment of the invention, the reporting layer 30 may store a number of the subject-user's parameters. Illustratively, the reporting layer 30 may store the type of carbohydrate units, a hypo blood glucose or sensor glucose reading, a carbohydrate conversion factor, and timeframes for specific types of reports. These examples are meant to be illustrative and not limiting.

Data analysis and presentations of the reported information may be employed to develop and support diagnostic and therapeutic parameters. Where information on the report relates to an individual subject, the diagnostic and therapeutic parameters may be used to assess the health status and relative well being of that subject, as well as to develop or modify treatment for the subject. Where information on the report relates to groups of subjects or conglomerates of data, the diagnostic and therapeutic parameters may be used to assess the health status and relative well being of groups of subjects with similar medical conditions, such as, but not limited to, diabetic subjects, cardiac subjects, diabetic subjects having a particular type of diabetes or cardiac condition, subjects of a particular age, sex or other demographic group, combinations thereof, or the like.

The user interface layer 32 supports interactions with the end user, for example, for user login and data access, software navigation, user data input, user selection of desired report types and the display of selected information. Subject-users may also input parameters to be utilized in the selected reports via the user interface layer 32. Users may be subjects, healthcare providers, healthcare payer entities, system operators or administrators, or the like, depending upon the service being provided by the system and depending upon the invention embodiment. More comprehensive embodiments are capable of interacting with some or all of the above-noted types of users, wherein different types of users have access to different services or data or different levels of services or data.

In an example embodiment, the user interface layer 32 provides one or more websites accessible by users on the Internet. The user interface layer may include or operate with at least one (or multiple) suitable network server(s) to provide the website(s) over the Internet and to allow access, world-wide, from Internet-connected computers using standard Internet browser software. The website(s) may be accessed by various types of users, including subjects, healthcare providers, payor entities, pharmaceutical partners or other sources of pharmaceuticals or medical equipment, and/or support personnel or other personnel running the system 16, depending upon the embodiment of use.

In another example embodiment, where the DDMS 16 is located on one computing device 100, the user interface layer 32 provides a number of menus to the subject-user to navigate through the DDMS. These menus may be created utilizing any menu format, including HTML, XML, or Active Server pages. A subject may access the DDMS 16 to perform one or more of a variety of tasks, such as accessing general information made available on a website to all subjects or groups of subjects. The user interface layer 32 of the DDMS 16 may allow a subject-user to access specific information or to generate reports regarding that subject's medical condition or that subject's medical device(s) 12, to download data or other information from that subject's support device(s) 12 to the system 16, to upload data, programs, program updates or other information from the system 16 to the subject's support device(s) 12, to manually enter information into the system 16, to engage in a remote consultation exchange with a healthcare provider, or to modify the subject's custom settings.

The system 16 may provide access to different optional resources or activities (including accessing different information items and services) to different users and to different types or groups of users, such that each user may have a customized experience and/or each type or group of user (e.g., all subject-users, diabetes subject-users, cardio subject-users, healthcare provider-user or payor-user, or the like) may have a different set of information items or services available on the system. The system 16 may include or employ one or more suitable resource provisioning program or system for allocating appropriate resources to each user or type of user, based on a pre-defined authorization plan. Resource provisioning systems are well known in connection with provisioning of electronic office resources (email, software programs under license, sensitive data, etc.) in an office environment, for example, in a local area network LAN for an office, company or firm. In one example embodiment, such resource provisioning systems is adapted to control access to medical information and services on the DDMS 16, based on the type of user and/or the identity of the user.

If the user is a subject-user, then upon entering successful verification of the user's identification information and password, the subject may be provided access to secure, personalized information stored on the DDMS 16. For example, the subject-user may be provided access to a secure, personalized location in the DDMS 16 which has been assigned to the subject. This personalized location may be referred to as a personalized screen, a home screen, a home menu, a personalized page, etc. The personalized location may provide a personalized home screen to the subject, including selectable icons or menu items for selecting optional activities, including, for example, an option to download device data from a subject support device 12 to the system 16, manually enter additional data into the system 16, modify the subject's custom settings, and/or view and print reports. Reports may include data specific to the subject's condition, including but not limited to, data obtained from the subject's subject support device(s) 12, data manually entered by the subject or healthcare provider, data from medical libraries or other networked therapy management systems, or the like. Where the reports include subject-specific information and subject identification information, the reports may be generated from some or all subject data stored in a secure storage area (e.g., storage devices 29) employed by the database layer 28.

If the user is the subject-user, the user may select an option to download (send) device data to the medical data management system 16. If the system 16 receives a subject-user's request to download device data to the system, the system 16 may provide the user with step-by-step instructions on how to download data from the subject's subject support device 12. For example, the DDMS 16 may have a plurality of different stored instruction sets for instructing users how to download data from different types of subject support devices, where each instruction set relates to a particular type of subject support device (e.g., pump, sensor, meter, or the like), a particular manufacturer's version of a type of subject support device, or the like. Registration information received from the subject user during registration may include information regarding the type of subject support device(s) 12 used by the subject. The system 16 employs that information to select the stored instruction set(s) associated with the particular subject's support device(s) 12 for display to the subject-user.

Other activities or resources available to the subject-user on the system 16 may include an option for manually entering information to the medical data management system 16. For example, from the subject-user's personalized menu or location, the subject-user may select an option to manually enter additional information into the system 16.

Further optional activities or resources may be available to the subject-user on the DDMS 16. For example, from the subject-user's personalized menu, the subject-user may select an option to receive data, software, software updates, treatment recommendations or other information from the system 16 on the subject's support device(s) 12. If the system 16 receives a request from a subject-user to receive data, software, software updates, treatment recommendations or other information, the system 16 may provide the subject-user with a list or other arrangement of multiple selectable icons or other indicia representing available data, software, software updates or other information available to the user.

Yet further optional activities or resources may be available to the subject-user on the medical data management system 16 including, for example, an option for the subject-user to customize or otherwise further personalize the subject-user's personalized location or menu. In particular, from the subject user's personalized location, the subject-user may select an option to customize parameters for the subject-user. In addition, the subject-user may create profiles of customizable parameters. When the system 16 receives such a request from a subject-user, the system 16 may provide the subject user with a list or other arrangement of multiple selectable icons or other indicia representing parameters that may be modified to accommodate the subject-user's preferences. When a subject-user selects one or more of the icons or other indicia, the system 16 may receive the subject-user's request and makes the requested modification.

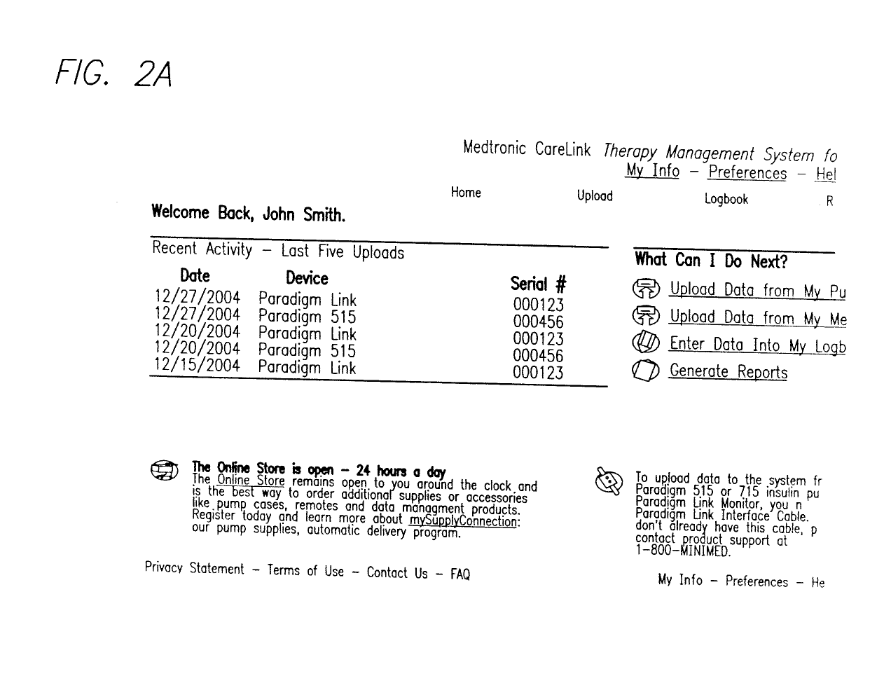

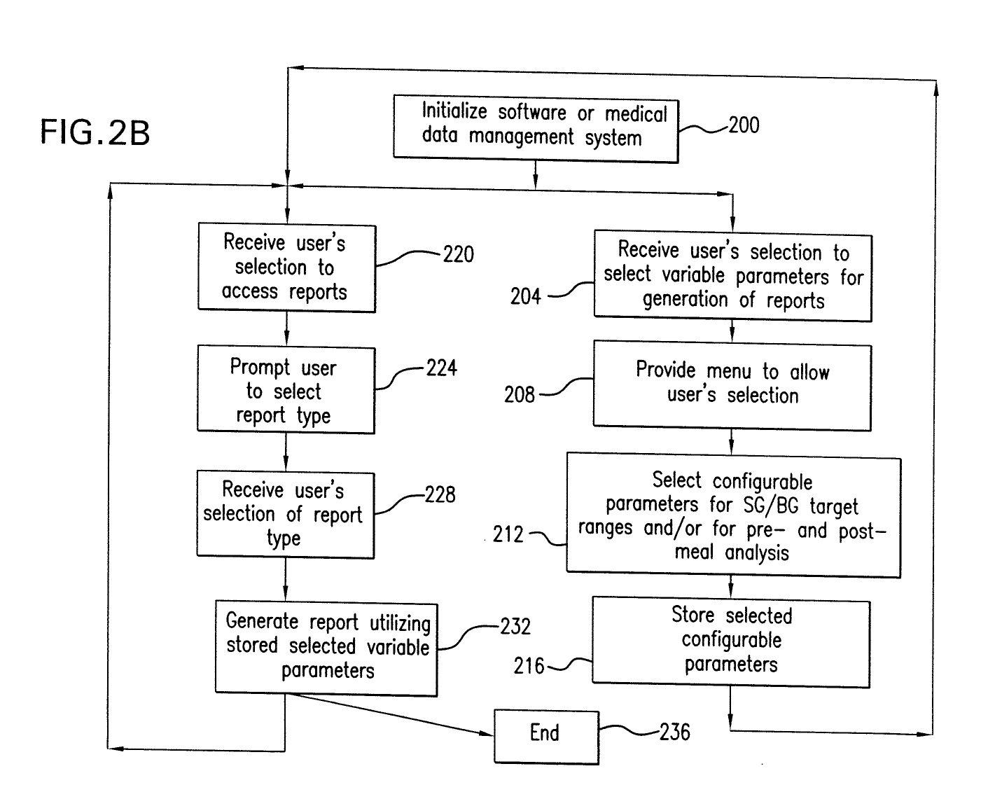

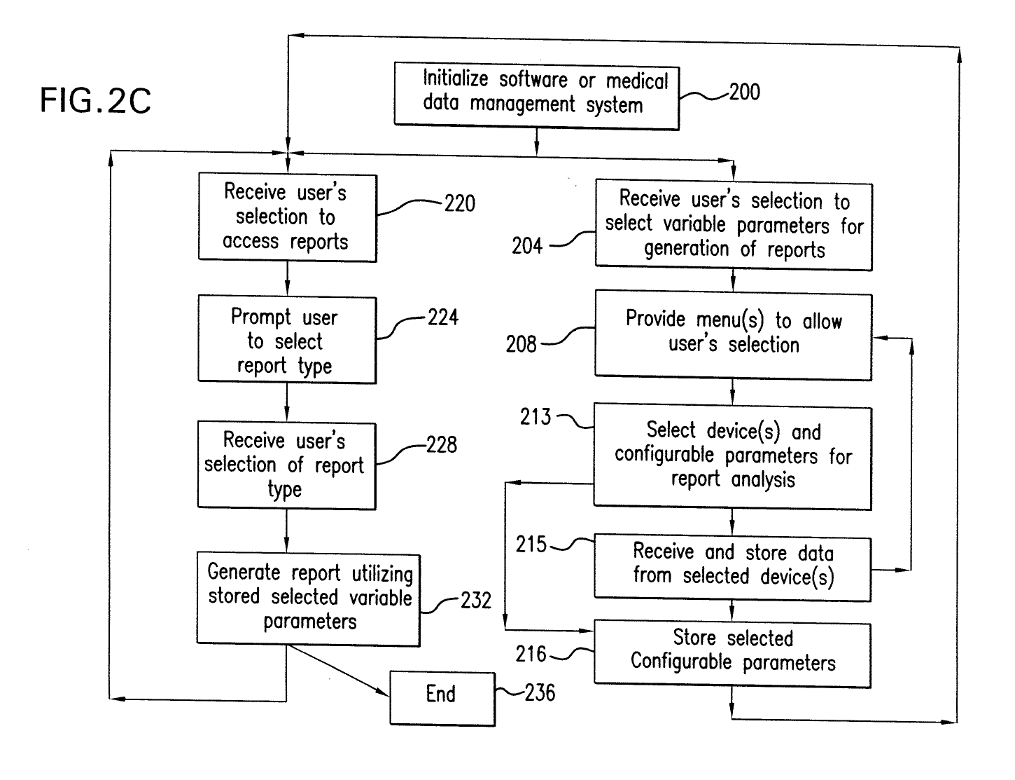

FIG. 2(a) illustrates a main operating screen of a DDMS according to an embodiment of the present invention. The main operating screens and other menu screens presented herein below may be employed by the DDMS 16 according to embodiments of the present invention. The main operating screen and other menu screens are provided as an example of an embodiment of the invention and are not intended to limit the scope of other embodiments of the invention.

FIG. 2(a) illustrates a personal menu that may be provided to a previously enrolled subject-user, upon the subject-user initializing the DDMS 16 through a login procedure. The personalized menu of the subject may include personalized information, such as the subject's name, and also may include a listing of recent activities. In the illustrated embodiment, the last five activities shown on the example user's personal menu refer to transfers of information from the subject's support devices to the system 16, e.g., last five updates for either Paradigm Link or Paradigm 512.

The user's personalized menu may also provide the user with a plurality of icons for selecting activities available on the website, such as for returning to the main operating screen, for uploading data from a pump or from a meter, for manually entering information or for generating, or for otherwise accessing reports. In the illustrated example, such selectable icons are provided in the form of tab-shaped icons (labeled “Home”, “Upload”, “Logbook” and “Reports,” respectively). Further labeled icons may be provided to allow a user to select instructions or further descriptions of the activities available for selection. In the illustrated example, such further selectable icons are labeled “Upload Data from My Pump,” “Upload Data from My Meter,” “Enter Data into My Logbook” and “Generate Reports,” respectively. In the embodiment of the invention where the DDMS 16 is located on a server on the Internet, upon the system 16 receiving a user's selection of tab-like icons (labeled “Home”, “Upload”, “Logbook” and “Reports,” respectively), the system 16 will provide the user with website locations associated with the selected icon, including a webpage for the home page, a webpage for initiating an upload operation, a webpage for initiating a manual entry into the user's logbook, and a webpage for accessing reports, respectively.

FIG. 2(b) illustrates a flowchart for generating reports and selecting options in the diabetes data management system according to an embodiment of the present invention. An activity or resource available to the subject-user on the DDMS 16 system may include an option for requesting reports. Before the generation of reports, a subject-user may decide to customize report parameters by modifying or adjusting parameters. Illustratively, the subject-user may input different glucose reading target ranges for time periods after specific meal events. In addition, the subject-user may decide to customize report parameters to include variable or adjustable analysis timeframes. In embodiments of the invention, the subject-user may decide to customize report parameters by including variable or adjustable target levels and variable or adjustable analysis timeframes. For example, the subject-user may enter blood glucose target levels specifically for each meal marker or meal event. The subject-user may also enter pre-meal and post-meal analysis timeframes for each meal marker or meal event. The DDMS 16 receives 204 a user's request to customize reports utilizing the modifiable, variable, or adjustable parameters.

In response to the user's request to the DDMS 16 for the adjustment or configuration of parameters, the DDMS 16 displays or provides 208 a menu to allow for the subject-user's selection of the variable, adjustable, or configurable parameters. The parameters may also be customized for the subject-user and referred to as customizable parameters or configurable parameters.

After the menu is displayed, the subject-user may select 212 the adjustable, variable, or customizable parameters to allow for generation of reports. Illustratively, the preferences menu may include selection capabilities for each meal marker or meal event, e.g., breakfast, lunch, or dinner. For example, a subject-user may select target levels for sensor glucose (SG) or blood glucose (BG) readings for each meal marker or meal event. The subject-user may also select target levels for SG or BG readings for time-defined events such as evening or sleeping. Time-defined events may be referred to as time events. Alternatively, or in addition to, the subject-user may also select adjustable pre- and post-meal analysis timeframes.

After the selection of the adjustable or customizable parameters, e.g., the subject-user's preferences, the subject-user's adjustable or customizable parameters are stored 216. The DDMS 16 may store the parameters temporarily in temporary storage such as RAM. In alternative embodiments of the invention, the DDMS 16 may store the parameters on a permanent basis in a hard disk, or non-volatile storage, such as in the data storage device(s) 29 of the database layer 28. Profiles may be created that the subject-user can select at a later timeframe. A subject-user may have multiple profiles stored in the computing device 100. In an embodiment of the invention, the menu which allows for the subject-user's selection of parameters is the preferences menu. An illustrative preferences menu is described in detail below.

After the DDMS 16 has stored the selected parameters, a subject-user may select to generate a customized report. This is represented in FIG. 2(a) by the line and arrow to from box 216 to box 220.

After the DDMS 16 system has been initialized (box 200), the subject-user may select an option to generate, view or print reports containing information stored by the DDMS 16. Also, as noted above, the subject-user may perform another action within the system (customize parameters or target levels) and then decide to select a report. As represented by box 220 in FIG. 2(b), the medical data management system 16 may receive a user's selection of an option to view or print reports. In response, as represented by box 224, the system 16 may prompt the user to select a type of report (for example, type of report contents, format and/or style), such as by providing the user with a table, list, menu or other suitable arrangement of a plurality of optional reports from which the user may select a desired report. Illustratively, the subject-user may select a logbook diary report, a modal day periods report, or a modal day hourly report. These reports are illustrative reports and are not meant to limit the invention described herein in any way.

Thus, information previously received by the system 16, for example, from the subject's support device(s) 12 and/or from manual entry by the subject, may be included in one or more reports. The system 16 may have a plurality of pre-defined report types, for displaying different reported information and/or in various manners. For example, different available reports (report types) may include respectively different data and/or different data formats, such as one or more bar graphs, x-y coordinate graphs, pie charts, tables, scatter charts, stacked bar charts, interactive data presentations, or the like. In further embodiments, the subject-user may be provided with options for generating a report, for example, by customizing a pre-existing report type or by creating an original type of report with user-defined types of data content and/or user-defined presentation format. Thus, a subject-user may design a report to include certain information specified by the subject-user and/or to present certain information in a particular format specified by the user.

A subject-user may select from a plurality of available reports and/or options for generating a report, as represented by box 228. The system 16 may receive the subject-user's selection (and/or content or format parameters). Alternatively, or in addition to, the DDMS 16 may retrieve the subject-user's selection and/or adjustable content or format parameters, which were previously stored (see box 216). In one embodiment, a subject-user may receive a report and/or parameters for generating a report from the subject-user's designated healthcare provider.

The report and/or parameters may be stored in the system 16 database layer 28 (or the reporting layer 30) and accessible by the subject-user. In that manner, a subject-user's healthcare provider may select an existing type of report or design a report that the healthcare provider believes would be helpful to that subject (for example, based on the healthcare provider's assessment of that subject's medical condition, habits, ability to understand reports, or other personal information that may be available to the particular healthcare provider treating that subject).

Based on the subject-user's selected report and/or the subject-user's selected adjustable or configurable report parameters, the DDMS 16 generates a suitable report, as represented by box 232. Some of these generated reports present the subject-user with information that varies per meal event. For example, a report may provide the subject-user with SG or BG readings where the SG or BG readings are mapped against SG/BG target levels and the SG or BG target levels are different for each meal event or meal marker. Alternatively, or in addition to, a report may provide the subject-user with SG/BG readings for different analysis timeframes for each meal event or meal marker. Illustratively, a user may select to analyze a certain timeframe (e.g. 1 to 2 hours) before a meal event and a second timeframe (e.g., 1 to 3 hours) after a meal event.

After this, the subject-user may exit the system, as represented by box 236, or may decide to generate another report or engage in another activity on the DDMS 16. The report may be displayed on the display 33 coupled to the computing device 100. Alternatively, or in addition, the DDMS 16 may forward data or other information to a computer over the Internet connection, such that DDMS software residing on the computer (located remotely) may generate the report with that data or other information. The system 16 may be configured to implement suitable security measures for reports or information communicated computer, over the Internet, such as, but not limited to, suitable encryption techniques, authentication techniques, password protection, or the like.

Generated reports may be displayed on a screen of a display device associated with the subject-side computer 100. Alternatively, or in addition, a subject-user may store reports on a storage device (not shown) associated with the subject-side computer 100 for later viewing or print reports on a printer (not shown) associated with the subject-side computer 100 for a hard copy representation of the same displayed information. If desired, the subject-user may send copies of one or more reports, data or other information to their healthcare provider or bring printed report copies to their next scheduled office visit. In one example embodiment, the system 16 on a local computing device 100 or the system software residing on the remote computer may provide an option to the subject-user to email a generated report, data or other information to the subject-user's healthcare provider.

Following the generation of a report, the subject-user may be prompted again to select an optional activity or resource available on the system 16, for example, by being returned to a main operating screen of the DDMS 16. Alternatively, or in addition, if no further activities are to be performed with the system 16, the communication session may be ended, as represented by box 236.

FIG. 2(c) illustrates another flowchart for generating reports and selecting options in the diabetes data management system according to an embodiment of the present invention. As discussed with respect to FIG. 2(b), an activity or resource available to the subject-user on the DDMS 16 system may include an option for requesting reports. Before the generation of reports, a subject-user may decide to customize report parameters by modifying or adjusting parameters. The subject-user may also decide to customize devices to be read into the DDMS 16. Illustratively, the subject-user may input a selected date range for reports and different glucose reading target ranges for the selected date range or for times before, after or during meal events. In embodiments of the invention, the subject-user may decide to customize report parameters by including variable or adjustable target levels and variable or adjustable analysis timeframes. For example, the subject-user may enter blood glucose target levels specifically for each meal marker or meal event. The subject-user may also enter pre-meal and post-meal analysis timeframes for each meal marker or meal event. The DDMS 16 receives 204 a user's request to customize reports utilizing the modifiable, variable, or adjustable parameters.

In response to the user's request to the DDMS 16 for the adjustment or configuration of parameters, the DDMS 16 displays or provides 208 a menu or menus to allow for the subject-user's selection of the variable, adjustable, or configurable parameters. The parameters may also be customized for the subject-user and referred to as customizable parameters or configurable parameters. The customizable/configurable parameters may include parameters that allow selection of devices whose data will be read into the DDMS 16.

After the menu(s) is displayed, the subject-user may select 213 the adjustable, variable, or customizable parameters, including the device(s), to allow for generation of reports. Illustratively, the preferences menu may include selection capabilities for devices, and selection capabilities for device parameters. A subject-user may select the time period for report generation and target levels for sensor glucose (SG) or blood glucose (BG) readings during that time period. The subject-user may also select target levels for SG or BG readings for time-defined events such as meal events or evening or sleeping. Alternatively, or in addition to, the subject-user may also select adjustable pre- and post-meal analysis timeframes.

After the selection of the adjustable or customizable parameters, e.g., the subject-user's preferences, the DDMS 16 may receive and store data from any selected devices. The subject-user's adjustable or customizable parameters may then be stored 216. The DDMS 16 may store the parameters temporarily in temporary storage such as RAM. In alternative embodiments of the invention, the DDMS 16 may store the parameters on a permanent basis in a hard disk, or non-volatile storage, such as in the data storage device(s) 29 of the database layer 28. Profiles may be created that the subject-user can select at a later timeframe. A subject-user may have multiple profiles stored in the computing device 100. In an embodiment of the invention, the menu which allows for the subject-user's selection of parameters is the preferences menu. In further embodiments, the menus that allow for the subject-user's selection of parameters are the source parameter selection menu, the report settings menu, and the generate reports menu. Illustrative menus are described in detail below.

After the DDMS 16 has stored the selected parameters, a subject-user may select to generate a customized report. This is represented in FIG. 2(c) by the line and arrow to from box 216 to box 220. In further embodiments, where there are more than one selection menu, there may be one menu for selection of devices and other menus for selection of additional parameters. In such a case, after receiving and storing data from selected devices in box 215, the DDMS 16 may provide additional menu(s) to allow user's selection of parameters in box 213. If the menu in 208 does not allow for selection of devices, the DDMS 16 may go directly to storing selected configurable parameters 216.

After the DDMS 16 system has been initialized (box 200), the subject-user may select an option to generate, view or print reports containing information stored by the DDMS 16. Also, as noted above, the subject-user may perform another action within the system (customize parameters or target levels) and then decide to select a report. An activity or resource available to the subject-user on the DDMS 16 system may include an option for requesting reports. In response, as represented by box 224, the system 16 may prompt the user to select a type of report (for example, type of report contents, format and/or style), such as by providing the user with a table, list, menu or other suitable arrangement of a plurality of optional reports from which the user may select a desired report. Illustratively, the subject-user may select an overview report, a daily detail report, a logbook report, an adherence report, a sensor report and/or a pump settings snapshot. These reports are illustrative reports and are not meant to limit the invention described herein in any way.

Thus, information previously received by the system 16, for example, from the subject's support device(s) 12 and/or from manual entry by the subject, may be included in one or more reports. The system 16 may have a plurality of pre-defined report types, for displaying different reported information and/or in various manners. For example, different available reports (report types) may include respectively different data and/or different data formats, such as one or more bar graphs, x-y coordinate graphs, pie charts, tables, scatter charts, stacked bar charts, interactive data presentations, or the like. In further embodiments, the subject-user may be provided with options for generating a report, for example, by customizing a pre-existing report type or by creating an original type of report with user-defined types of data content and/or user-defined presentation format. Thus, a subject-user may design a report to include certain information specified by the subject-user and/or to present certain information in a particular format specified by the user.

A subject-user may select from a plurality of available reports and/or options for generating a report, as represented by box 228. The system 16 may receive the subject-user's selection (and/or content or format parameters). Alternatively, or in addition to, the DDMS 16 may retrieve the subject-user's selection and/or adjustable content or format parameters, which were previously stored (see box 216). In one embodiment, a subject-user may receive a report and/or parameters for generating a report from the subject-user's designated healthcare provider. The report and/or parameters may be stored in the system 16 database layer 28 (or the reporting layer 30) and accessible by the subject-user. In that manner, a subject-user's healthcare provider may select an existing type of report or design a report that the healthcare provider believes would be helpful to that subject (for example, based on the healthcare provider's assessment of that subject's medical condition, habits, ability to understand reports, or other personal information that may be available to the particular healthcare provider treating that subject).

Based on the subject-user's selected report and/or the subject-user's selected adjustable or configurable report parameters, the DDMS 16 generates a suitable report, as represented by box 232. Some of these generated reports present the subject-user with information that varies per meal event. For example, a report may provide the subject-user with SG or BG readings where the SG or BG readings are mapped against SG/BG target levels and the SG or BG target levels are different for each meal event or meal marker. Alternatively, or in addition to, a report may provide the subject-user with SG/BG readings for different analysis timeframes for each meal event or meal marker. Illustratively, a user may select to analyze a certain timeframe (e.g. 1 to 2 hours) before a meal event and a second timeframe (e.g., 1 to 3 hours) after a meal event.

After this, the subject-user may exit the system, as represented by box 236, or may decide to generate another report or engage in another activity on the DDMS 16. The report may be displayed on the display 33 coupled to the computing device 100. Alternatively, or in addition, the DDMS 16 may forward data or other information to a computer over the Internet connection, such that DDMS software residing on the computer (located remotely) may generate the report with that data or other information. The system 16 may be configured to implement suitable security measures for reports or information communicated computer, over the Internet, such as, but not limited to, suitable encryption techniques, authentication techniques, password protection, or the like.

Generated reports may be displayed on a screen of a display device associated with the subject-side computer 100. Alternatively, or in addition, a subject-user may store reports on a storage device (not shown) associated with the subject-side computer 100 for later viewing or print reports on a printer (not shown) associated with the subject-side computer 100 for a hard copy representation of the same displayed information. If desired, the subject-user may send copies of one or more reports, data or other information to their healthcare provider or bring printed report copies to their next scheduled office visit. In one example embodiment, the system 16 on a local computing device 100 or the system software residing on the remote computer may provide an option to the subject-user to email a generated report, data or other information to the subject-user's healthcare provider.

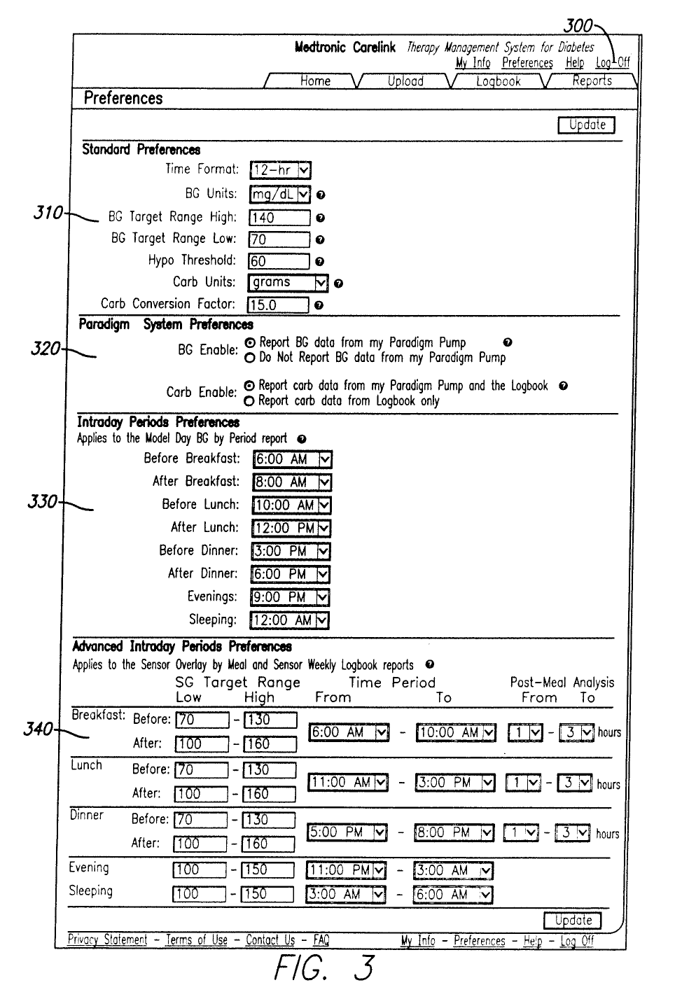

Following the generation of a report, the subject-user may be prompted again to select an optional activity or resource available on the system 16, for example, by being returned to a main operating screen of the DDMS 16. Alternatively, or in addition, if no further activities are to be performed with the system 16, the communication session may be ended, as represented by box 236. FIG. 3 illustrates a parameter selection menu according to an embodiment of the invention. The parameter selection menu illustrated in FIG. 3 may be referred to as a preferences menu and may be selected utilizing a preferences selection bar or tab on the main operating screen of the diabetes data management system. FIG. 3 illustrates one embodiment of the parameter selection menu 300. In an embodiment of the invention, each section of the parameter selection menu 300 may be presented in a separate submenu. In other embodiments of the invention, only a subset of the parameters presented for selection on the preferences menu illustrated in FIG. 3 may be presented in the parameter selection menu.

The parameter selection menu allows for the selection of the adjustable, modifiable, or configurable SG or BG levels. The parameter selection menu may allow for the selection of adjustable, configurable, or modifiable analysis timeframes.

In an embodiment of the invention illustrated in FIG. 3, the preferences menu 300 may be divided into a standard parameter selection section 310, a device input parameter selection section 320, a period definition section 330, and an advanced adjustable or configurable parameter selection section 340.

In the embodiment of the invention illustrated in FIG. 3, the standard parameter selection section 310 may be referred to as the standard preferences section. The standard preference selection section 310 sets readings that are common for a subject's interaction with the DDMS Illustratively, the standard parameter selection section 310 may allow a time format to be selected, a blood glucose or sensor glucose unit to be defined, a blood glucose or sensor glucose range to be defined (with a high threshold and a low threshold) for a subject's interaction with the DDMS 16. The standard parameter selection section 310 also may include a hypo threshold. Because dropping into a hypo level is a drastic or significant event, it is important to establish a level for the user that causes the DDMS 16 or blood glucose monitors to notify the patient of the hypo situation.

A unit for carbohydrates may also be established in the standard parameter selection section 310. Under certain operating conditions, the carbohydrates unit may be grams or may be exchanges. A carbohydrate conversion factor may also be selected. The carbohydrate conversion factor may be utilized to convert between carbohydrates and exchanges. An illustrative conversion factor representation is that one exchange is equal to the conversion factor multiplied by a number of grams. For example, under certain operating conditions, the default carbohydrate conversion factor is 15.0. For example, in embodiments of the invention, the carbohydrate conversion factor may range between 5.0 and 25.0.

The device input parameter selection section 320 allows a subject-user to receive or request an automatic inputting of data into the DDMS 16. In an embodiment of the invention illustrated in FIG. 3, the device input parameter selection section may be referred to as a paradigm system preferences menu 320. The may include an area for selection of paradigm system preferences. In the device input parameter selection section 320, a subject-user of the DDMS 16 may be able to specify whether patient medical condition information is to be provided from or uploaded from a medical condition measuring device. For example, information from a blood glucose sensor or a blood glucose meter may be uploaded into the DDMS 16 and utilized in the generation of reports. Under certain operating conditions, a communications device or cradle may provide or upload the medical condition information (e.g., blood glucose level/reading information) to the DDMS 16. Illustratively, in the embodiment of the invention illustrated in FIG. 3, selector buttons or icons may be checked or selected if blood glucose or sensor glucose data is supposed to be reported from a Medtronic Minimed Paradigm pump. An option may also be presented which provides for not reporting the blood glucose data from an insulin pump.

In the device input parameter selection section 320, a user can also select how meal event information is to be provided to and utilized by the DDMS 16. The device input parameter selection section 320 may allow a user to utilize or report data that has been uploaded into the DDMS from a Minimed Paradigm pump. As an alternative selection, the device input parameter selection section 320 may allow for a subject-user to utilize or report data from a Paradigm pump and also from a logbook. In an embodiment of the invention, the patient logbook allows for recording of the self-reported personal health record information. In other words, if the data cannot be automatically input, the information may be manually input, using a feature like a logbook. Illustrative, but not limiting, of what may be entered into a logbook may include meal carbohydrates; exercise time, duration, and intensity, urine ketones, infusion set changes, HbAlc results, and general comments.

As illustrated in FIG. 3, the utilization of meal event information may be referred to as “Carb Enable,” which refers to carbohydrate enablement. One selector button of “Carb Enable” allows for selecting to report carbohydrate data from the Paradigm Pump and a Logbook. Another selector button of “Carb Enable” allows for selecting to report carbohydrate data from the Logbook only.

The parameter selection menu 300 allows for selection of different time ranges or time buckets for certain reports. For example, for a Modal Day BG by Period report, a user can select how time categories or time buckets are defined. The period definition section 330 provides for the selection of time ranges or definitions for the time categories or time buckets. As illustrated in FIG. 3, in an embodiment of the present invention, the period definition section may be referred to as a intraday periods preferences section. As illustrated in FIG. 3, the period definition section 330 allows a subject-user to select timeframes for a before breakfast time mark, an after breakfast time mark, a before lunch time mark, an after lunch time mark, a before dinner time mark, an after dinner time mark, an evening time mark, and a sleeping time mark. These time marks (or alternatively time breaks), delineate a certain time category or time bucket. For example, in terms of a report generated utilizing these time marks, a graph will have a section break at each of the selected time marks or time breaks. Illustratively, a graph on a report generated utilizing the time marks of the intraday periods preferences section illustrated in the period definition section 330 of FIG. 3, would have a section break at 6:00 am, 8:00 am, 10:00 am, 12:00 pm, 3:00 pm 6:00 pm, 9:00 pm, and 12:00 am. A report utilizing the period definition section may generate statistics for each define section of the period definition section.

The parameter selection menu 300 allows for selection of different timeframes of analyzation and/or different medical information reference or target readings (e.g., SG or BG target ranges) for the patient or person medical measurements. A subject-user may select a timeframe for a first meal event (e.g., breakfast), a second meal event (e.g., lunch), a third meal event (e.g., dinner), in which a meal event should occur. The DDMS 16 may also select a timeframe for time events, e.g., evening and sleeping. The advanced adjustable or configurable parameter selection section 340 of the parameter selection menu 300 provides this capability. As illustrated in FIG. 3, advanced adjustable or configurable parameter selection section 340 may be referred to as the advanced intraday periods preferences menu 340. As illustrated in FIG. 3, the time period column provides the subject-user with the ability to define time ranges in which the meal events or the time events should occur.

The meal event may be automatically determined by the DDMS 16 based on the entry of a carbohydrate consumption and a bolus intake or consumption into a bolus wizard. In other words, although breakfast may normally be at 8:00 a.m. for the subject user, if the DDMS 16 identifies that a carbohydrate consumption event has been entered and a corresponding bolus has been ingested at 8:30 a.m., the DDMS 16 may identify that a meal event, e.g., breakfast has occurred, and may now treat 8:30 a.m. as the breakfast meal event time.

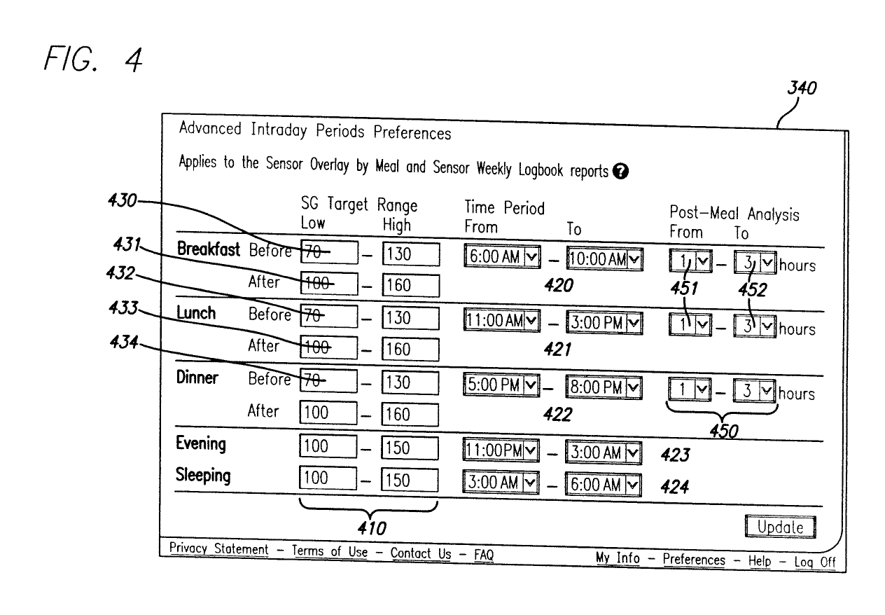

FIG. 4 illustrates a close-up view of an advanced adjustable or configurable parameter selection section according to an embodiment of the present invention. The DDMS 16 utilizes the timeframes entered in the time period input boxes 420, 421, 422, 423, 424 as ranges for when certain meal events or time events should occur. For example, if for the breakfast time period input box 421 6:00 am-10:00 am is selected, the DDMS may look for a meal event during this specified timeframe. As illustrated in FIGS. 3 and 4, the timeframes may be selected via a drop-down menu. In other embodiments of the invention, the timeframes may be entered into an input box. The use of a drop-down menu allows a system operator to only allow certain times to be selected as specified timeframes.

A subject-user may be able to generate designate SG or BG target ranges for the meal events and time events. In other words, the SG or BG target ranges are configurable or adjustable. In previous versions of the Medical Data Management System (DDMS) system 16, only a single target range for an entire time period may be designated. Illustratively, for one 24-hour period, a single SG or BG low threshold and a single BG or SG high threshold may be designated for a 24 hour period (or for a week timeframe). The ability to include variable, modifiable, adjustable, or configurable SG or BG readings is important because subject-users have different SG or BG target ranges for different times of the day. The different SG or BG target ranges are a result of different physiological conditions in a patient at different times of the day and also different types of physical activities of the subject-user.

For ease of illustration, a separate figure is provided for the advanced adjustable or configurable parameter selection section 340. FIG. 4 illustrates an input screen 410 in the advanced adjustable or configurable parameter selection section 340 screen in the DDMS 16 that allows for the establishment of adjustable or configurable BG or SG readings or target readings. As illustrated in FIG. 4, target range input section 410 in the advanced adjustable or configurable parameter selection section 340 allows for selection of variable or adjustable SG or BG target readings for meal events (e.g., before breakfast, after breakfast, before lunch, after lunch, before dinner, and after dinner).

As illustrated in FIG. 4, a subject-user can enter into target range input boxes, such as input boxes 430, 431, 432, 433, and 434, etc., SG or BG low threshold and SG or BG high threshold, (e.g., SG or BG target ranges), for a number of target range input boxes, e.g., 12 input boxes. Although input boxes are utilized in the target range input boxes 410 of the advanced adjustable or configurable parameter selection section 340, a drop down menu, an icon, or other type of input screen may be utilized to provide the subject-user with choices for SG or BG target thresholds corresponding to each of the meal events.

The advanced adjustable or configurable parameter selection section 340 may also allow for selection of SG or BG threshold levels for time events, such as an evening time and a sleeping time. As illustrated in FIG. 4, evening SG or BG target ranges or target levels and sleeping SG or BG target ranges or target levels may be entered for the evening time event and the sleeping time event, respectively.

The DDMS 16 may allow a subject-user to select a post-meal event analysis timeframe. The DDMS 16 may also allow a subject-user to select a pre-meal event analysis timeframe. The post-meal event analysis timeframe may be selected for a number of meal events. The pre-meal event analysis timeframe may be selected for a number of meal events. The consuming of a meal increases a subject-users blood glucose (and also sensor glucose) level and a taking of a number of insulin units via a bolus counteracts the increase in the subject-users SG or BG level. Boluses are generally taken either via shots or via a pump and therefore may take a while to enter the bloodstream. Thus, for post-meal analysis it may be important to analyze a timeframe after the bolus has started to enter the subject-user's fluids and/or bloodstream and decrease the subject user's SG or BG level. In addition, there are some boluses that are dual wave boluses. The dual bolus is a combination of a normal and a square bolus. A square bolus is used to administer bolus over a longer period of time to count for low glycemic foods that do not spike the blood glucose (or sensor glucose), but that do elevate the BG or SG over the basal rate. A dual bolus used for combinations of foods that contain both high glycemic and low glycemic portions. A classic food in this category is pizza, which has high glycemic bread along with low glycemic toppings. Monitoring at an appropriate interval after the meal can also help the user to understand when to use a square or a dual. The dual wave boluses include a spike of insulin soon after the taking of the bolus and a even or uniform release or ingestion of insulin for a timeframe after the original spike of the bolus. This may result in the SG or BG reading being a better or more accurate reading at a time after the actual meal event.

For pre-meal analysis, it is important to monitor how the SG or BG levels are acting before a meal event occurs. It is important to monitor pre-meal SG or BG readings in a pre-meal timeframe. First, if the user is not in a target glucose range before a meal, this may be an indication of an incorrect basal infusion or other factors, such as exercise. SG or BG measured before the meal affects the calculation for the bolus to account for correction to target. As an indicator of the state of control prior to a meal event, this information is critical to understanding whether the correct bolus is being calculated and administer, and also aid to understanding other therapy factors such as basal rate and insulin sensitivity. Before the sudden increase or spike of the subject user's SG or BG level occurs after consuming carbohydrates during the meal event, it is desirable for the subject user's SG or BG level to be in the target range for a certain time before the meal event.

FIG. 4 illustrates advanced adjustable or configurable parameter selection section 340 including a section for inputting adjustable timeframe analysis according to an embodiment of the present invention. As illustrated in FIG. 4, a post-meal analysis timeframe may be selected or input for each of the meal events by entering information into the post-meal timeframe input section 450. In the embodiment of the invention illustrated in FIG. 4, the post-meal analysis timeframe is entered into the post-meal timeframe input section 450 by selecting a begin analysis timeframe 451 and an end analysis timeframe 452 input for each of the meal events (breakfast, lunch, and dinner).

The begin analysis timeframe 451 and the end analysis timeframe 452 are selected, as illustrated in FIG. 4, by selecting a timeframe from a drop-down menu, e.g., 1 hour, 2 hours, 4 hours, etc.). In other embodiments of the invention, the begin analysis timeframe 451 and the end analysis timeframe 452 may be selected by selecting two times on a clock that is presented in the after-meal analysis timeframe section 450 of the advanced intraday periods preference section 340. This is important because immediately after a meal is consumed the BG or SG level in a patient generally is high. The begin analysis timeframe 451 may start immediately after the meal event. The end analysis timeframe 452 may start at any available timeframe in a designated interval after the begin analysis timeframe.

Although it is not illustrated in FIG. 4, a pre-meal analysis timeframe input section (not shown) of the advanced adjustable or configurable parameter selection section 340 includes entry locations for selecting an analysis timeframe for pre-meal analysis. The pre-meal analysis timeframe may allow for entry of a pre-analysis start time and a pre-analysis end time. In addition, a pre-time event and post-time event analysis time may also be established for a time event (such as evening time event and/or a sleeping time event).

A subject-user may determine that his or her blood glucose reading is not stable or that he or she has high or low readings during certain time periods of the day. The subject user can then select a pre-meal or post-meal analysis timeframe to hone in or focus on the problem timeframe.

The selection of the configurable or adjustable SG or BG target ranges allow for the generation of reports which display measured SG or BG ranges against the selected adjusted SG or BG ranges. A number of reports may display the adjustable or configurable SG or BG ranges in both graphical and/or tabular form for each of the meal events. In embodiments of the invention, the information may be in an output display such as text. A report may only display the adjustable configurable SG or BG ranges in both graphical and/or tabular for one of the meal events. In embodiments of the invention, the selection of pre- and post-meal analysis timeframes also allows for the generation of reports which display in graphical form the SG or BG readings for all timeframes, but highlight the selected adjustable or configurable analysis timeframes. These highlighted area(s) may be referred to as analysis area(s). In addition, the DDMS 16 may calculate a number of SG or BG statistics for the analysis timeframes (both pre-meal and post-meal) and presents this information in graphical, tabular, or textual format for the subject-users. These readings include, but are not limited to: 1) SG or BG ranges; 2) average SG or BG readings; 3) low SG or BG readings; 4) high SG or BG readings; 5) a standard deviation of the SG or BG readings; 6) the number of SG or BG readings; 7) how many times during each analysis timeframe (for example in teens of readings) the subject user SG or BG readings was outside the selected target SG or BG ranges (either on the high side or the low side).

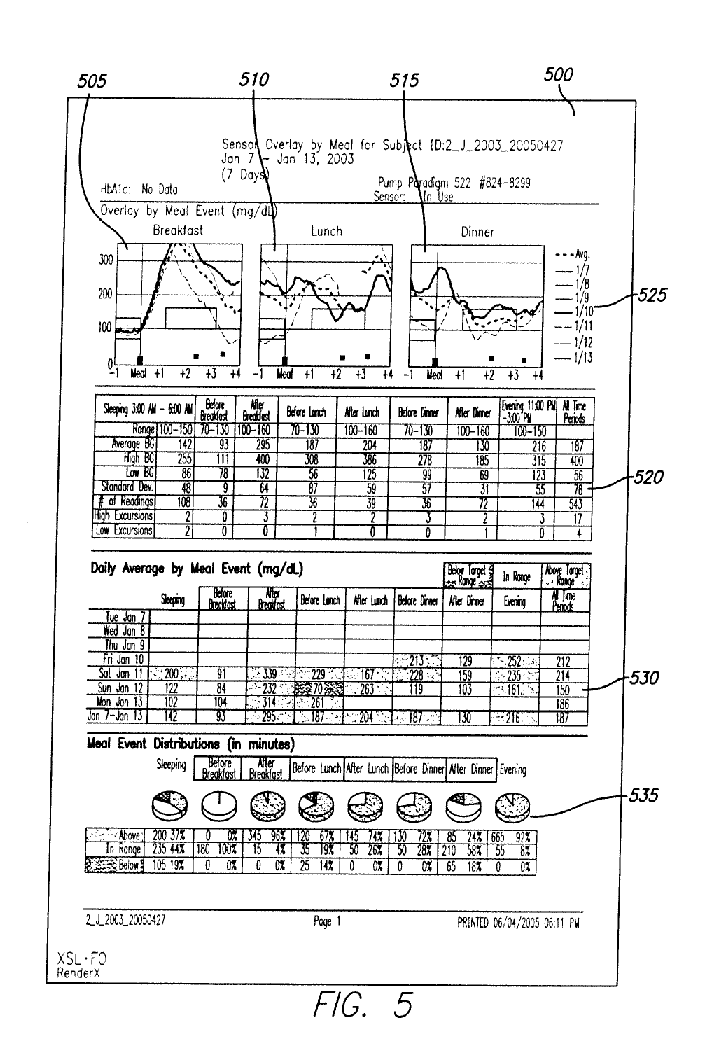

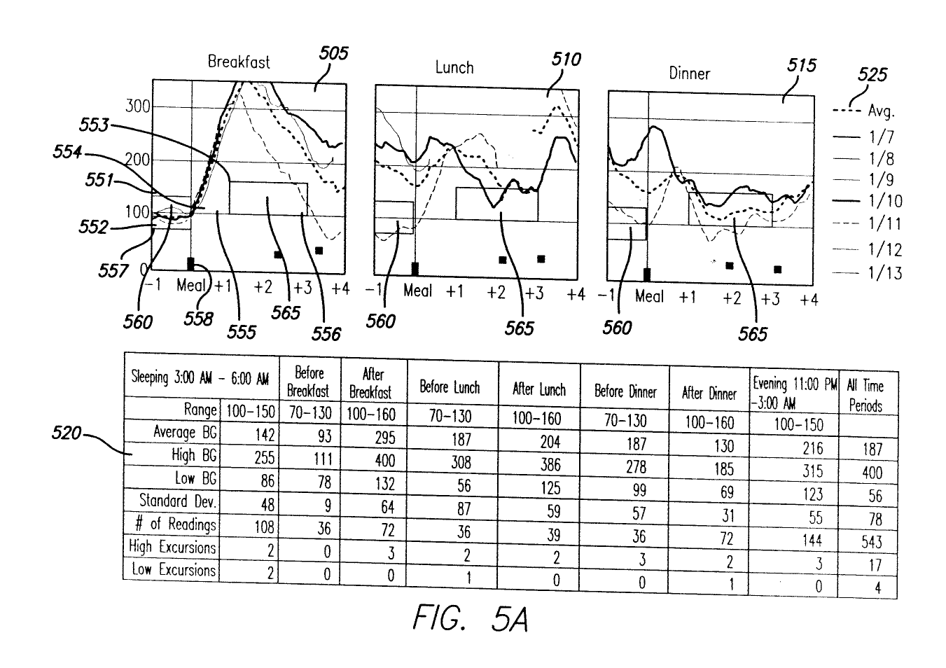

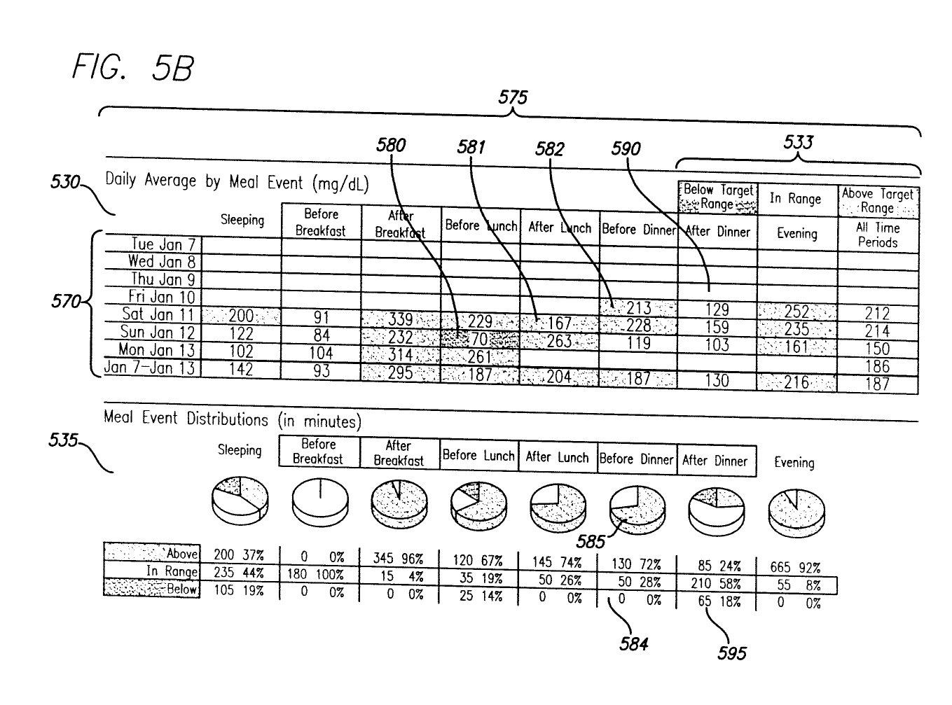

A number of reports may be generated utilizing the DDMS 16. Instead of selecting the parameters selection menu 300 (e.g., with a preferences selection), a report generation menu may be selected. In an embodiment of the invention, a reports tab on the main operating screen of the DDMS 16 may be utilized. A report generation menu may also be selected by entering a command, selecting an icon, or selecting an entry in a drop-down menu. Illustratively, one report is a report which displays sensor readings corresponding to meal events. This report may be referred to as a Sensor Overlay by Meal report. FIG. 5 illustrates a report to display sensor readings corresponding to meal events according to an embodiment of the present invention. The sensor overlay by meal report 500 displays the variable or adjustable target SG or BG ranges. The sensor overlay by meal report 500 includes a first meal event graph 505 (e.g., breakfast), a second meal event graph 510 (e.g., lunch), a third meal event graph 515 (e.g., dinner), a SG or BG meal event and time event table 520, a date legend 525, a sensor analysis for meal event table 530, and a meal event distribution pie chart and table 535.

FIG. 5(a) illustrates a top section of the sensor overlay by meal event report according to an embodiment of the present invention. As illustrated in FIG. 5(a), the first meal event graph 505 displays a high SG or BG threshold or reading 551 and a low SG/BG threshold or reading 552 for a timeframe before the first meal event. The timeframe before the meal event may be referred to as a pre-meal analysis timeframe. Although this discussion highlights the first meal event graph 505, e.g., breakfast, the discussion equally applies to the both the second meal event graph 510 and the third meal event graph 515, e.g., lunch and dinner. In addition, although the sensor display by meal report displays graphs of meal events, in embodiments of the invention, the sensor display by meal report could also present graphs of times events, such as the evening time event and the sleep time event. The meal event graphs may also display other information such as carbohydrates, exercise, individual blood glucose values from finger sticks, etc.

The first meal event graph 505 also displays a high SG or BG threshold or reading 553 and a low SG or BG threshold or reading 554 for a timeframe after the first meal event, which may be referred a post-meal timeframe or a post-meal analysis timeframe.

The first meal event graph 505, the second meal event graph 510, and the third meal event graph also display selected pre-meal and post-meal analysis timeframes. As discussed above, the selection of the pre-meal and post-meal analysis timeframes may occur in the parameter selection menu 300. As illustrated in FIG. 5(a), the start post-meal analysis time 555 and the end post-meal analysis time 556 define the analysis timeframe for the post-meal timeframe. The start pre-meal analysis time 557 and the end pre-meal analysis time 558 define the analysis timeframe for the pre-meal timeframe.

In the embodiment of the invention illustrated in FIG. 5(a), a first shaded analysis area 560 in the first meal event graph 505 represents a target blood glucose range for an pre-meal analysis timeframe. A second shaded area 565 in the first meal event graph 505 represents a target blood glucose range for a post-meal analysis timeframe. The shaded analysis area(s) 560 565 may be colored with one color for the pre-meal analysis area 560 and one color for the post-meal analysis area 565. In alternative embodiments of the invention, the color of the shaded analysis area(s) in a meal event graph 505, 510, or 515 may be different for each of the meal event graphs 505 510 515, e.g., light yellow for first meal event graph 505 shaded area(s) 560 565 and light green for second meal event graph 510 shaded area(s) (not shown). In an embodiment of the invention, the color of the shading area(s) 560 565 may change if the subject user's SG or BG readings are not located in the shaded area(s) 560 565 for any of the days being measured. For example, if the subject user post-meal readings for the breakfast meal event are never in the target range for the week timeframe being measured in the sensor overlay by meal report, the shaded analysis area(s) 560 565 may blink or the shaded area(s) 560 565 may change to a red color.

In FIGS. 5 and 5(a), the shaded analysis area(s) 560 565 is represented as a rectangle with two pairs of parallel sides. In alternative embodiments of the present invention, an upper SG or BG target range and/or a lower SG or BG target range in the shaded analysis area(s) 560 565 may be represented as a line with a slope or a line having a parabolic shape. In embodiments of the invention, the lower SG or BG threshold may have a different line shape (e.g., straight, sloped, parabolic) than the upper SG or BG threshold. In an embodiment of the invention, each of the meal event graphs 505 510 515 shaded analysis area(s) 560 565 may have a different line shape than the other meal event graphs' shaded analysis area(s) 560 565. In this embodiment of the invention, the different line shapes for the SG or BG levels may be selected in the advanced adjustable or configurable parameter selection section 340. Instead of selecting a low SG or BG reading or threshold and a high SG or BG reading or threshold, the advanced adjustable or configurable parameter selection section 340 may allow a selection of a starting SG or BG threshold (for the start of the analysis timeframe) and the selection of a slope (e.g., 10 mg/dl for every 30 minutes). Alternatively, or in addition to, the advanced adjustable or configurable parameter selection section 340 may allow the selection of an existing parabolic curve. For example, the DDMS 16 may display a number of parabolic curves that generally describe a number of patient's desired SG or BG thresholds or the subject user's desired SG or BG thresholds over a period of time.

The SG or BG meal event and time event table 520 presents SG or BG statistics for the selected analysis timeframes or areas. The DDMS 16 may calculate the SG or BG statistics. In the embodiment of the invention illustrated in FIG. 5(a), each row is directed to a different statistic, e.g., a SG or BG statistic, and each column is a different analysis timeframe (e.g., selected adjustable pre-meal analysis timeframe or period and selected adjustable post-meal analysis timeframe or period). In the embodiment of the invention illustrated in FIG. 5(a), the SG or BG meal event and time event table 520 displays the following blood glucose statistics: blood glucose range, a median blood glucose average blood glucose, high blood glucose reading, low blood glucose reading, standard deviation in the blood glucose readings, the number of blood glucose readings, a number of high excursions (i.e., a number of times the blood glucose readings were above the target blood glucose range), and a number of low excursions (i.e., a number of times the blood glucose readings were below the target blood glucose range during each analysis period. In an alternative embodiment of the invention, glucose statistics for sensor glucose readings may be calculated.

Other BG or SG statistics may be presented in the glucose meal event and time event table 520. In an embodiment of the invention, fewer BG or SG statistics may be presented in the glucose meal event and time event table 520. A subject-user may be able to select which glucose statistics are presented in the glucose meal event and time event table 520. For example, a drag and drop selection menu may be used to select particular glucose statistics to be presented in the glucose meal event and time event table 520. Alternatively, a menu may be presented with checkboxes or similar features to allow the subject user to select the glucose statistics that are to be displayed in the glucose meal event and time event table 520. In addition, other statistics such as insulin delivery statistics and carbohydrates consumed statistics may be presented in the glucose meal event and time event table 520 along with selected blood glucose statistics for the selected adjustable analysis timeframes. In the embodiment of the invention illustrated in FIG. 5(a), an average or a total of glucose statistics for all of the analysis timeframes are presented in a column (e.g., last far right column) of the glucose meal event and time event table 520.

The date legend 525 of the sensor overly by meal report 500 presents a reference legend for the meal event graphs 505, 510, 515. The date legend 525 may display a number of days and corresponding line color or shading, may display a number of weeks and corresponding line color or shading, or may display a number of months and corresponding line color or shading. In the embodiment of the invention illustrated in FIG. 5(a), the date legend 525 displays a number of or plurality of dates and the associated line color. The date legend 525 also displays a dotted line which represents the average of the dates measured and displayed in the meal event graphs.

FIG. 5(b) illustrates a bottom section of the sensor overlay by meal report according to an embodiment of the present invention. A daily average by meal event table 530 displays average blood glucose or sensor glucose readings or information for selected meal event or time event analysis timeframes. In an alternative embodiment of the invention, a daily statistic by meal event table 530 may display median blood glucose or sensor glucose readings or information for selected meal event or time event analysis timeframes. The daily average by meal event table may also include a shading legend 533 which describes whether the average blood glucose readings are in range, below target range, or above target range. As illustrated in the shading legend 533 of FIG. 5(b), a first shading type or color represents a below target range, a second shading type or color (which can be no shading) represents an in target range, and a third shading type or color represents an above target range. Instead of different shading types, different colors may be utilized to display whether the average blood glucose readings are in range, below target range, or above target range.

The daily average by meal event table 530 includes rows 570 corresponding to the dates for which the blood glucose levels are measured and columns 575 corresponding to the different adjustable or configurable selected analysis times. In alternative embodiments of the present invention, the columns and rows may be switched, i.e., where the rows represent the selected adjustable analysis times and the columns correspond to the dates where the BG or SG levels are measured. In embodiments of the invention, other BG or SG measurements may be displayed in the daily average by meal event table 530 if a subject-user desires to determine whether other blood glucose measurements were out of range during the selected adjustable analysis times. In most cases, the blood glucose average reading is utilized for the day reading in each of the selected adjustable analysis times because a subject-user is interested not in all the data points but in the average of a number of data points.

As illustrated in FIG. 5(b), one date and analysis time frame combination, represented by reference numeral 580 in the table 525, include a value that is below the target range established in the preferences section of the DDMS 16. A number of rectangles, two of which are represented by reference numerals 581 and 582, have average blood glucose or sensor glucose readings above the target threshold range. As discussed above, the color or shading may be attention-grabbing, e.g., for example the color or shading for a rectangle or box may start blinking if a below target range reading is measured. Because a blood glucose or sensor glucose average below a target range can represent a severe condition, the attention-grabbing coloring or shading may be necessary to place the subject-user on notice of the condition.

The sensor daily overlay by meal report 500 may also includes a meal event distribution pie chart and graph 535. The meal event distribution pie chart and graph 535 includes a graphical representation of how often the subject-user is in each of the designated states, i.e., above range, in range, and below range. In the embodiment of the invention illustrated in FIG. 5(b), columns of the meal event distribution chart and table represent each selected adjustable analysis timeframe. A chart (e.g., a pie chart), may also be displayed for each of the selected adjustable or configurable analysis timeframes. A table is also presented for each of the designated analysis timeframes which discloses a number of readings for each state within the selected adjustable analysis timeframes. For example, as illustrated in FIG. 5(b), the before dinner selected analysis timeframe 584 includes a pie chart and a section of the table, where 130 readings are above the target blood glucose range and 50 readings were below the target blood glucose range. The table also identifies that 72% of the BG readings are above the target level and 28% are within the target BG range. This percentage allocation of BG readings within the states is then displayed in the pie chart 585.

The daily average by meal event table 530 and the meal event distribution chart and table 535 display information in a different fashion. For example, the daily average by meal event table 530 may display that no BG or SG averages are below target range for a specified analysis timeframe, but the meal event distribution chart and table 535 may display or identify that a number of blood glucose readings were below the BG or SG target range for the specified analysis timeframe This is illustrated in FIG. 5(b), where for the after dinner analysis timeframe, the average BG or SG reading for the subject user is in range for all days, as identified by reference numeral 590, yet there were 65 readings during the after dinner timeframe for the entire measured time period that were below the BG target range, as illustrated by reference numeral 595.

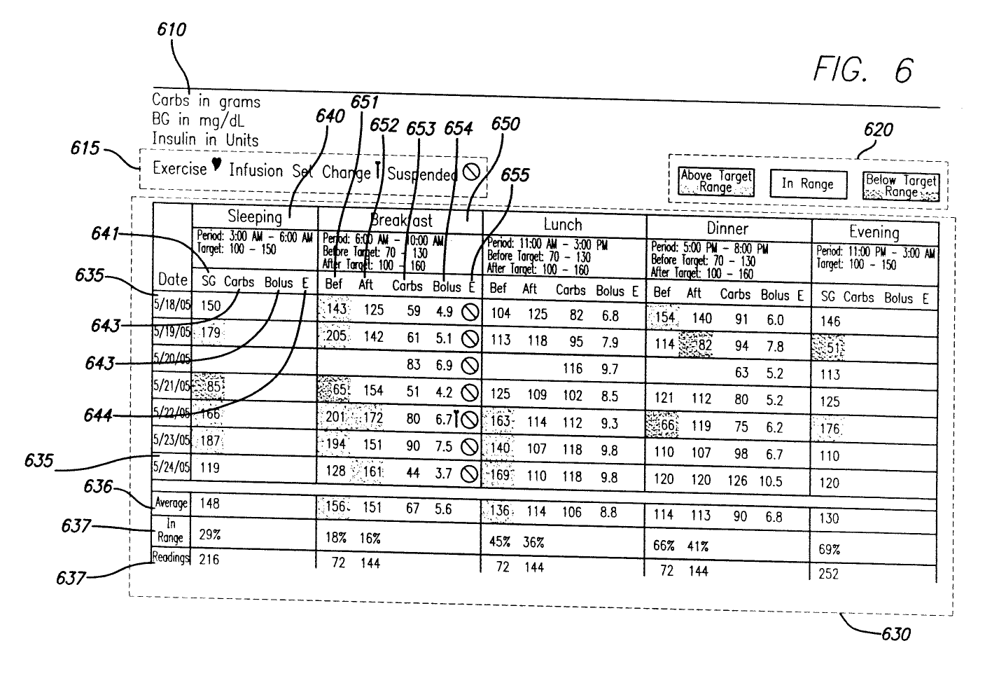

The DDMS 16 may also generate a report that provides a summary or logbook for important information of a subject-user's diabetes therapy. The report may be referred to as a Sensor Weekly Logbook Report. FIG. 6 illustrates a sensor weekly logbook report according to an embodiment of the present invention. The DDMS 16 may automatically generate the report to provide a subject-user utilizing Medtronic MiniMed equipment, such as a Medtronic MiniMed Paradigm 522 infusion pump, a glucose sensor, or a glucose meter, with glucose information. As illustrated in FIG. 6, the Sensor Weekly Logbook Report shows the timeframe for the logbook, e.g., Mar. 10, 2003-Mar. 13, 2003. The Sensor Weekly Logbook Report 600 may also provide the subject-user with information regarding the insulin infusion pump, e.g., model number and serial number, as well as information regarding the operational status of a sensor.

As illustrated by reference numeral 610, the Sensor Weekly Logbook Report may also show units for the carbohydrates (e.g., grams), units for the blood glucose or sugar glucose (SG) (e.g., mg/dL), and insulin units.

The Sensor Weekly Logbook Report 600 also illustrates symbols 615 for certain outside events that occur. For example, a heart may symbolize an exercise event; a needle may symbolize a infusion set change event; and a circle with a cross through it may signify that a sensor (or pump) has its operation suspended.

The Sensor Weekly Logbook Report 600 also includes a status legend 620. The status legend may provide three states, e.g., “above target range,” “in range,” and “below target range.” In the embodiment of the invention illustrated in FIG. 6, the “above target range” is represented by a rectangle having a yellow shading. The “in range” is represented with no shading or a white shading. The “below target range” is represented with an orange shading.

The Sensor Weekly Logbook Report includes an overall table 630. A number of rows 635 of the table 630 may signify the dates for which the logbook has been kept. A second number(s) of rows 636 may identify the average SG or BG reading for dates for which the logbook has been kept. A third number of rows 637 may signify a percentage of BG readings within a target glucose range and a total number of BG readings. In addition, other medical or treatment information may be input into the Sensor Weekly Logbook report.

In the overall table 630 of the Sensor Weekly Logbook report, each meal event and time event may have a corresponding event table. For example, the sleeping time event, the breakfast meal event, the lunch meal event, the dinner meal event, and the evening time event each may have a corresponding event table. Although only a single time event table is described and a single meal event table is described below, the description applies to other defined meal event tables or time event tables.

The time event table 640, e.g., sleeping, may display or provide a subject-user with a period which is defined as the time event. In other words, through the parameter input screen 300, a subject-user may have defined a sleeping event timeframe as being 3:00-6:00 am and this is presented in the time event table 640. The time event table 640 may also provide the user with a target blood glucose range for the time event timeframe. As illustrated in FIG. 6, for the sleeping time event, the target BG or SG range is 100-150.

The time event table 640, e.g., the sleeping event table, also includes columns for an average or median SG or BG reading 641, a carbohydrate consumed reading 642, a bolus intake reading 643, and an outside event display 644. As discussed above, if data has been supplied for each of the columns in each of the measured days of the logbook, a value is presented or displayed. In FIG. 6, no SG or BG reading is available for the sleeping timeframe of May 20, 2005, and no carbohydrates consumed, boluses received, or outside events have been entered into the DDMS 16. In FIG. 6, although one of the day's reading has not been provided, an average BG or SG reading is presented in the sleeping event table 620, a percentage of readings within a target BG or SG range is displayed, and a number of BG or SG readings is also displayed.

The overall table 630 also includes a meal event table 650, e.g., a breakfast event table. The meal event table (e.g., breakfast event table) also provides a subject-user with a period in which the breakfast event is to take place. Note that this may not be the analysis timeframe for which BG or SG readings are displayed. The meal event table 650 also provides a subject-user with a before meal event BG or SG target range and an after meal event BG or SG target range. For each of the days having measurements in the Sensor Weekly logbook, the breakfast meal event table 650 displays a before meal average or median BG or SG value 651, an after meal average or median BG or SG value 652, a carbohydrates consumed value 653, and a bolus intake value 654. In addition, a symbol 655 representing an outside event may also be provided. The before meal average or median BG or SG value 651 and the after meal average or median BG or SG value 652 may be calculated for the selected adjustable or configurable before-meal analysis timeframe and the after-meal analysis timeframe, respectively. It is important to recognize that this is not the timeframe listed at the top of the meal event timeframe (in FIG. 6, 6:00 am-10:00 am). Instead, it is the time selected for the adjustable or configurable pre-meal analysis and adjustable post-meal analysis in the advanced adjustable or configurable parameter selection section 340 (see FIG. 3).

As illustrated in FIG. 6, for the breakfast event table 650, on May 18, 2005, a before meal average blood glucose reading is 104, an after meal average BG or SG reading is 125, 59 grams of carbohydrates have been consumed, 4.9 bolus units were ingested to counteract the carbohydrates, and an outside event (e.g., a status of a infusion pump or a glucose sensor) is in a suspended mode. Under certain operating conditions, the carbohydrates consumed value and the bolus ingested value are calculated or displayed for the entire meal event timeframe, i.e., in FIG. 6, 6:00-10:00 am. Under other operating conditions, the carbohydrates consumed value and the bolus ingested value are calculated for the meal event only. In other words, the DDMS 16 may only capture grams of carbohydrates and corresponding bolus for the first occurrence (7:30 am) during, for example, a breakfast timeframe, e.g., 6:00 am-10:00 am. Even if another consumption of carbohydrates or ingestion of bolus is recorded, for example at 9:45 a.m., the DDMS 16 may not include those carbohydrate grams in the bolus ingested column 654 of the meal event table 650. The meal event table 650 also presents or displays the average BG or SG reading for the meal event timeframe of the days captured in the logbook report, the number of readings for the meal event timeframe of the days captured in the logbook report, and the percentage of BG or SG readings for the meal event timeframe of the days captured in the logbook report.

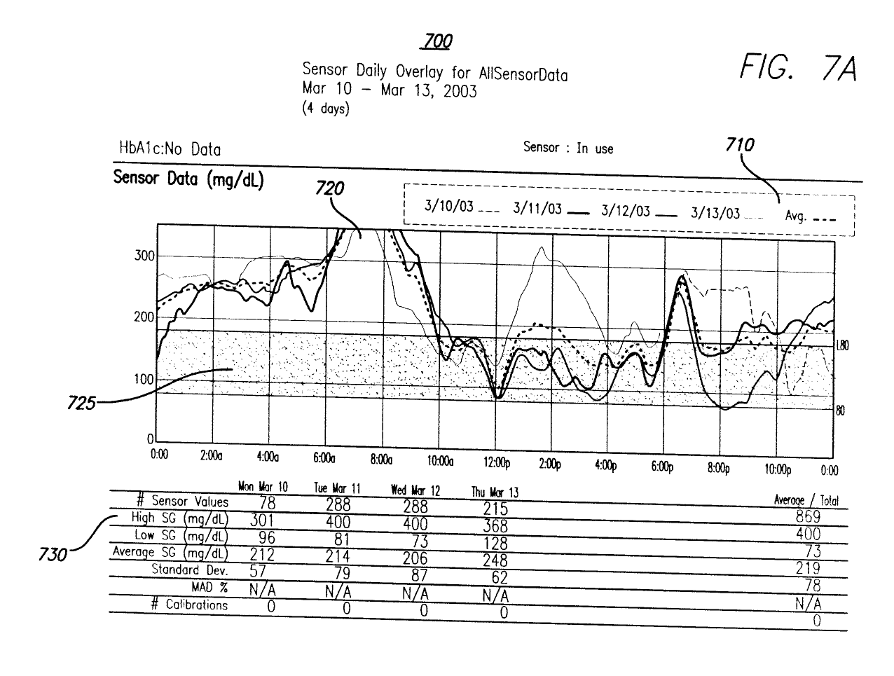

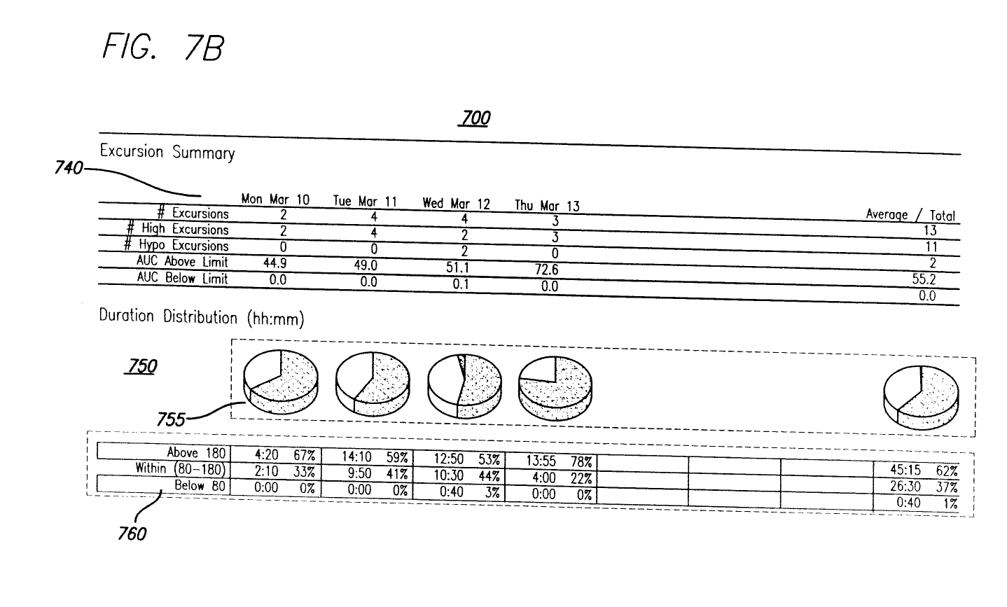

The DDMS 16 may also utilize the received data from the glucose sensor and glucose meter and the user-supplied parameter selections (e.g., preferences) to generate a report to provide daily SG or BG readings for a number of days. FIGS. 7(a) and 7(b) illustrates a top half and a bottom half of a sensor daily overlay report according to an embodiment of the present invention. Illustratively, this report may be referred to as the Sensor Daily Overlay for All Sensor Data report (hereinafter referred to as the Sensor Daily Overlay report). The Sensor Daily Overlay report 700 may include a date legend 710, a daily sensor graph 720, a daily sensor table 730, an excursion summary table 740, and a duration distribution chart and table 750. The duration distribution chart and table 750 includes a duration distribution chart 755 and duration distribution table 760. The Sensor Daily Overlay report 700 may include other statistics such as bolus information, insulin delivery information, carbohydrates consumed, etc.

The Sensor Daily Overlay report date legend 710 displays the dates for which the reports have been generated and the symbol that are utilized to represent the date on the daily sensor graph 720. The date legend 710 also includes a symbol representing the average or median SG reading (e.g., a dotted line) for the dates for which the report has been generated. Each date may have a corresponding symbol that is a color different from the other date symbols, a line thickness different from the other date symbols, or a shading different from the other date symbols.

The daily sensor graph 720 displays the continuous SG or BG readings for each day. The daily sensor graph 720 has an x-axis that represents the timeframe within a day and the y-axis that represents the SG readings. Imposed across the daily sensor graph is a blood glucose or sensor glucose target level range 725 for the entire day. In an embodiment of the invention, the parameters (e.g., preferences) selected in advanced adjustable or configurable parameter selection section 340 are not applied to the daily sensor graph 720 (or the Sensor Daily Overlay report). In an alternative embodiment of the invention, not displayed in FIG. 7, the parameters selected in the advanced adjustable or configurable parameter selection section 340 are applied to the daily sensor graph.

The daily sensor table 730 may display a number of SG or BG statistics for each day included in the Sensor Daily Overlay report 700 along with an average (median)/total for all of the days included in the Sensor Daily Overlay report. In the embodiment of the invention illustrated in FIG. 7, the SG statistics for each day may include 1) a number of sensor values; 2) a high SG reading; 3) a low SG reading; 4) an average SG reading; 5) a standard deviation in the SG readings; and 6) a mean absolute difference (MAD) % for the SG readings. The MAD value is often utilized for diagnostic and tracking purposes of how the glucose sensor is performing. Illustratively, the MAD value may be calculated by taking, for each pair of SG readings, the absolute difference between the meter reading and the sensor glucose, dividing by the meter value, and then averaging across all pairs. Under certain operating conditions, a number of calibrations per day may also be included in the daily sensor table 730. The number of calibrations may provide a subject user with information on how accurate the sensor glucose readings are in comparison to blood glucose readings. In other words, if the glucose sensor has not been calibrated in a day, the glucose readings may not be as accurate as when the glucose sensor has been calibrated once or twice in a day.

FIG. 7(b) illustrates the excursion summary table 740 and the duration distribution table and chart 750. The excursion summary table 740 displays or provides a number of out-of-range conditions for each day included in the Sensor Daily Overlay report 700 along with a total or average (median) condition for all of the days having measurements in the Sensor Overlay report 700. In the embodiment of the invention illustrated in FIG. 7(b), the excursion summary table 740 may include the number of excursions (e.g., out of sensor glucose target range occurrences) for each day included in the Sensor Daily Overlay report 700. The excursion summary table 740 may include the number of high excursions (e.g., greater than the upper SG or BG target level) and the number of low excursions (e.g., less than the upper SG or BG target level) for each day. The excursion summary table 740 may also display a percentage of Area Under the Curve (AUC) calculation above limit events for each day and a percentage of AUC below limit events for each day. AUC above limits may be determine by calculating the area created by the sensor tracing when it exceeds the upper target range limit and the AUC below limits shall be determined by calculating the area (glucose concentration*time) created by the sensor tracing when it is below the patient lower target range limit. In the average(median)/total column of the excursion summary table 740, the # of excursions are totaled (rather than averaged), the # of high excursions are totaled, the # of low excursions are totaled, the AUC above limit is averaged and the AUC below limit is averaged.

The duration distribution table 760 includes rows for above SG or BG target threshold readings, within SG or BG target threshold readings, and below SG or BG target threshold readings. As illustrated in FIG. 7, the high SG or BG threshold is 180, the low SG or BG threshold is 80 and within the target range is 80-180. For each day included in the Sensor Daily Overlay report 700, a reading is provide which measures duration distribution identifies an amount of time that the subject-user is within the selected configurable target range, above the target range, and below the target range. The glucose sensor may not be in use for the entire timeframe so the timeframe may not add up to an entire measuring timeframe, e.g., 4:20 is 4 hours and 20 minutes. Also, for each day in the Sensor Daily Overlay report 700, the duration distribution table 760 provides or displays a percentage of time during each of the days that the subject user was within each of the states, i.e., above SG or BG target threshold, below SG or BG target threshold, and within SG or BG target threshold. The duration distribution table 760 also provides an overall percentage of time in each of the above-identified states for all of the days with measurements in the Sensor Daily Overlay report 700 in a total column 765. The duration distribution graph 755 provides a graphical representation of the percentage of time in each of the states (above, within, or below SG target thresholds). In the embodiment of the invention illustrated in FIG. 7(b), the graphical representation is a pie chart.

Embodiments of the invention may also be utilized in other medical data management systems. Illustratively, the Medtronic MiniMed Virtual Patient system may utilize the capability of selecting adjustable blood glucose target ranges for meal events and time-based events. The Medtronic MiniMed Virtual Patient system may utilize the capability of selecting adjustable analysis timeframes before and after meal events. In addition, the Medtronic MiniMed Virtual Patient system may generate statistics for the adjustable analysis timeframe. The Medtronic MiniMed Virtual Patient system is described in detail in U.S. patent application Ser. No. 11/145,485, filed Jun. 3, 2005, entitled Virtual Patient Software System for Educating and Treating Individuals with Diabetes, Attorney Docket No. 40088-316103.

The following menus disclose copies of example screens in the DDMS 16. These menus are provided as an example of an embodiment of the invention and are not intended to limit the scope of other embodiments of the invention.

The menus relate to a medical data management system 16 configured for diabetes subjects and, thus, is referenced as a “diabetes data management system.” However, as described above, other embodiments of the invention may be employed for other types of medical conditions or for medical data in general.

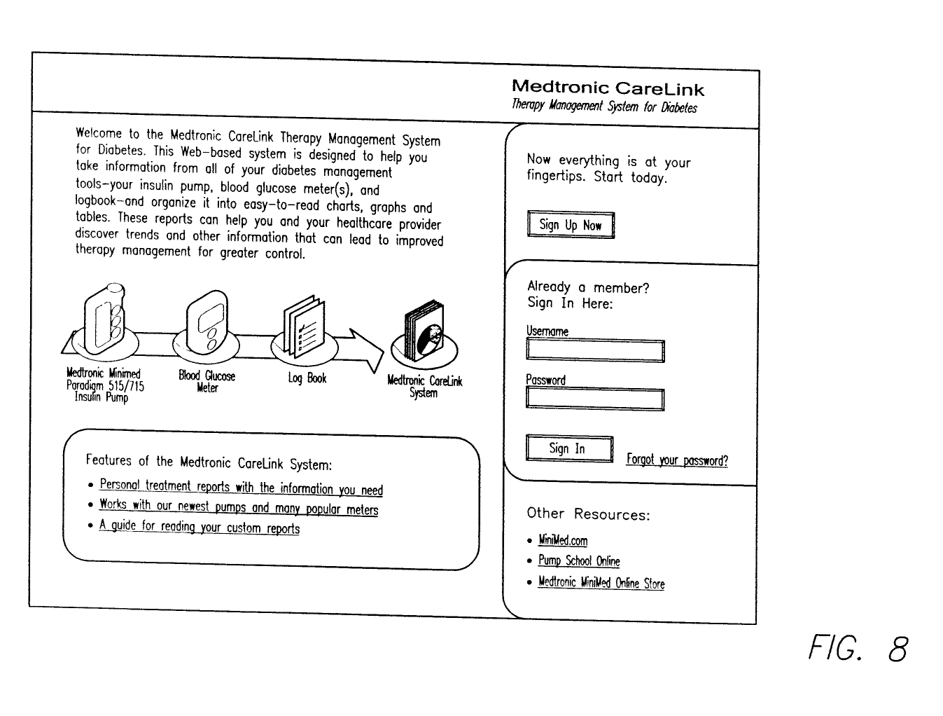

FIG. 8 illustrates an initial “login” menu or page of a medical data management system according to an embodiment of the present invention. The initial “login” page may be the starting screen or a home page for a system. The login page includes a location having labeled fields for the user to enter a username and a password and a selectable icon (labeled “Sign In”) to allow a user to click and send information entered into the username and password fields to the system 16. The login page also includes a selectable icon (labeled “Sign Up Now”) to allow a new user to access (or link to) an enrollment or registration page.

The login page also may include descriptions and/or links to of some of the activities or information that may be available through the DDMS 16 and descriptions and/or links to one or more legal notices, terms of use, a privacy statement and contact information. In FIG. 8, the example login page includes selectable icons, to link the user to a privacy statement, terms of use and contact information (labeled “Privacy Statement,” “Terms of Use,” and “Contact Us,” respectively). Also, in the example shown on FIG. 8, the example login page includes selectable icons for linking the user to pages or network sites associated with such resources as a company that produces subject support devices (e.g., MiniMed.com), an instruction or training session (e.g., Pump School Online), and an on-line store that allows a user to order and/or purchase pharmaceuticals and medical equipment such as, but not limited to, replacement infusion sets, insertion tools, insulin supplies, or the like. The icons or links may be selected by a mouse-click, keyboard input, touch screen input or other suitable input operation on the user's computer.

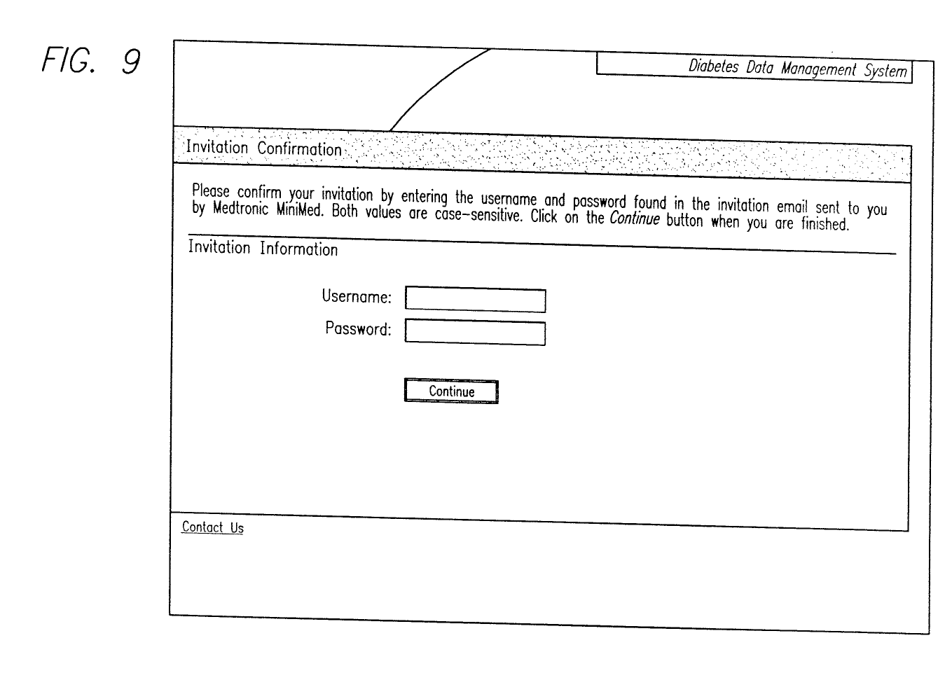

FIG. 9 illustrates a confirmation screen according to an embodiment of the present invention. FIG. 9 illustrates a “confirmation” menu which the system 16 may provide, in response to receiving a user's login information (username and password). The confirmation menu includes a request for the user to re-enter the username and password and has a location including fields in which the user may enter that information. The confirmation menu also includes a clickable icon, labeled “Continue” that allows the user to send information entered into the username and password fields to the system 16. The confirmation page may also include clickable links to other locations within the system (such as a link to contact information, labeled “Contact Us”).

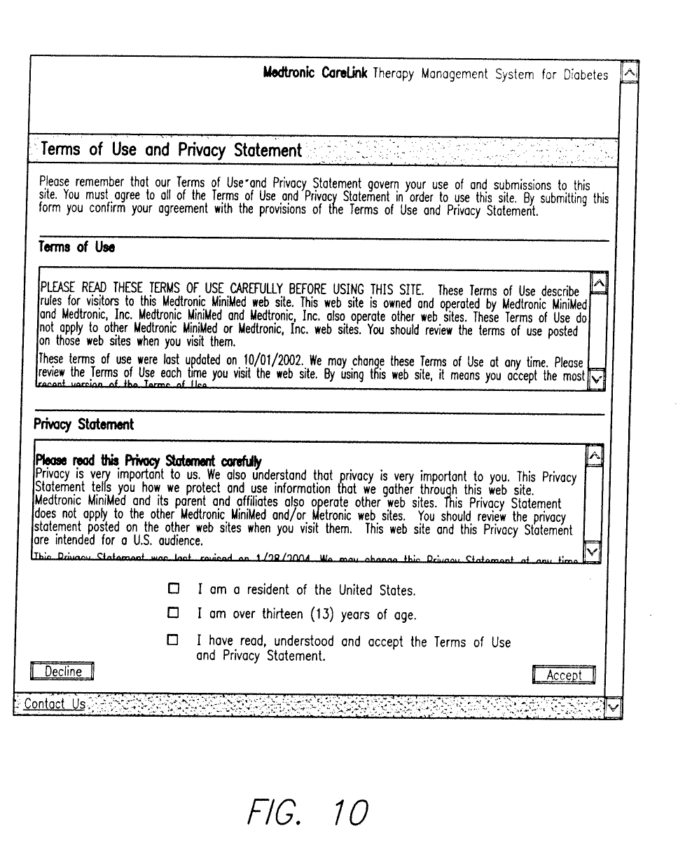

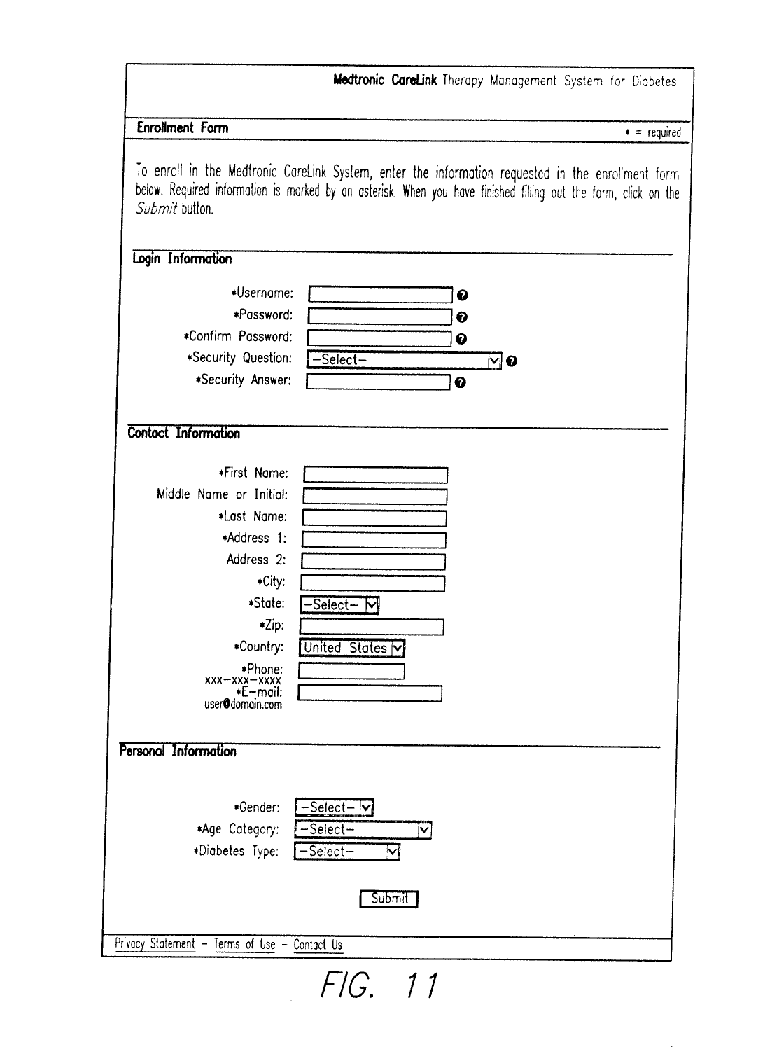

FIG. 10 illustrates a terms and privacy screen according to an embodiment of the present invention. FIG. 10 shows a “terms of use and privacy statement” menu, which includes a description of teams of use of the system 16 and a privacy statement. The menu or page may also include locations, such as labeled fields, in which a user may enter information, such as information confirming that the user (1) is a resident of particular area or country, such as the United States, (2) is over a certain age, such as over thirteen years of age, and (3) has read, understood and accepted the terms of use and the privacy statement. The menu or page may include selectable icons for allowing a user to accept or decline the terms or statement (labeled “Accept” and “Decline,” respectively). The terms of use and privacy statement menu or page may also include clickable links to other locations on the website (such as a link to contact information, labeled “Contact Us”). If the system 16 receives a user's selection of the “Accept” icon, then the system will allow the user to proceed with the access process. If the system 16 receives a user's selection of a “Decline” icon, then the system may end the session and log off the software and/or link the user to another website, another website location or back to the main operating screen of the system 16.

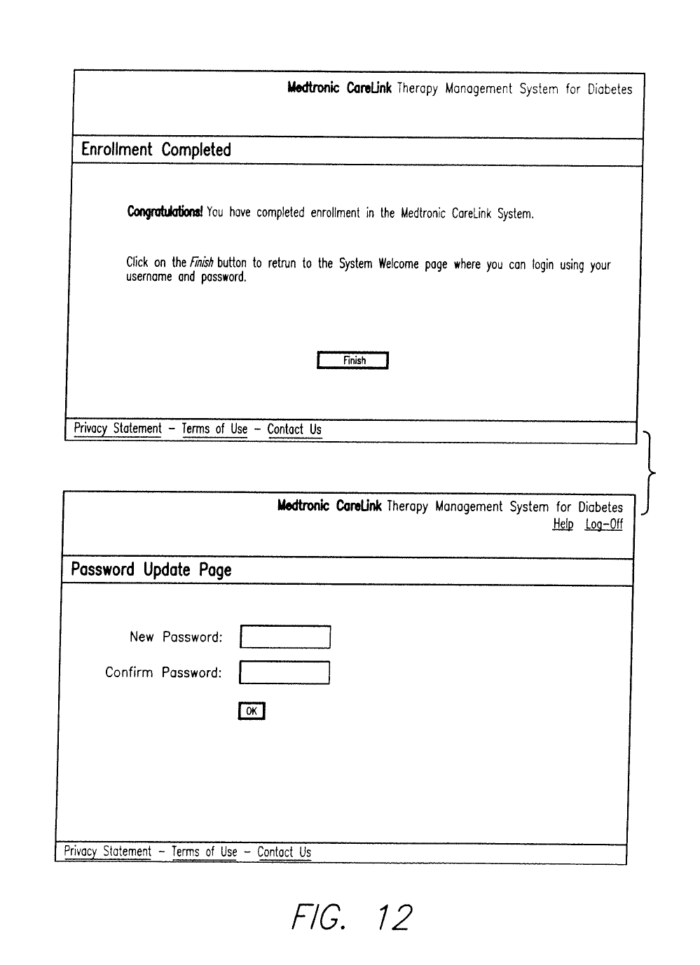

FIG. 11 illustrates an enrollment form menu according to an embodiment of the present invention. FIG. 11 displays an “enrollment form” menu that may be provided to a system visitor who has selected the “Enroll” icon from the login menu, to allow a new user to enroll or register with the system 16. The enrollment form menu provides locations, including labeled fields, for a user to enter certain contact information, including the user's name (first, last and middle), address, country, telephone number and email address. The enrollment menu may also have locations, including labeled fields, for a user to enter additional information that may be relevant to the subject's medical condition (such as, but not limited to, gender, age or age category, diabetes type, or the like). The enrollment menu may also include one or more security questions and corresponding security answers. A security question may be selectable from a pre-defined group of security questions (such as questions that ask for the user's mother's maiden name, pet's name or the like). Various selectable security questions may be displayed to the user, as a menu, list or other arrangement, for example, upon the user selecting (for example, clicking on) an appropriate icon on the enrollment form page (such as the arrow to the right of the security question entry field). Security questions may be used by personnel operating the system 16 to verify the authenticity of a user, for example, if a user contacts the system 16 personnel for assistance or if the system 16 personnel contact a user to provide information or respond to a request.

A selectable icon (labeled “Submit”) may be provided to allow a user to send an enrollment form from the enrollment menu with completed subject information, to a validator within the system 16. The enrollment form menu (as well as other menus) may also include clickable links to other locations within the software in the DDMS (such as links labeled “Contact Us” and “Privacy Statement-Terms of Use”).

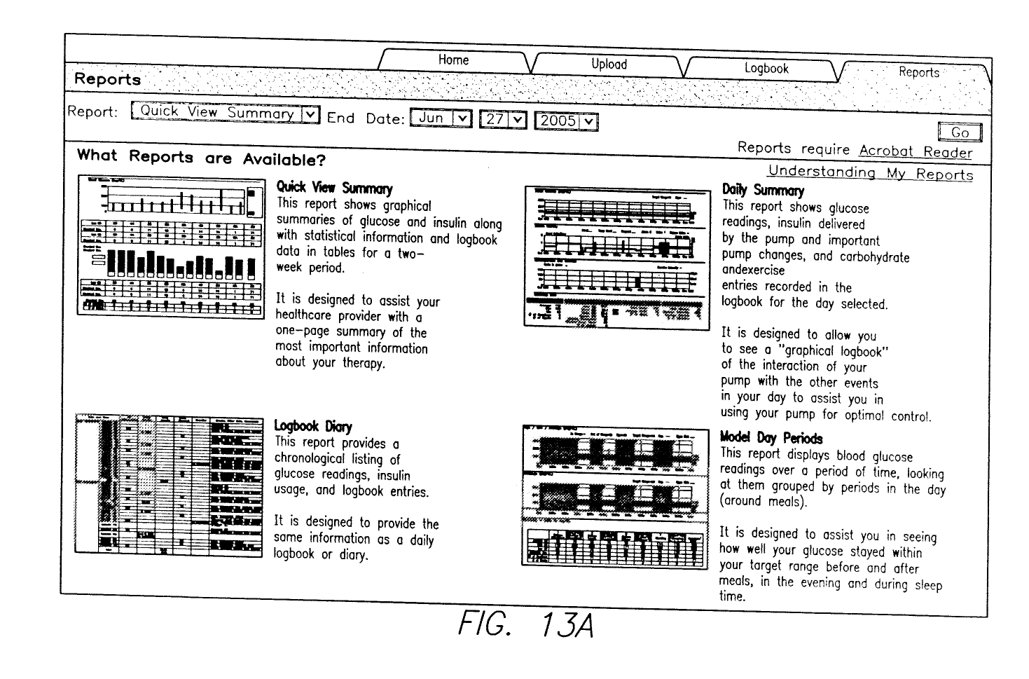

FIG. 12 illustrates two menus for confirming enrollment and changing a password according to an embodiment of the invention. These two menus may be provided to system users or website users. The top half of FIG. 12 shows an “enrollment completed” men that is provided to a new user, upon successfully completing and sending a new enrollment form (from FIG. 11). The “enrollment completed” menu may include a message informing the user of a successful completion of an enrollment process. The menu may also include a selectable icon (labeled “Finish”) that may be selected by the user, to return the user to the initial or login menu (FIG. 8), to allow the user to officially login by entering a username and password. The user name and password may be provided to or selected by a user during the enrollment or registration process.

Upon returning to the initial or login menu, the new user may be prompted to change the user's password. The additional security measures of requiring a user to change the password after initial enrollment and before a first use of secure features of the system 16, may provide additional security, for example, in the event that the user's password is compromised during the initial enrollment procedure (e.g., as a result of system administrators, healthcare providers or other individuals or entities assisting the user with the enrollment process).

The bottom half of FIG. 12 shows a “password update page” in which a user may change a password. The password update page may include a labeled field or other location in which the user may enter a new password. The page may also include a similar field or location in which the user may enter the password again, to confirm the password.

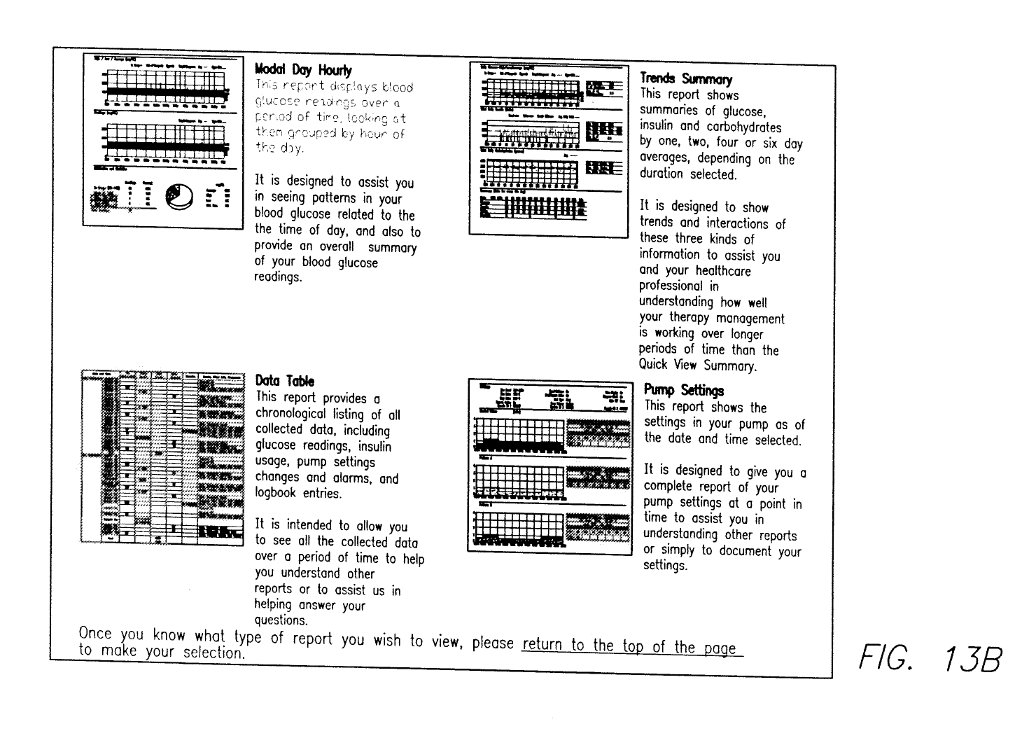

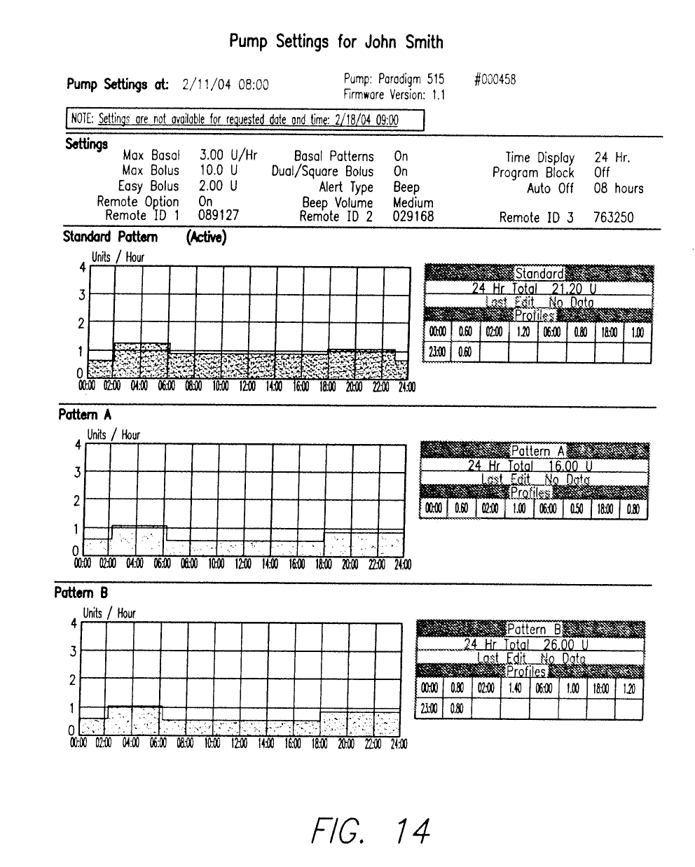

FIGS. 13(a) and 13(b) show a “reports available” menu that may be provided in response to a user's selection of an icon for generating or otherwise accessing reports (i.e., the “Reports” tab-icon on the menu shown on FIG. 2(a)). The “reports available” menu may include a list or other suitable organization of selectable icons representing different types of reports, where different reports may include some or all different information relative to other reports and/or include information in different formats relative to other reports. In the illustrated embodiment, the “reports available” menu includes selectable icons in the form of small representations of a page of the report corresponding to the icon and brief descriptions of the report and the type of information contained in the report. Alternatively, or in addition, the “reports available” menu may have a location including fields for a user to enter a type of report, a date (or period of dates) for which the data in the report is to encompass and/or a time (or period of times) for which the data in the report is to encompass. The field for the type of report to be generated may include a user-selectable icon that, when selected, causes the system 16 to display a list, menu or other suitable arrangement of available reports for selection by the user.

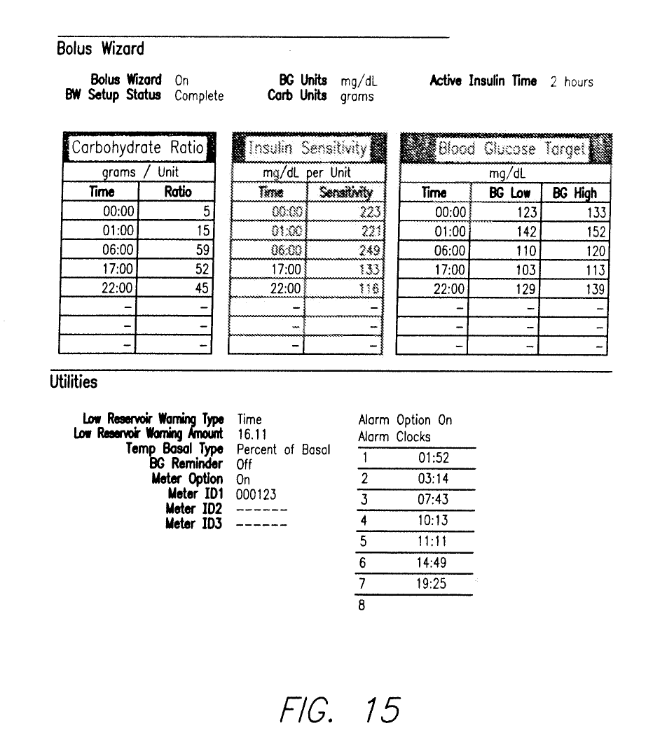

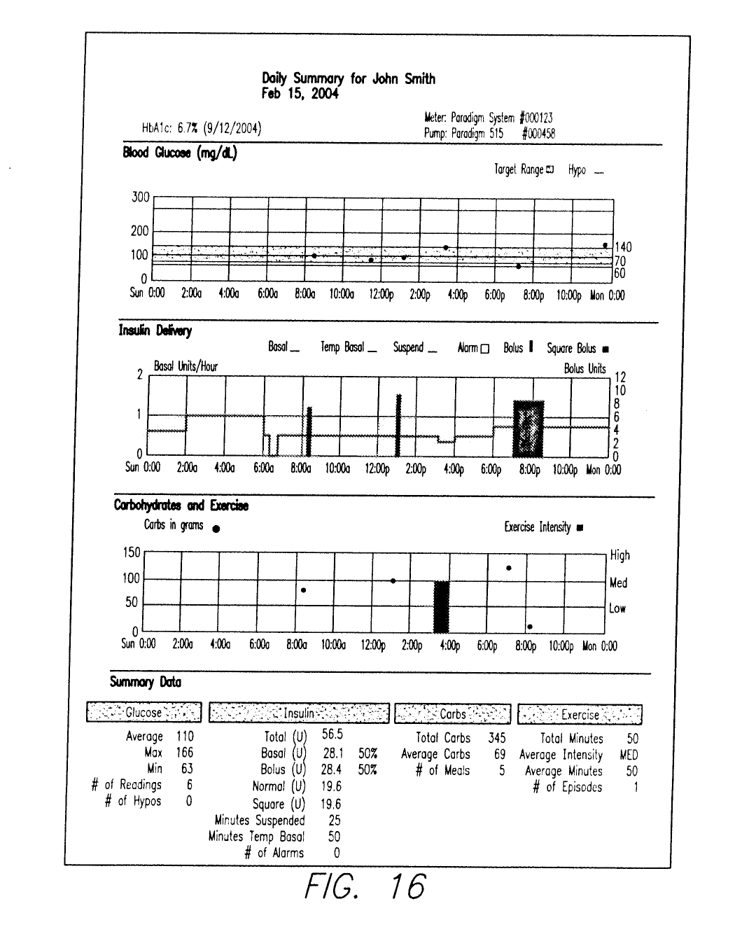

FIGS. 14 and 15 illustrate a pump settings report according to an embodiment of the present invention. FIGS. 14 and 15 are a repetitive example of a “pump settings” report that may be generated by the system 16. FIG. 16 is a representative example of a “daily summary” report according to an embodiment of the present invention. The “daily summary” report may be generated by the system 16. Other reports may be generated, depending upon the role, needs and selections of the user. In one example embodiment, a predicted glycemic or a predicted glucose and insulin activity curve may be provided. For example, such curves can show, in a graph, a prediction of the effect on a subject's blood glucose level that a particular event or activity (such as ingestion of a meal) will have. The report may also show actual blood glucose levels (based on sensor or meter readings) and, in some embodiments, may show reprehensive actual blood glucose levels over a defined time period on a graph separate from or in combination with a graph of predicted blood glucose levels over the same time period.

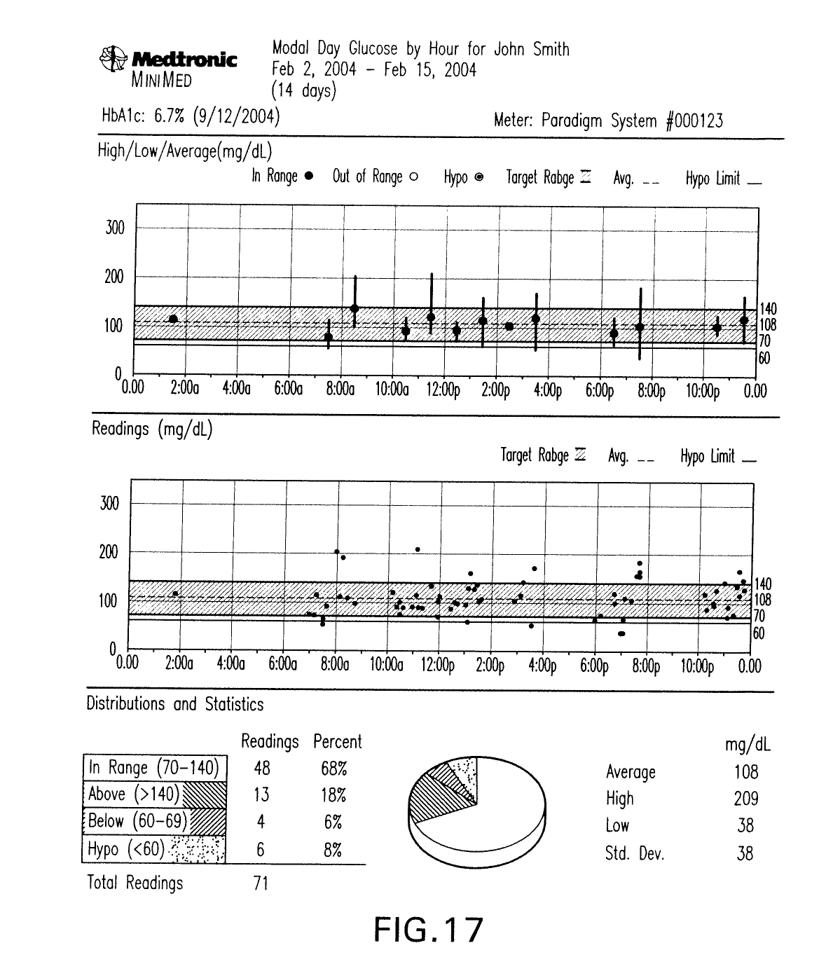

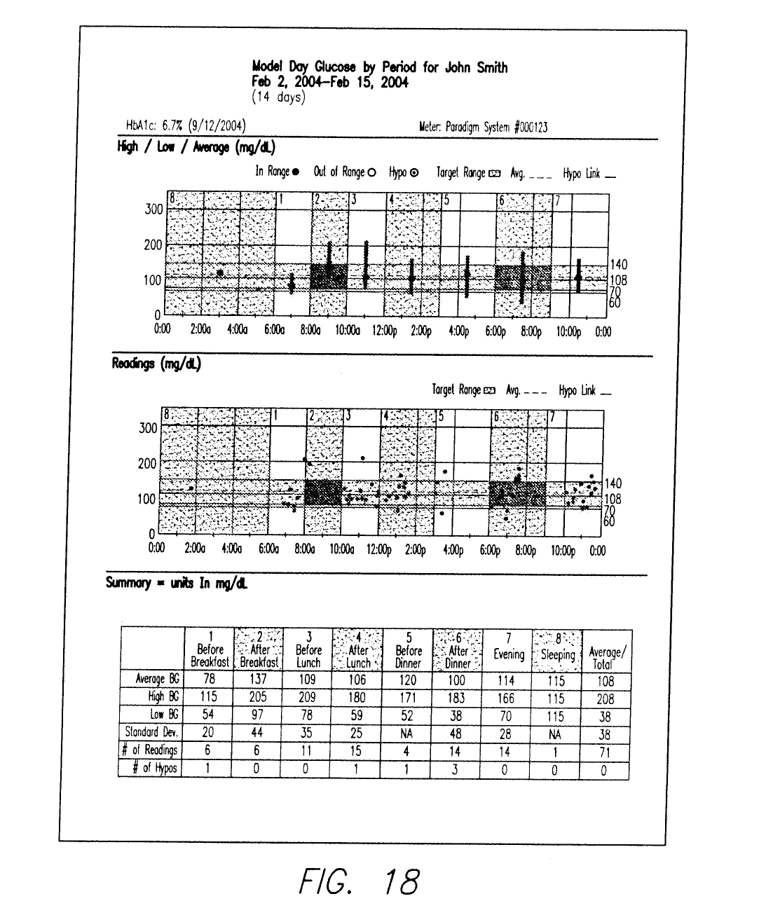

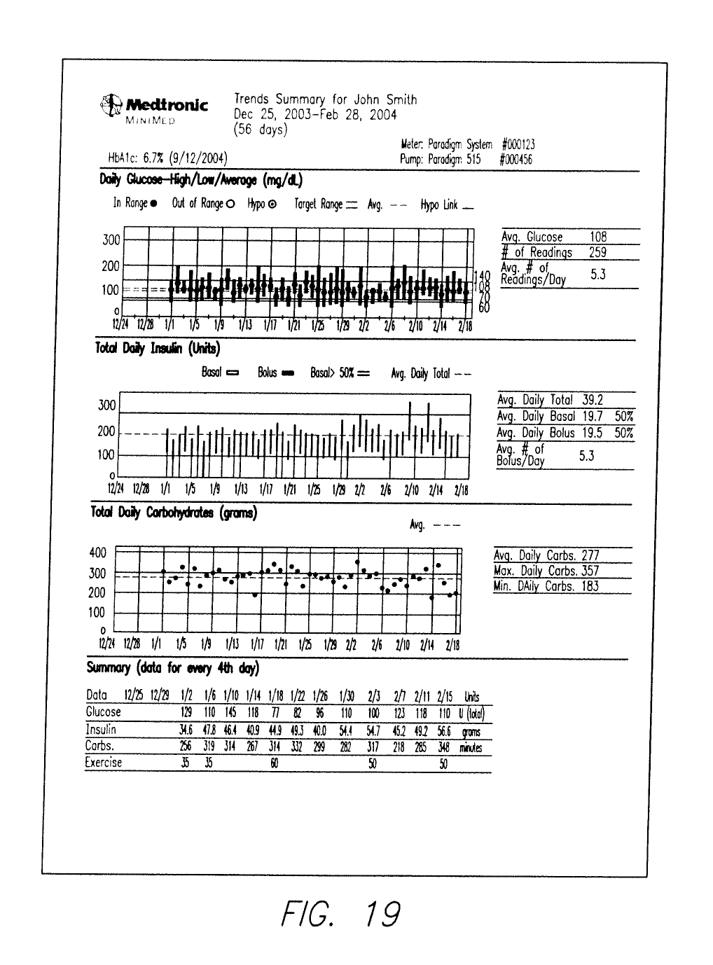

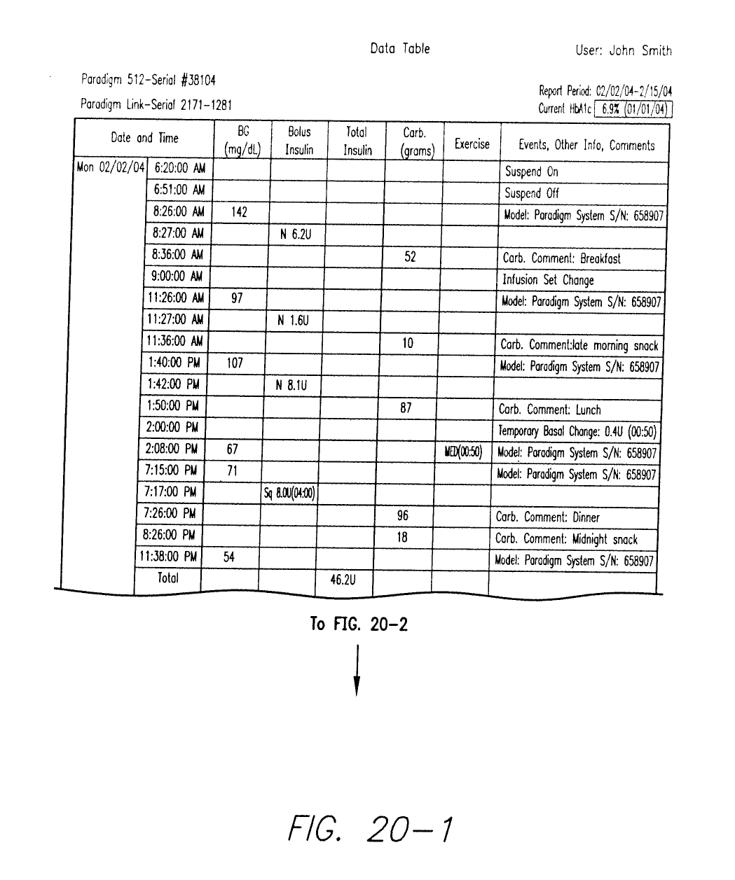

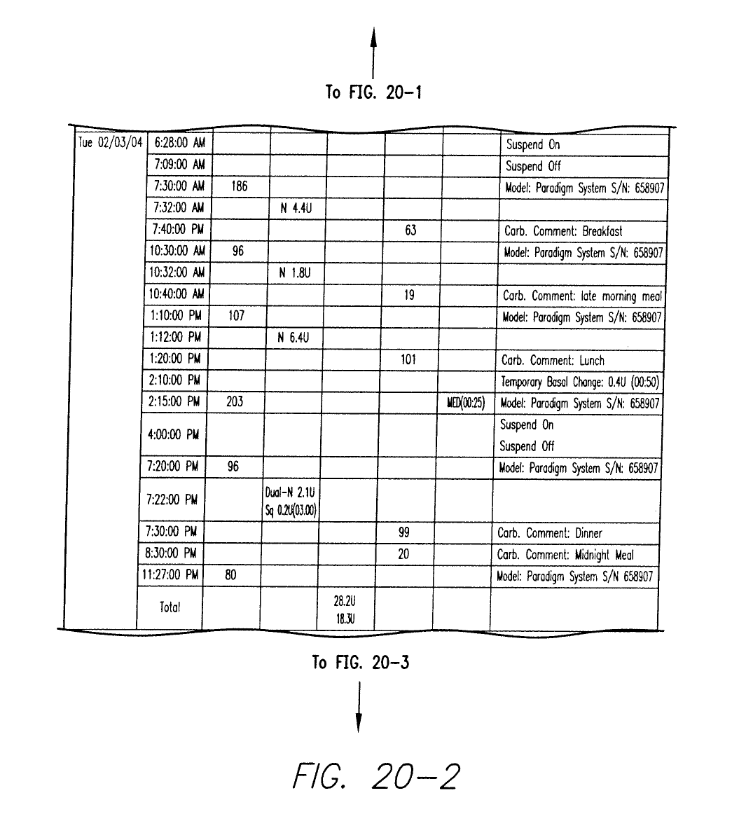

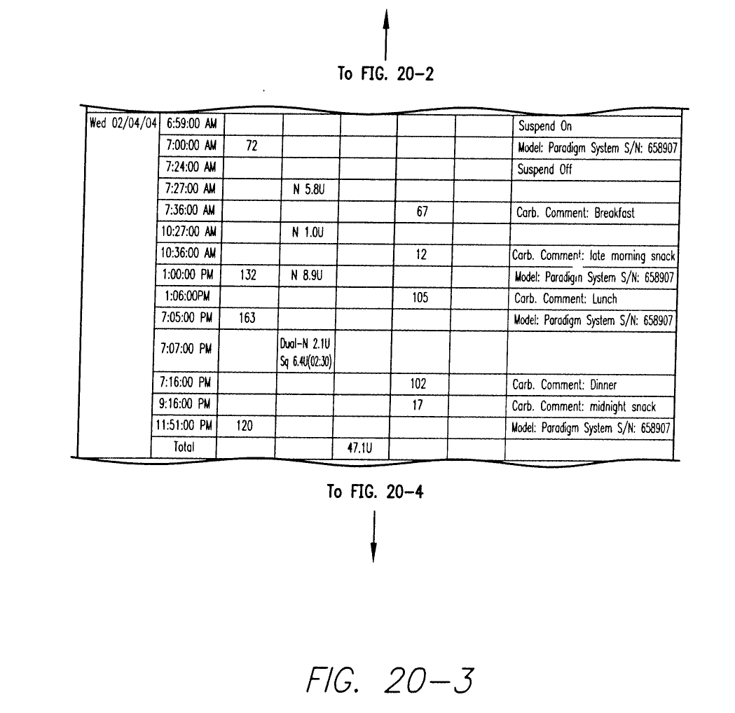

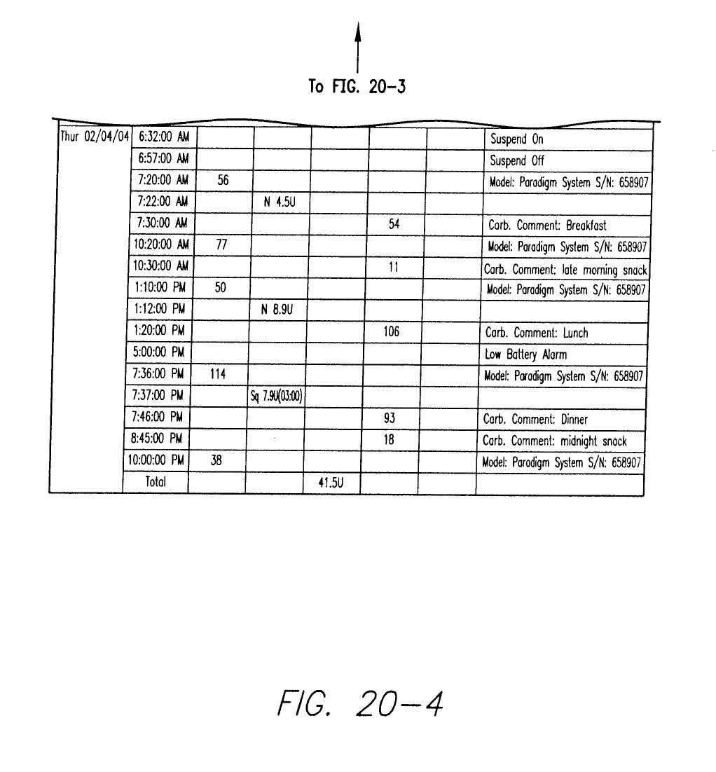

FIG. 17 illustrates a hourly standard day glucose report according to an embodiment of the present invention. FIG. 18 illustrates a period standard day glucose report according to an embodiment of the present invention. FIG. 19 illustrates a trend summary report according to an embodiment of the present invention. FIG. 20 illustrates a data table report according to an embodiment of the present invention.

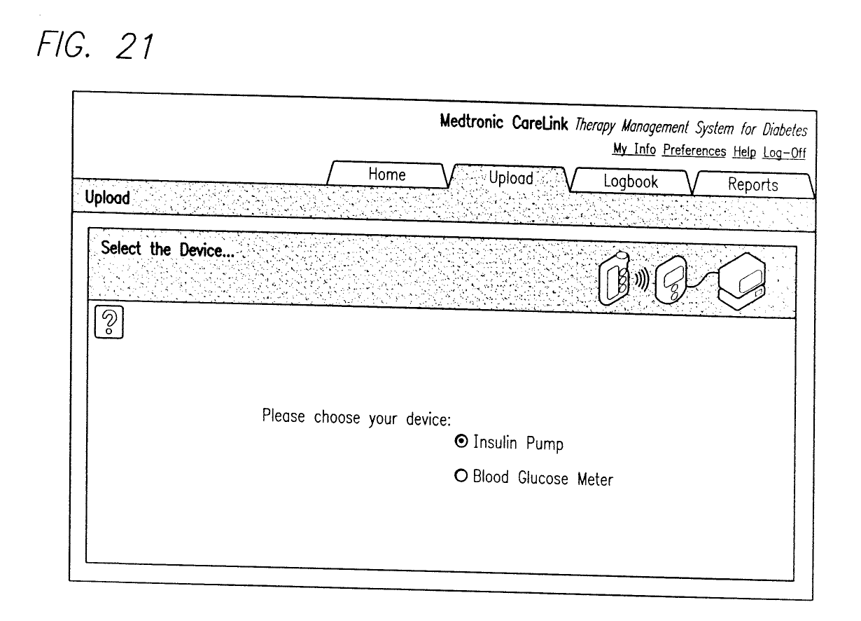

FIG. 21 illustrates an initial upload menu according to an embodiment of the present invention. FIG. 21 shows examples of an initial “upload” menu that may be provided in response to a user's selection of an icon for uploading data from a general type of subject support device (i.e., the “Upload” tab-icon on the menu illustrated in FIG. 2(a)). Upon selecting an option to upload data from one of the selectable general types of subject support devices 12, the system 16 (and/or software 19 or 21) may implement an upload routine (or wizard) for providing a series of instruction pages to assist the user in the upload operation from the selected type of subject support device. Some instruction pages (or each instruction page) may include a request for information and require the user to enter information, where the next instruction page in the series may depend upon the user's input of information. In this manner, different instruction pages may be given to different users, based on the user's input on previous instruction pages, such that a user may be provided with a series of instructions pages that is related to the particular type of subject support device 12 employed by that user.

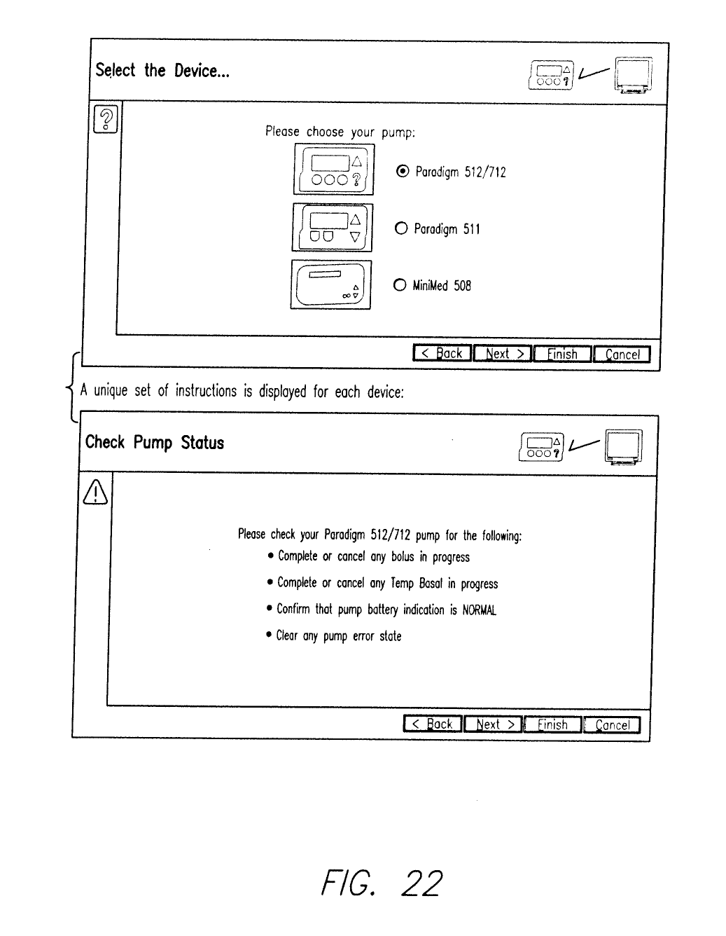

In the illustrated embodiment, the initial “upload” menu of FIG. 21 is part of a series of upload instruction pages that provide step-by-step instructions for uploading data from any one of various types of subject support devices 12 that may communicate with the system 16. FIGS. 22-28 illustrate instructions for uploading data from various types of subject support devices that communicate with the system. Each upload instruction menu may include an icon (for example, labeled “Next>” in FIGS. 22-28) to allow a user to select the next instruction page in the series after the user enters requested information on a current menu in the series. Each upload instruction page after the initial upload instruction page may include another icon to allow a user to return to the previous instruction page in the series (where such icon is labeled “Back<” in FIGS. 21-28).

The initial “upload” menu may include a location for the user to enter information identifying the type of subject support device that will be uploading data to the system 16. In the illustrated embodiment, the user is provided with selectable icons labeled “Insulin Pump” and “Blood Glucose Meter” and is allowed to select one of those icons. Other embodiments may include other suitable selectable icons corresponding to other types of subject support devices. Some or all of the upload instruction menu may include a selectable icon to cancel the upload procedure (where such icon is labeled “Cancel” in FIGS. 21-28). Also, some or all of the upload instruction menu may include a selectable icon to allow the user to skip some or all steps, for example, where the user has previously accessed information or provided information required in those steps (where such icon is labeled “Finish” in FIGS. 21-28).

In the illustrated example in FIG. 21, the user is provided with locations to enter information identifying the general type of subject support device employed by the user. For example, the initial upload menu includes selectable text icons that identify, by general common names or descriptions, multiple general types of subject support devices. In the illustrated embodiment, the user is provided with the option of selecting an icon labeled “Insulin Pump” or an icon labeled “Blood Glucose Meter.” In further embodiments, other types of subject support devices compatible with the system 16 may be included in the arrangement of selectable icons.

FIG. 22 shows two further upload instruction pages in the series that may be provided to the user according to an embodiment of the present invention. FIG. 22 is displayed following the selection of an “Insulin Pump” as the type of subject support device amoiig the selectable icons on FIG. 21. The top half of FIG. 22 shows a menu or server page that may be provided to a user for further refinement of the selection, by allowing the user to select a type of insulin pump (by manufacturer, model, or the like), where the user is provided with selectable icons for selecting one of a plurality of different insulin pump models and/or different manufacturers. The icons may include or otherwise be located adjacent corresponding pictures, photographs, drawings or other suitable representations of the particular types of insulin pumps from which the user may select. By providing photographs or detailed drawings of the plurality of selectable pump options, the user may more easily, visually identify the proper icon that corresponds with the user's pump and thereby reduce any risk of making an erroneous selection.

In the embodiment shown in FIG. 22, the user is provided with icons for selecting a type of insulin pump from among a plurality of models of insulin pumps manufactured by a single entity (Medtronic-MiniMed). In the illustrated embodiment, the user may select from among three different pumps, identified as Paradigm™ 512/712, Paradigm™ 511 and MiniMed 508. In further embodiments, other pump options may be available. The user may continue to the next page in the series of upload instruction pages by selecting one of the available insulin pump icons and then selecting the Next> icon. Alternatively, the system 16 may automatically provide the next page upon the user selecting one of the available insulin pump icons (i.e., without requiring a further action, such as the selection of the Next> icon).

The bottom half of FIG. 22 shows one of the upload instruction pages that may be provided to a user, upon the user selecting one of the icons for a particular insulin pump (i.e., the Paradigm™ 512/712 icon on the page on the top half of FIG. 22). The page includes instructions to the user, for example, in the form of a check-list of actions that the user should take with respect to the particular subject support device associated with the selected icon. The user may continue to the next menu or server page in the series of upload instruction pages by selecting one of the available insulin pump icons and then selecting the Next> icon. Alternatively, the system 16 may automatically provide the next page upon the lapse of a predetermined time from providing the current page (i.e., without requiring a further action, such as the selection of the Next> icon).

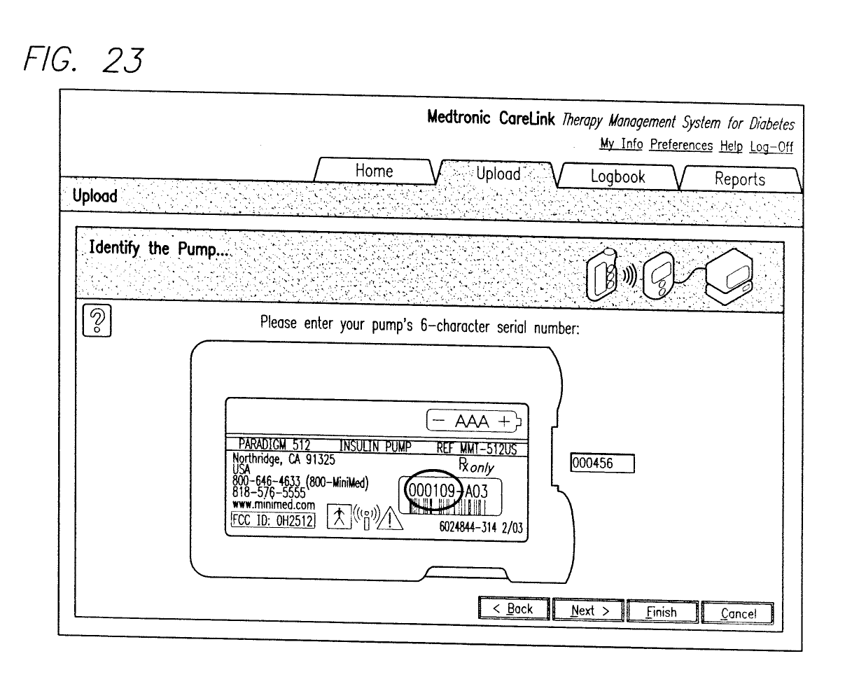

FIG. 23 shows another upload instruction menu or page in the series that may be provided to the user according to an embodiment of the present invention. FIG. 23 may be displayed after the user selected one of the icons for an insulin pump (i.e., the Paradigm™ 512/712 icon on the page on the top half of FIG. 22). The menu or page of FIG. 23 includes an instruction that requests the user to enter the serial number of the user's insulin pump. The menu or page also has a location, including a field, in which a user may enter the requested serial number. To assist the user in locating the serial number on the insulin pump, the menu or page may include a view, such as an enlarged view (picture, photograph, drawing, or other suitable representation) of the portion or side of the selected insulin pump on which the serial number is printed. The viewable representation also includes a marking (such as a circle around the serial number or an arrow pointing to the serial number) directing the user's view to the location of the serial number on the insulin pump. The user may continue to the next page in the series of upload instruction menus or pages by entering a serial number and then selecting the Next> icon. Alternatively, the system 16 may automatically provide the next menu or page upon the user entering a serial number (i.e., without requiring a further action, such as the selection of the Next> icon).

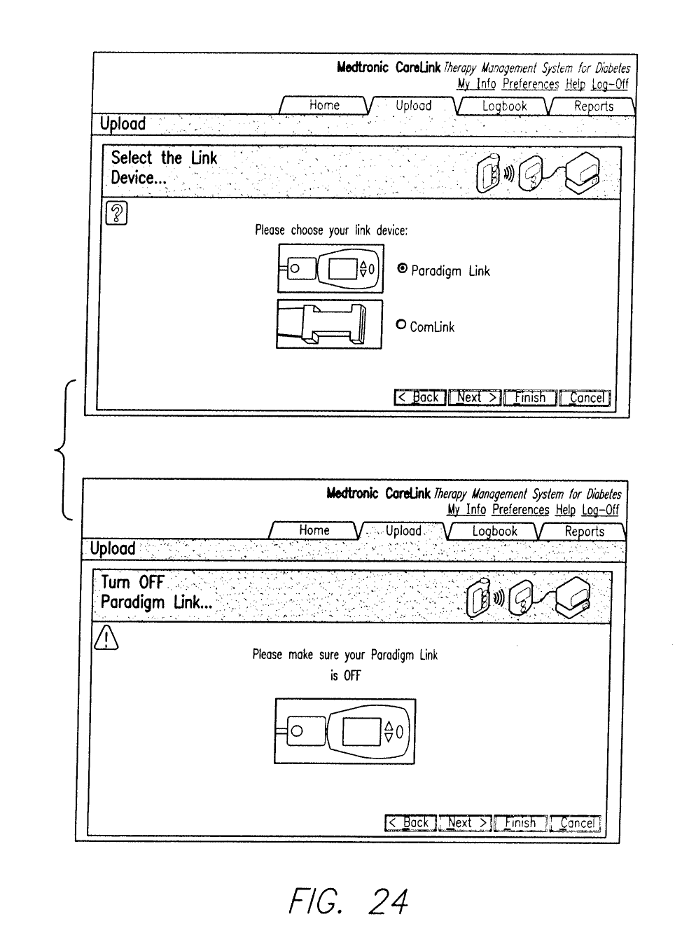

FIG. 24 illustrates a further upload instruction menu and an instruction menu according to an embodiment of the present invention. The top half of FIG. 24 shows a further upload instruction menu or page in the series that may be provided to the user, after the system 16 received the serial number from a user (as described in the previous menu or page). In the menu or page on the top half of FIG. 24, the user is provided with an instruction, requesting the user to select a link device (for linking a pump in communication with a computer). The user is also provided with a plurality of icons for selecting a type of link device from among a plurality of link devices. The icons may include or otherwise be located adjacent corresponding pictures, photographs, drawings or other suitable representations of the particular types of link devices from which the user may select. By providing photographs or detailed drawings of the plurality of selectable link options, the user may easily, visually identify the proper icon that corresponds with the user's link device and the risk of making an erroneous selection may be reduced.

In the illustrated embodiment, the user is provided with icons for selecting either a Paradigm Link™ or a ComLink™ type of link device. However, other embodiments may include other possible link device selections. The user may continue to the next menu or page in the series of upload instruction pages by selecting one of the available link device icons and then selecting the Next> icon. Alternatively, the system 16 may automatically provide the next menu or page upon the user selecting a link device icon (i.e., without requiring a further action, such as the selection of the Next> icon).

The bottom half of FIG. 24 shows a menu or page that provides the user with an instruction, requesting the user to make sure that the link device is turned off. The menu or page may include a picture, photograph, drawing or other suitable representation of the selected link device in an off mode (or otherwise showing the user an off button or other operator that places the selected link device in an off mode.

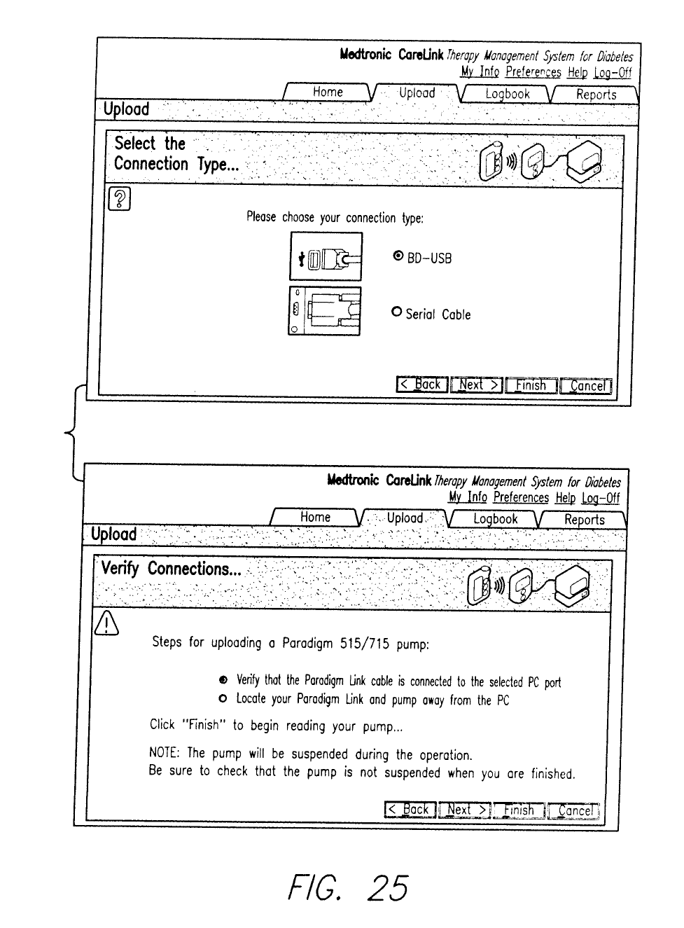

FIG. 25 illustrates a further upload instruction menu or page and an connection instruction menu according to an embodiment of the present invention. The top half of FIG. 25 shows a further upload instruction menu or page in the series that provides an instruction, requesting the user to select a connection type. The user is also provided with a plurality of icons for selecting a type of connection from among a plurality of types of connections. The icons may include or otherwise be located adjacent corresponding pictures, photographs, drawings or other suitable representations of the particular types of connections from which the user may select. By providing photographs or detailed drawings of the plurality of selectable connection options, the user may easily, visually identify the proper icon that corresponds with the user's connection and the risk of making an erroneous selection may be reduced.

In the illustrated embodiment, the user is provided with icons for selecting either a BD-USB connection or a Serial Cable connection. However, other embodiments may include other possible connection selections. The user may continue to the next menu or page in the series of upload instruction menus or pages by selecting one of the available connection icons and then selecting the Next> icon. Alternatively, the system 16 may automatically provide the next menu or page upon the user selecting a connection icon (i.e., without requiring a further action, such as the selection of the Next> icon).

The bottom half of FIG. 25 shows a further upload instruction menu or page that provides an instruction, requesting the user to verify that the link cable is properly connected to the selected computer port and to locate the link and pump away from the user's computer. The page also instructs the user to take a further action, such as select the “Finish” icon to cause the system to begin reading (receiving) information from the user's pump.

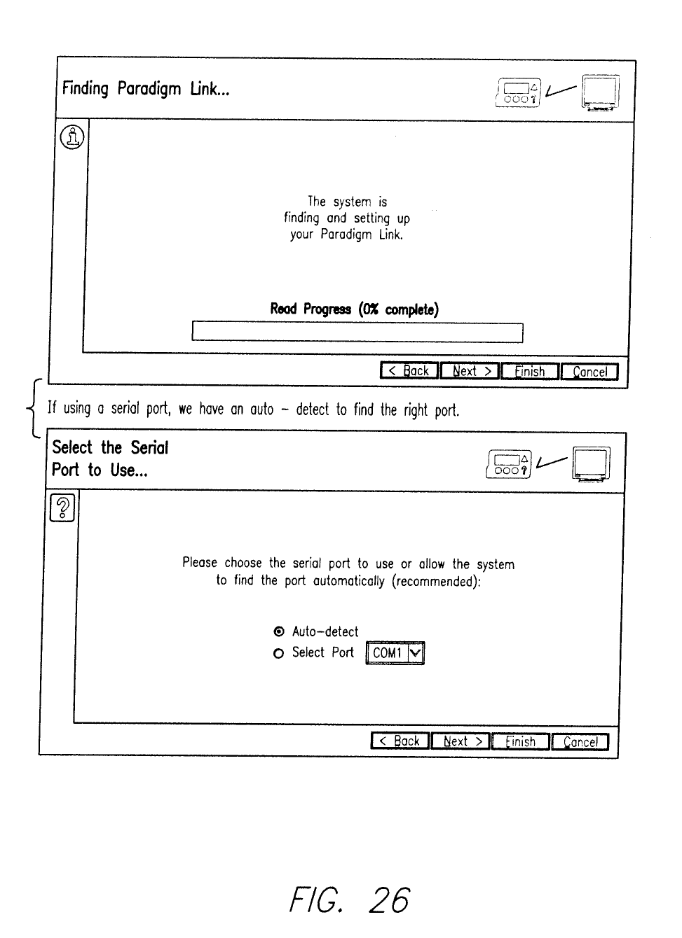

FIG. 26 illustrates a message menu displayed during system configuration and an instruction menu for selecting a communications port according to an embodiment of the present invention. The top half of FIG. 26 shows a message menu or page provided to the user, while the system is configuring itself with appropriate settings, based on the user's input. The bottom half of FIG. 26 shows a menu or page that provides the user with an instruction, requesting the user to select either an option to choose a serial port or to allow the system to find a port, automatically. In the illustrated embodiment, the user is provided with icons for selecting either “Auto-detect” or “Select port.” If the user selects “Select port” icon, then the system may provide the user with a field for entering a port identification and/or a list of possible port identifications from which to choose. The user may continue to the next menu or page in the series of upload instruction menus or pages by selecting an Auto-detect or Select port icon and then selecting the Next> icon. Alternatively, the system 16 may automatically provide the next menu or page upon the user selecting an Auto-detect or Select port icon (i.e., without requiring a further action, such as the selection of the Next> icon).

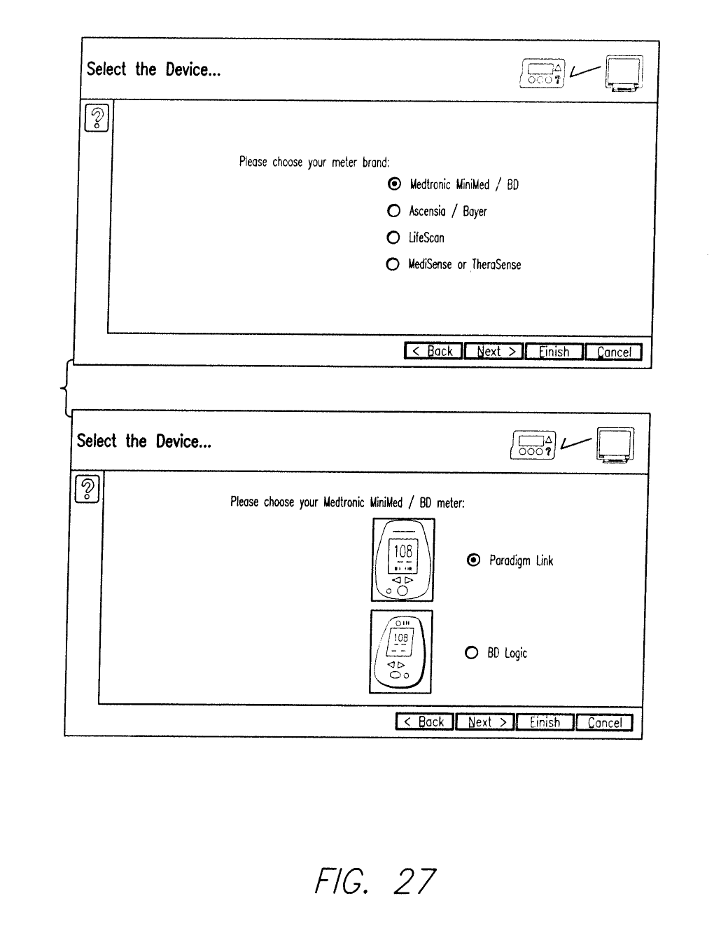

FIG. 27 shows two upload instruction menus or pages in the series that may be provided to the user according to an embodiment of the present invention. These upload instructions menus or pages are displayed in the event that the user selected a Blood Glucose Meter type of subject support device from the selectable icons on the menu page shown on bottom half of FIG. 21. The top half of FIG. 27 shows a menu or page that may be provided to a user for further refinement of the user's selection, by allowing the user to select a type of Blood Glucose Meter (by manufacturer, model, or the like), where the user is provided with selectable icons for selecting one of a plurality of different meter models and/or different meter manufacturers. The icons may include or otherwise be located adjacent corresponding pictures, photographs, drawings or other suitable representations of the particular types of meters from which the user may select.

In the embodiment shown in FIG. 27, the user is provided with icons for selecting a type of blood glucose meter from among a plurality of meter manufacturers. In the illustrated embodiment, the user may select from among four different meter manufacturers, identified as Medtronic MiniMed/BDT™, Ascensia™/Bayer™, LifeScan™ and MediSense™ or TheraSense™. In other embodiments, other suitable meter manufacturer selections may be provided. The user may continue to the next page in the series of upload instruction pages by selecting one of the available meter manufacturer icons and then selecting the Next> icon. Alternatively, the system 16 may automatically provide the next page upon the user selecting one of the available meter manufacturer icons (i.e., without requiring a further action, such as the selection of the Next> icon).

The bottom half of FIG. 27 shows a further upload instruction menu or page in the series that may be provided to a user, upon the user selecting one of the icons for a particular meter manufacturer (i.e., the Medtronic MiniMed/BD meter). The menu or page provides the user with a plurality of icons for selecting a model of the selected manufacturer's meters, for example, a particular model of a Medtronic MiniMed/BD meter, from among a plurality of optional models. The icons may include or otherwise be located adjacent corresponding pictures, photographs, drawings or other suitable representations of the particular models from which the user may select. By providing photographs or detailed drawings of the plurality of selectable model options, the user may easily, visually identify the proper icon that corresponds with the user's meter model and the risk of making an erroneous selection may be reduced.

In the illustrated embodiment, the user is provided with icons for selecting either a Paradigm Link™ or a BD Logic™ model of the selected meter manufacturer. However, other embodiments may include other possible model selections. The user may continue to the next menu or page in the series of upload instruction pages by selecting a model icon and then selecting the Next> icon. Alternatively, the system 16 may automatically provide the next menu or page upon the user selecting a model icon (i.e., without requiring a further action, such as the selection of the Next> icon).

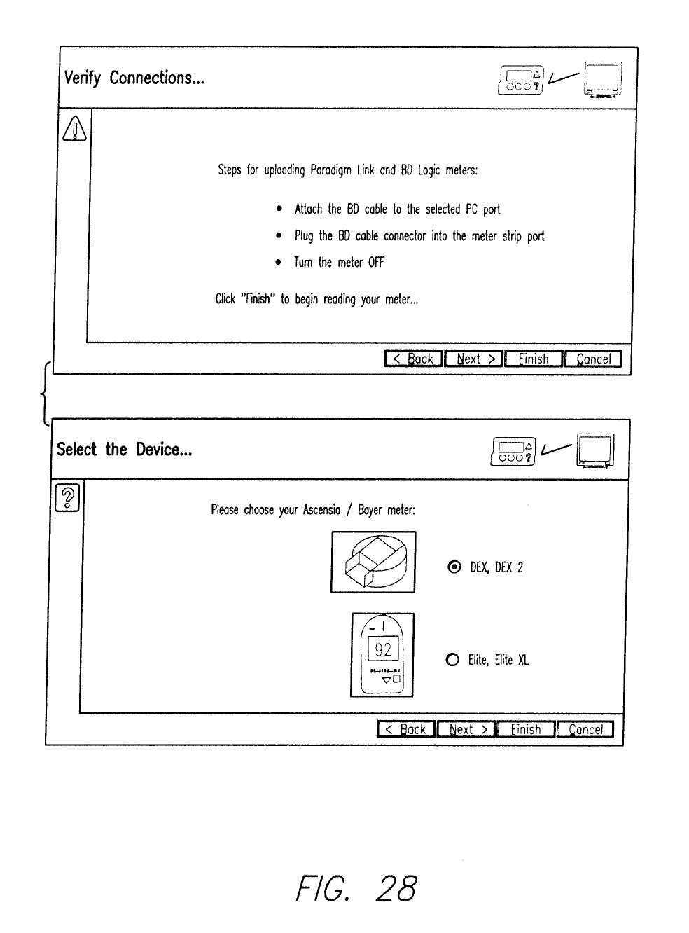

FIG. 28 illustrates a further upload instruction menu or page and a meter manufacturer selection menu according to an embodiment of the present invention. The top half of FIG. 28 shows a further upload instruction menu or page in the series that may be provided to the user, following the selection of a type of meter model from the selectable icons of FIG. 27. The top half of FIG. 28 shows a menu or page that provides the user with an instruction, requesting the user to attach the BD cable to the selected computer port, plug the BD cable connector into the meter strip port and turn the meter off. The menu or page also instructs the user to take a further action, such as select the “Finish” icon to cause the system to begin reading (receiving) information from the user's meter.

The bottom half of FIG. 28 shows an upload instruction page that may be provided to a user, upon the user selecting another one of the icons for a particular meter manufacturer (i.e., the Ascensia/Bayer meter icon) from the options available to the user as shown on the top half of FIG. 27. The menu or page provides the user with a plurality of icons for selecting a model of the Ascensia/Bayer meters from among a plurality of optional models. The icons may include or otherwise be located adjacent corresponding pictures, photographs, drawings or other suitable representations of the particular models from which the user may select. By providing photographs or detailed drawings of the plurality of selectable model options, the user may easily, visually identify the proper icon that corresponds with the user's meter model and the risk of making an erroneous selection may be reduced.

In the illustrated embodiment, the user is provided with icons for selecting either a DEX™-DEX™ 2 or an Elite™-Elite™ XL model of the selected meter manufacturer. However, other embodiments may include other possible model selections. The user may continue to the next menu or page in the series of upload instruction pages by selecting a model icon and then selecting the Next> icon. Alternatively, the system 16 may automatically provide the next page upon the user selecting a model icon (i.e., without requiring a further action, such as the selection of the Next> icon).

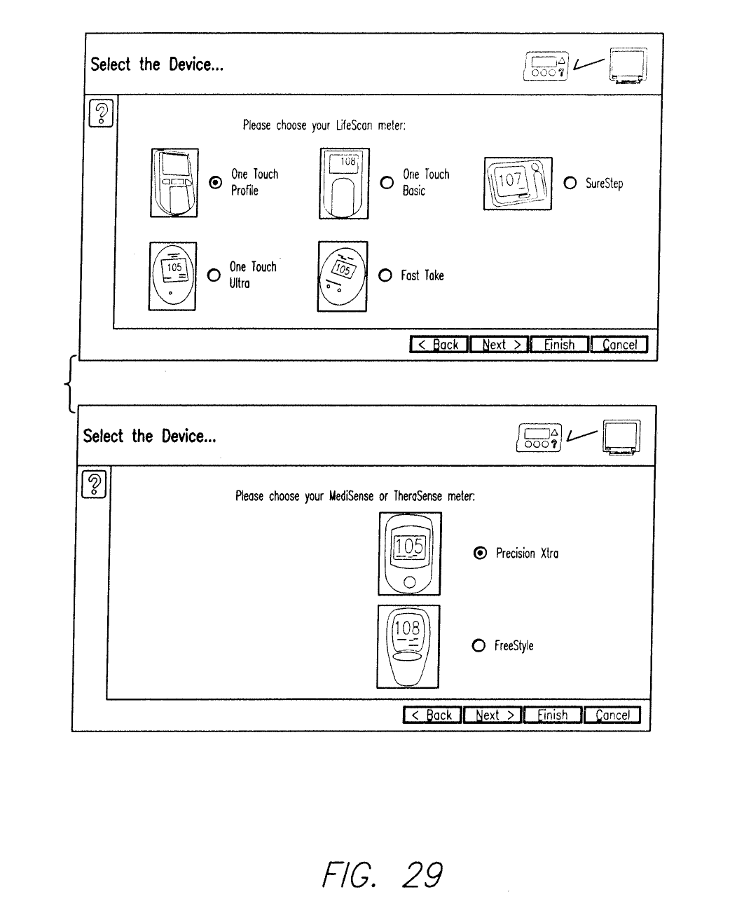

FIG. 29 illustrates an upload instruction menu displayed if a user selects a meter manufacturer icon and selection of a Thermasense™ meter according to an embodiment of the present invention. The top half of FIG. 29 shows an upload instruction menu or page that may be provided to a user, upon the user selecting yet another one of the icons for a particular meter manufacturer (i.e., the LifeScan meter icon) from the options available to the user as shown on the top half of FIG. 27. The menu or page provides the user with a plurality of icons for selecting a model of the LifeScan meter from among a plurality of optional models. The icons may include or otherwise be located adjacent corresponding pictures, photographs, drawings or other suitable representations of the particular models from which the user may select. By providing photographs or detailed drawings of the plurality of selectable model options, the user may easily, visually identify the proper icon that corresponds with the user's meter model and the risk of making an erroneous selection may be reduced.

In the illustrated embodiment, the user is provided with icons for selecting one of the following LifeScan meter models: One Touch Profile™, One Touch Basic™, One Touch Ultra™, SureStep™ and Fast Take™. However, other embodiments may include other possible model selections. The user may continue to the next menu or page in the series of upload instruction menus or pages by selecting a model icon and then selecting the Next> icon. Alternatively, the system 16 may automatically provide the next menu or page upon the user selecting a model icon (i.e., without requiring a further action, such as the selection of the Next> icon).

The bottom half of FIG. 29 shows an upload instruction menu page that may be provided to a user, upon the user selecting another one of the icons for a particular meter manufacturer (i.e., the TheraSense meter icon) from the options available to the user as shown on the top half of FIG. 27. The page provides the user with a plurality of icons for selecting a model of the TheraSense meter from among a plurality of optional models. The icons may include or otherwise be located adjacent corresponding pictures, photographs, drawings or other suitable representations of the particular models from which the user may select. By providing photographs or detailed drawings of the plurality of selectable model options, the user may easily, visually identify the proper icon that corresponds with the user's meter model and the risk of making an erroneous selection may be reduced.

In the illustrated embodiment, the user is provided with icons for selecting either a Precision Xtra™ or a FreeStyle™ model of the selected meter manufacturer. However, other embodiments may include other possible model selections. The user may continue to the next menu or page in the series of upload instruction menus or pages by selecting a model icon and then selecting the Next> icon. Alternatively, the system 16 may automatically provide the next menu or page upon the user selecting a model icon (i.e., without requiring a further action, such as the selection of the Next> icon).

As described above with respect to the Medtronic-MinimedlBD meter, upon selection of an appropriate meter model, the system 16 may provide the user with instructions, requesting the user to attach or check cable connections and to turn off the meter. The system may also instruct the user to take a further action, such as select the “Finish” icon to cause the system to begin reading (receiving) information from the user's meter.

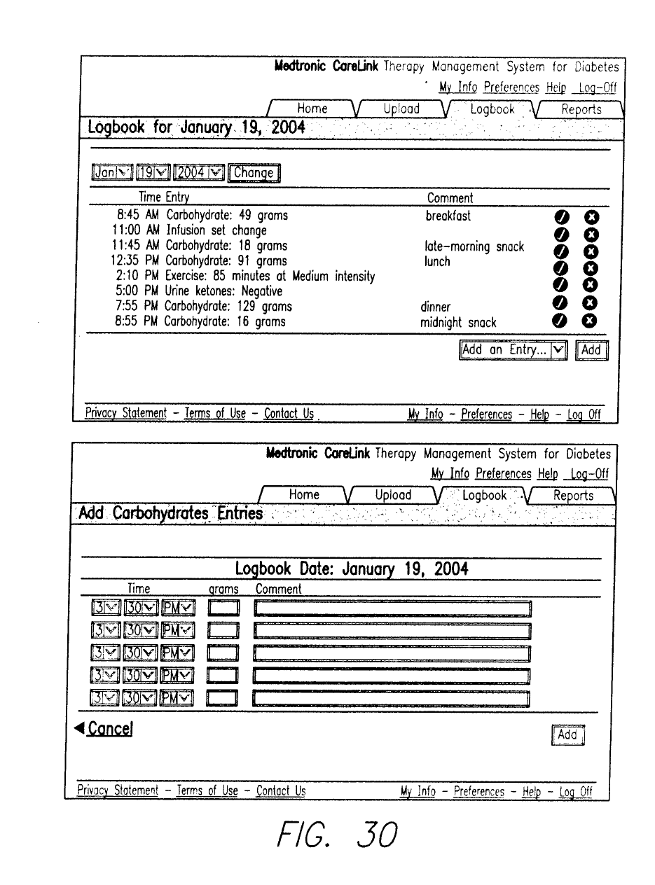

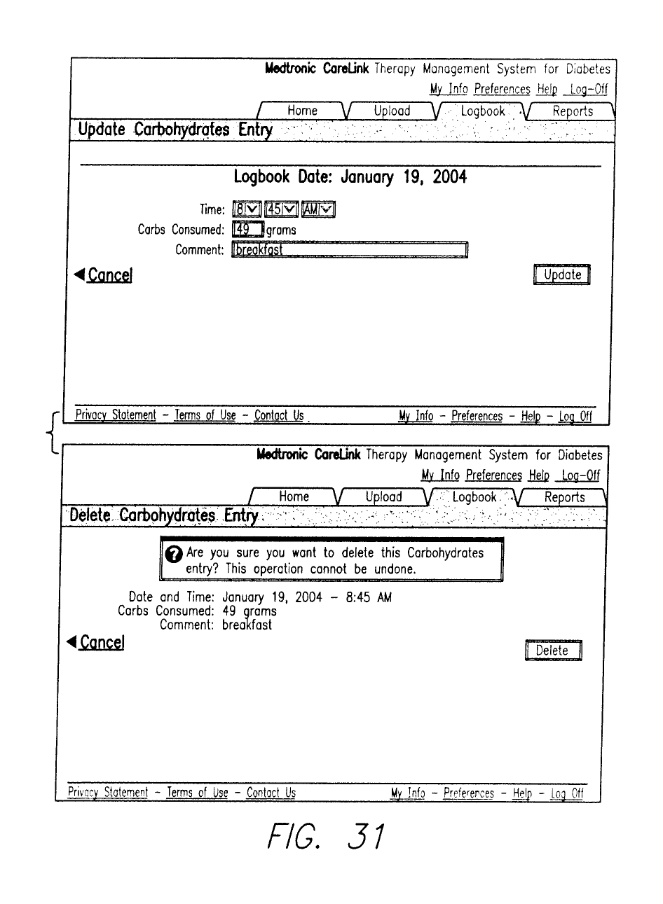

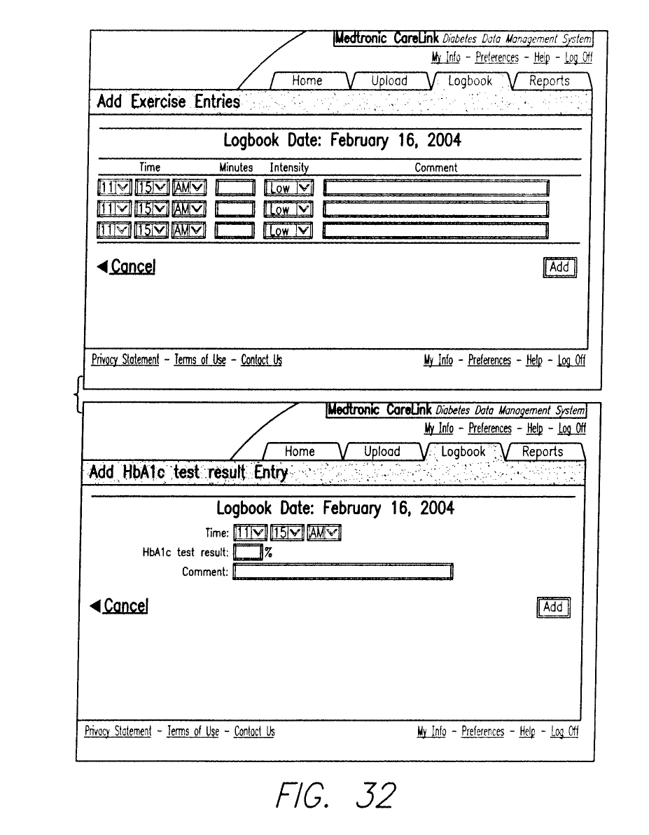

FIG. 30 illustrates a logbook menu and an “add carbohydrates entries” menu according to an embodiment of the present invention. FIG. 31 illustrates an “update carbohydrates menu” and a “delete carbohydrates menu” according to an embodiment of the present invention. FIG. 32 illustrates an “add exercise entries” menu and an “add HbAlc test result entry” menu according to an embodiment of the present invention. FIGS. 30-32 show examples of menus or pages that may be provided in response to a user's selection of an icon for entering information into the user's logbook (i.e., the “Logbook” tab-icon on the personal menu or page illustrated in FIG. 2(a). The menu or web page shown on the top half of FIG. 30 is an example of an initial logbook entry page that may be provided to the user, upon the receipt by the system 16 of a user's selection to enter logbook information.

The initial logbook menu page (top half of FIG. 30) may include a list, a table or other suitable arrangement of information regarding logbook entries made on a particular date. The logbook entry information shown in the table in the illustrated embodiment includes a time associated with each entry, a description of an activity, a value associated with the entry (such as a reference to carbohydrates intake, exercise or other activity and a value associated with that activity, such as grams of carbohydrates or minutes and intensity of exercise) and a comment about some of the activities (such as an indication that a carbohydrate intake entry was associated with a particular meal, or snack). Other activities and associated values, such as urine ketones detection, sleep times and periods, medication ingestion times, infusion set change times or amounts, or the like may be included in the logbook.

A field or other location on the menu or web page may be provided to allow a user to select the date for which the logbook entries are displayed. In the illustrated embodiment, the date associated with the displayed logbook entries is also displayed on the menu or web page, near the upper left corner. The menu or web page may be provided with icons (such as arrows next to the date fields), for allowing a user to select from a plurality of possible dates. Upon a user selection of a date icon, the system 16 may provide the user with a list, menu or other arrangement of selectable date entries.

The initial logbook page (top half of FIG. 30) also may provide the user with a location, field or icon for allowing a user to enter logbook information. In the illustrated embodiment, a selectable icon labeled “Add” is provided for a user to initiate a procedure for entering logbook information. In one embodiment, upon selecting an option to add logbook information, the user may be provided with a list, menu or other arrangement of selectable options corresponding to types of entry information. In this manner, the user may be provided with a plurality of selectable icons (in a list, menu or other arrangement), each icon identifying a type of activity for which a user may enter manual information. For example, the user may select an icon for entering information regarding such activities as carbohydrate intakes, exercise activities, HbAlc test results, infusion set changes, sleep times or periods, medication ingestion times, or the like. Other embodiments may include icons for selecting to enter information about other types of logbook activities.

Upon the system 16 receiving a user's selection of a particular type of activity information to enter into a logbook, the system 16 may provide the user with a menu or page configured to allow the user to enter appropriate information relating to the selected activity. For example, the website page shown on the bottom half of FIG. 30 may be provided to a user, upon receipt by the system 16 of a user's selection to enter information regarding carbohydrate intake. The page may provide one or more locations (including fields) for a user to enter particular information. The locations or fields may be labeled with the type of information that the user should enter, such as “Time”, “grams” and “Comment.”

Similarly, the website page shown on the top half of FIG. 31 may be provided to a user, upon receipt by the system 16 of a user's selection to enter information regarding a carbohydrate update. The menu or page may provide one or more locations (including fields) for a user to enter particular information regarding a carbohydrate intake. In the illustrated example, the user is provided with labeled fields for entering a time (hour, minute and am/pm) of the carbohydrate intake, an amount of carbohydrates consumed (grams) and comments (such as an explanation of the type of meal). The bottom half of FIG. 31 shows a menu or page that may be provided to a user, upon receipt by the system 16 of a user's selection to delete a carbohydrate entry. That menu or page shows information regarding the selected entry to be deleted (including time, amount of carbohydrates and comments) and a message asking the user to verify that the user is sure that the entry should be deleted.

The website page shown on the top half of FIG. 32 may be provided to a user, upon receipt by the system 16 of a user's selection to enter information regarding exercise activities of the subject. The menu or page may provide one or more locations (including fields) for a user to enter particular information regarding one or more exercise activities. The locations or fields may be labeled with the type of information that the user should enter, such as “Time” (for the time of day at which the exercise began or ended), “Minutes” (for the number of minutes the exercise activity occurred), “Intensity” (for an estimated level of the exercise activity) and “Comment” (for any additional information relevant to the activity).

The website page shown on the bottom half of FIG. 32 may be provided to a user, upon receipt by the system 16 of a user's selection to enter information regarding HbAlc test activities of the subject. The menu or web page may provide one or more locations (including fields) for a user to enter particular information regarding one or more HbAlc test activities. The locations or fields may be labeled with the type of information that the user should enter, such as “Time” (for the time of day at which the test was taken), “HbAlc test results” (for the value of the test results) and “Comment” (for any additional information relevant to the test activity).

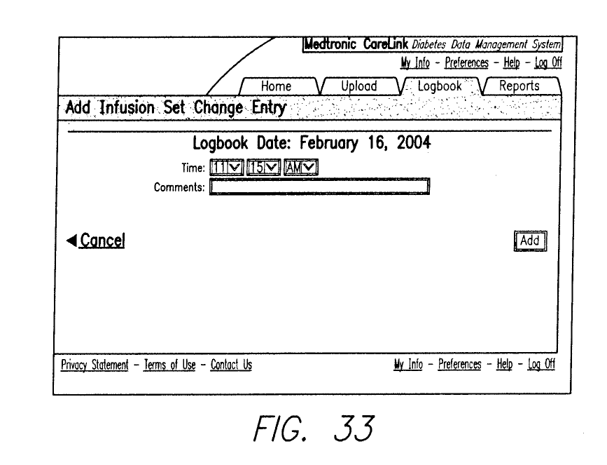

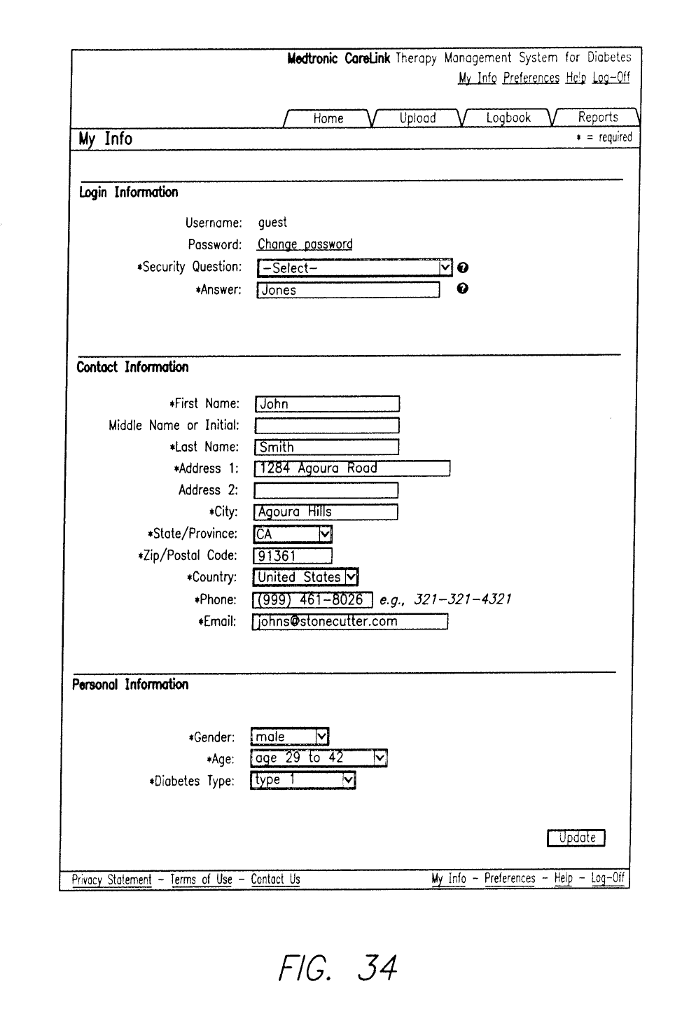

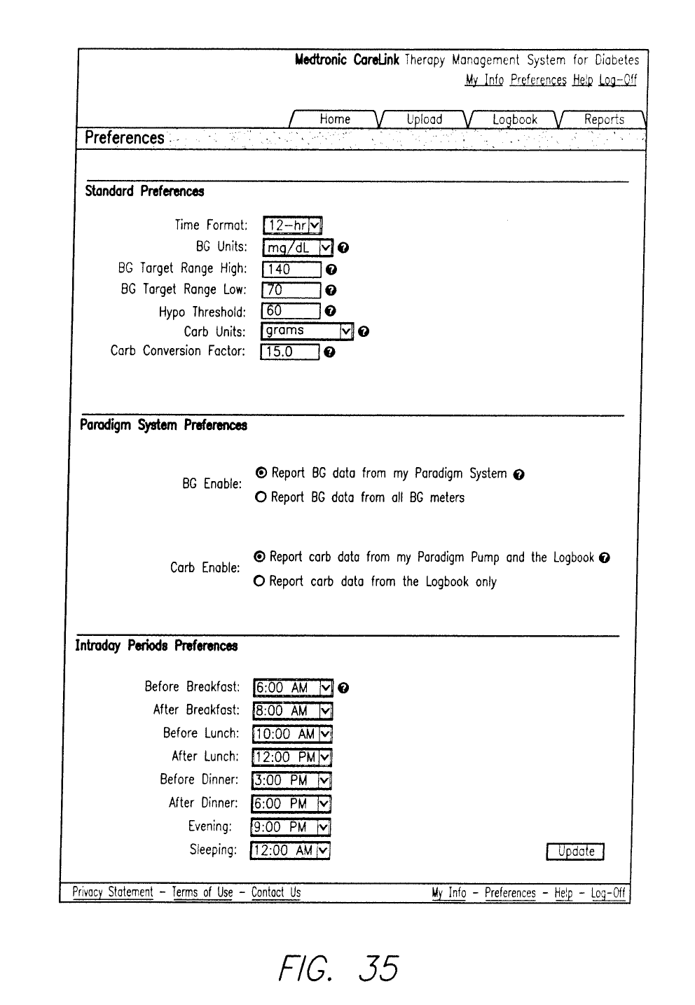

FIG. 33 illustrates an infusion set change entry menu according to an embodiment of the present invention. FIG. 34 illustrates a my info page menu according to an embodiment of the present invention. FIG. 35 illustrates an earlier version of the parameter selection menu according to an embodiment of the present invention. The website menu or page shown on FIG. 33 may be provided to a user, upon receipt by the system 16 of a user's selection to enter information regarding infusion set changing activities of the subject. The menu page may provide one or more locations (including fields) for a user to enter particular information regarding one or more infusion set changing activities. The locations or fields may be labeled with the type of information that the user should enter, such as “Time” (for the time of day at which the infusion set was changed) and “Comment” (for any additional information relevant to the infusion set changing activity).

The menus or pages shown on FIGS. 34 and 35 may be provided to a user to allow the user to verify current information stored by the system 16 for the user. FIG. 34 shows a “My Info” menu or page, in which various personal information regarding the user is shown, including username, password, security question and answer, name, address, telephone, E-mail, gender, age and diabetes type. FIG. 35 shows a “Preferences” menu or page, in which various information regarding the user's blood glucose targets and preferences are provided.

Some or all of the website pages may include user-selectable icons for accessing other website pages (such as the “Home”, “Upload”, “Logbook” and “Reports” tab-icons shown on the user's personal home menu or page, e.g., FIG. 2(a). Alternatively, or in addition, some or all of the menus or pages may include further selectable icons, for accessing other menus pr pages or locations, including an icon (for example, labeled “My Info”) for allowing a user to access (or access and modify) the user's personal information that may have been recorded during the user's registration processes. Other user selectable icons that may be provided on some or all menus or pages include an icon for allowing a user to view (or view and modify) preferences, an icon for allowing a user to access help information, an icon for allowing a user to access contact information relating to the entity running the system 16, or the like. In the illustrated embodiment, such icons are labeled “Preferences”, “Help” and “Contact Us,” respectively. Also, some or all of the website pages may include a selectable icon to allow a user to log off of the system (labeled “Log-Off” in the illustrated embodiment).

In additional embodiments, the present invention includes more complete medical data therapy/diabetes data management systems. The above embodiments may be incorporated into the more complete medication therapy management system to provide the described target blood and sensor glucose ranges and the report generation of glucose statistics for time ranges. The above embodiments may be incorporated with the below embodiments in one application or they may be two or more separate applications that work with each other. Where the above embodiments are in one application, for example, at a patient's home, and the below embodiments are in another application, for example, at a doctor's office, there may be a menu in either application to allow the two applications to communicate, for example over the Internet. In this way, a patient will only have to download data once, saving unnecessary waiting time at the doctor's office. In further embodiments, the doctor may print out patient authorization to synchronize the two applications, for the doctor's records. In further embodiments, when the user is downloading data from a device in either application, the user may select how much data (e.g., past 2 weeks, past month) will be downloaded. This will also save time of download.

In embodiments of the invention, the DDMS includes software for generating or otherwise providing reports containing information received from a subject, a group of subjects, or multiple groups of subjects regarding data retrieved from the subject's (or subjects') medical devices. For example, as discussed above, the diabetes data management system may retrieve data from medical devices including, but not limited to, infusion pumps, such as insulin pumps, blood glucose meters, glucose sensors, and the like. The reports may be useful for a number of reasons, such as monitoring a patient's reaction to particular insulin delivery protocols or assessing the accuracy of certain parameters used to create a delivery protocol. As an example, in an insulin pump, it may be possible to set a carbohydrate/insulin ratio for a particular patient (i.e., the amount of insulin that should be delivered when a particular amount of carbohydrates is ingested), insulin sensitivity of the patient, and basal patterns. The reports may be used to assess how well these parameters are keeping the patient within a target blood glucose range and may allow the user to adjust parameters based upon the reports.

The data retrieved may be medical information about a patient. For example, the medical information may include carbohydrate information indicating carbohydrates ingested by the patient. The carbohydrate information may be data that the patient input into his/her infusion pump or other device. Thus, it may be complete or incomplete, depending on how often the patient entered his/her carbohydrate information. The carbohydrate information may include carbohydrate information during meal events, which may include regular meals like breakfast, lunch, and dinner, or additional meals, such as snacks or drinks. The medical information may include insulin information indicating insulin delivered to the patient. This insulin data could be automatically created by the infusion pump being used or entered by the patient, and the insulin data may be complete for a selected report time period or incomplete. The medical information may also include glucose information, for example glucose readings taken and/or entered into a device by the patient. The glucose information may come from a number of devices, including infusion pumps, blood glucose meters, and continuous glucose sensors.

Additional information on reports is also possible, such as how often the patient takes a blood glucose measurement using a test strip, or how often a patient changes infusion sets and sensors. In further embodiments, the patient may be warned to buy new test strips or infusion sets/sensors based upon the patient's pattern of use of those items.

Reports generated may be useful for health care providers, patients, and interested authorities, such as insurance companies, ministries of health in certain countries. Although a number of reports and report selection menus are illustrated below, each is illustrative and could be modified in a number of ways. For example, there may be separate types of reports for different types of users. There may be different axes or reports for patterns that go on during a user's life, such as menstrual periods. The times may be adjustable, such as for night time workers or for traveling across time zones. Reports may be set up that only show the days when a glucose sensor was on, or that only show weekend days or weekdays or holidays.

In addition, although the reports and parameter selection menus disclosed below generally show the retrieval and display of data from a medication infusion pump, such as an insulin infusion pump, it is not necessary for there to be pump data to generate reports according to the present invention.

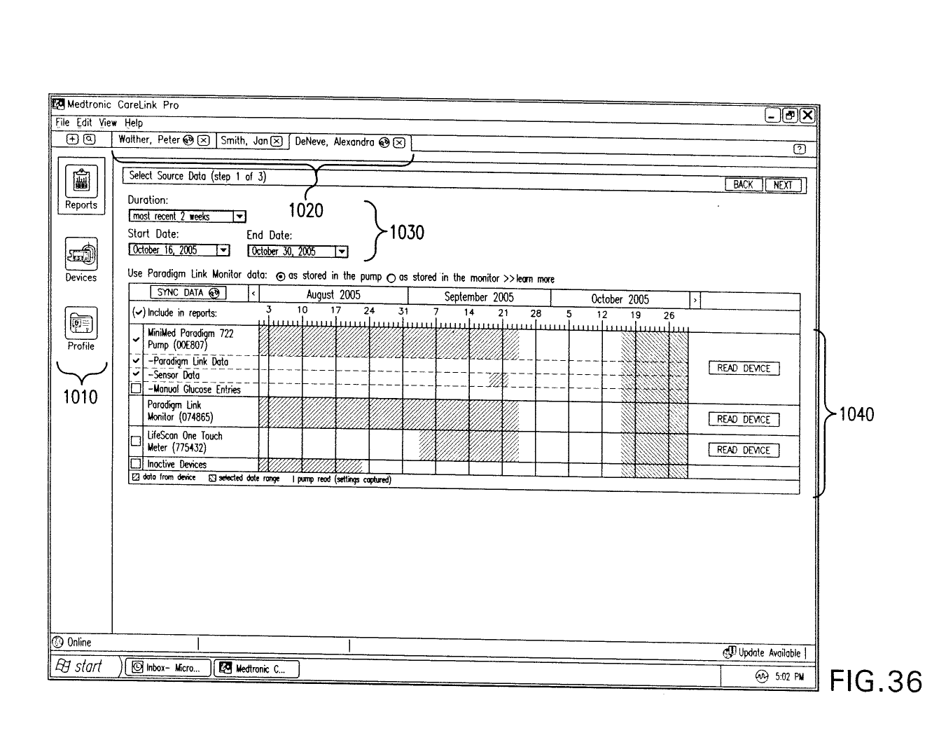

FIG. 36 illustrates a source parameter selection menu according to an embodiment of the invention. The configuration shown is one of many possible configurations that would allow selection of parameters for preparation of reports according to embodiments of the present invention. In the embodiment shown in FIG. 36, the user is prompted to select source data. Optionally, there may be one or more icons 1010 or other selection graphics, such as drop down menus or tabs, that allow the user to switch between the parameter selection menu in FIG. 36 and other menus, such as a menu to input data about devices and a menu to input data about a patient profile. Also optionally, where more than one patient's information is included in the data management system, there may be one or more tabs 1020 or other selection graphics, such as drop down menus or icons, that allow a user to switch between patient information. In this way, it is convenient for the user to prepare reports for any of the patients. When selecting patients, there may be a patient lookup menu that allows to search for patients in the database. In certain embodiments, the patient lookup function may be achieved by searching for any combination of a name. For example, a user looking for John Smith could type in “J Smi” or “John S” or “Smith” and the lookup would fined John Smith, with any other names that also fit into the criteria. In each of the menus there may be a “guide me” panel that the user may select to show help information as the user proceeds through the menus.

As shown in FIG. 36, the user may be prompted to select a period within which information should be collected to prepare reports. For example, the period selection section 1030 may include an input for the desired duration, inputs for start and end dates and/or times, or combinations of the same. In the embodiment shown, drop down menus are used. However, manual entry of the dates or duration could be used, as could any other convenient method of entering desired durations. If a drop down menu is used for the duration, the menu could include any number of date ranges, for example, the most recent week, the most recent 2 weeks, the most recent 4 weeks, the most recent 8 weeks, the most recent 12 weeks, or a custom date range. Selection of the custom date range could prompt additional drop down menus for the custom date range or fields to manually enter the custom date range. If a drop down menu is used for the date range, the menu could include a list of dates or activating the menu could bring up a calendar page, for example, a calendar month, for easy selection of dates.

In embodiments of the invention, a maximum date range and/or duration may be preprogrammed, or selected by a user. For example, it may be desired that the system not create reports over a year old. Additionally or alternatively, it may be desired that a duration for reports not be more than 12 weeks, 6 months, a year, or any other desired duration. If the user attempts to select a date range or duration that is outside the maximum, an error message may be displayed, for example, next to the period selection section 1030.

Once the user has selected a period for which to prepare reports, the user may request that the DDMS read data, such as medical information, from one or more devices. Where a device has a separate monitor that acts as a remote for the device, or that stores data from the device, the parameter selection menu may be configured to ask whether the data stored in the pump or in the monitor should be read. A device selection section 1040 may be included where there is more than one device that can be read. For example, in FIG. 36, three devices are shown, an insulin pump and two blood glucose meters. In addition, the insulin pump may have data from a blood glucose meter, a continuous glucose sensor and/or manual glucose entries. There also may be a section for inactive devices. The embodiment shown in FIG. 36 is merely illustrative, and there could be any number of listed devices, from which it is desired to retrieve data. There may be a button or other graphical interface to start collection of data from one or more of the devices.

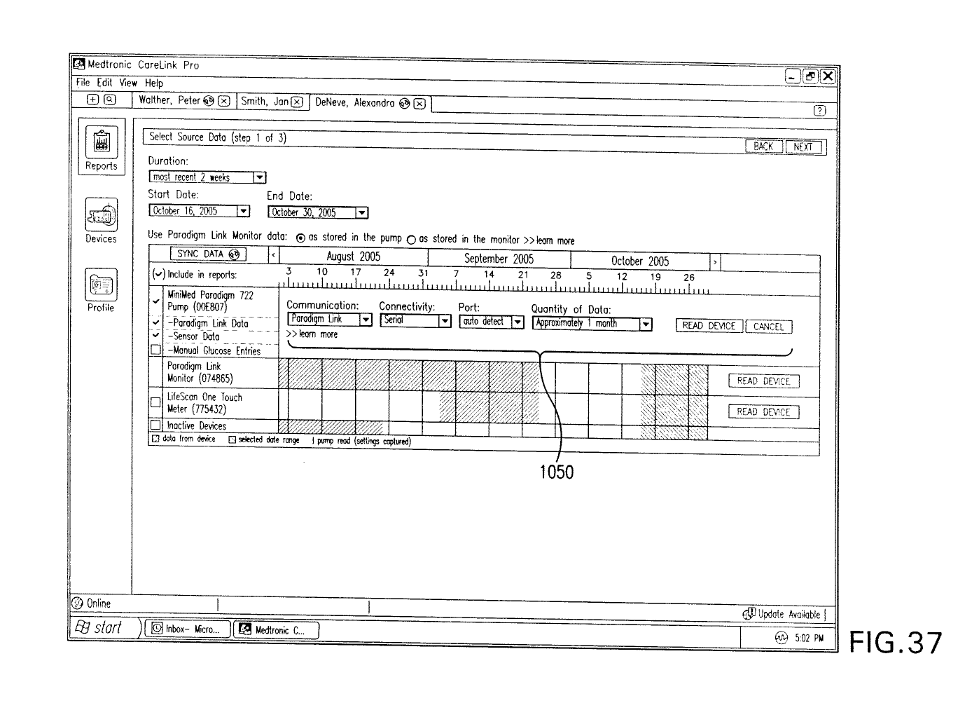

In further embodiments, as shown in FIG. 37, there may be a device parameter selection section 1050 so that the user may enter information about the device that is desired to be read. The selection of this data may be by drop down menu, text box, or any other method desired. For example, and without limitation, data which may be selected in the device parameter selection section 1050 includes the type of communication (e.g., through a USB port, serial port, interface provided with a pump or other product, or other communication), the connectivity (e.g., serial, parallel, or wireless), the port (e.g., communications port 1, communications port 2, etc. or an automatically detected port), and the quantity of data (e.g., approximately 1 month, approximately 3 months, approximately 12 weeks). Thus, for example, the devices may communicate with the DDMS wirelessly by any suitable wireless method, including, but not limited to RF, IR, Bluetooth and IEEE 802.11.

Generally, before a device is read, such as an infusion pump, the device must be suspended. A warning may prompt the user that the device is going to be suspended, and, if a pump, it may warn the user to cancel any active boluses or temporary basal rates and to make sure any associated monitors are off before proceeding with reading the device. If the device is powered off, and if it is required that the device be on to receive data, it may prompt the user that the device must be on before it can read the data. If a user tries to cancel reading of the data while the data is being read from the device, depending on the system, the DDMS may erase all data being read already. In that case, the DDMS may prompt the user that canceling will result in a loss of all data read so far and ask the user whether or not it is still desired to cancel the retrieval of data.

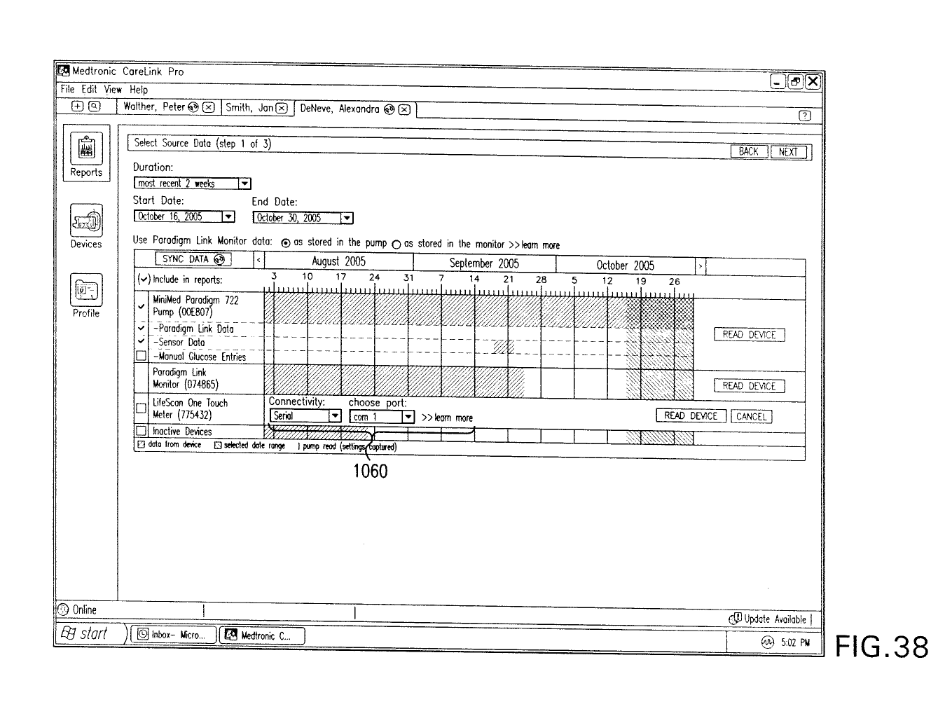

Once the data has been read from a device, the DDMS may advise the user that it is done reading that device. The user may then opt to read data from other devices into the DDMS. In FIG. 38, in further embodiments, a second device parameter selection section 1060 is shown for a blood glucose meter. The second device parameter selection section 1060 may have similar parameter selections to the device parameter selection section 1050 discussed above. In the embodiment shown in FIG. 38, connectivity and port are the parameters that allow selection.

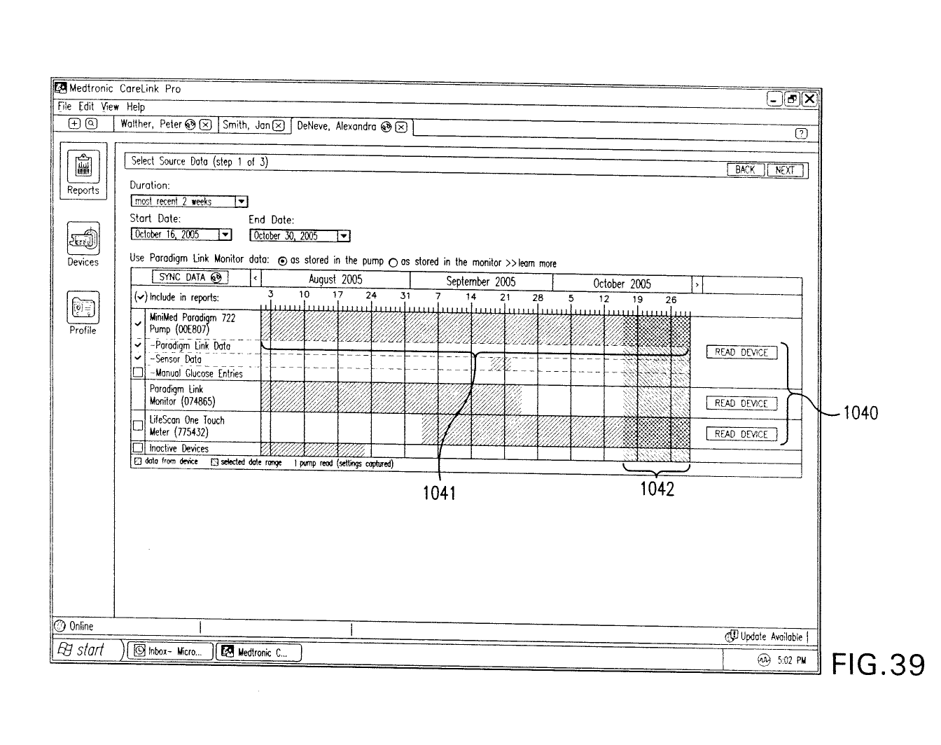

Once data has been read in from one or more devices, the DDMS may indicate the time frame of the data that was read into the system. For example, in FIGS. 36-39, shading is used to indicate for what timeframes data from each device has been read into the DDMS. Shading may also be used to indicate the selected date range for reports. FIG. 39 illustrates an embodiment after data from two devices has been read. The shading 1042 indicates the selected date range for the reports. In the embodiment shown in FIG. 39, the dates are shown above the shading and match the duration and start/end dates. The shading 1041 indicates when data was available, and read into the DDMS, for the pump. As can be seen, there is an overlap between the shading 1041 and the shading 1042 to indicate that the data has been read into the DDMS for the selected date range. The use of shading is merely illustrative. The presence of data from devices in the DDMS and the selected date range could be indicated in a number of different ways, for example, it could be text based and not graphical.

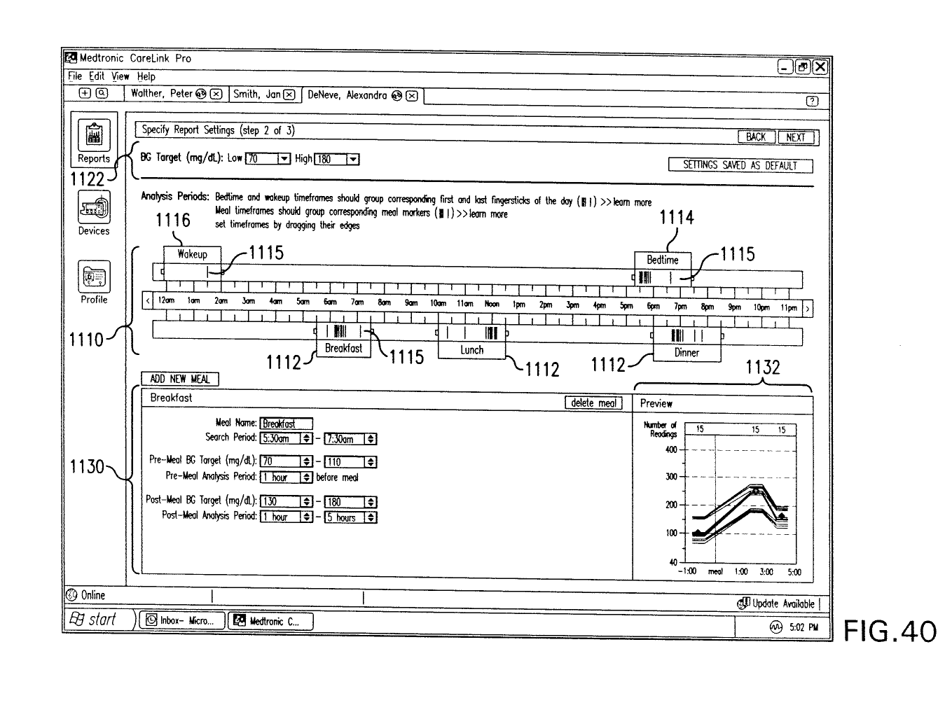

Once the desired data has been read into the DDMS for all desired devices, the user may go to a report settings menu, as shown in FIG. 40. The report settings menu may include a number of selection sections. For example, in the embodiment shown in FIG. 40, the report settings menu includes a blood glucose (BG) target selection section 1120. The BG target selection section 1120 may be used to select the range of blood glucose values that the user, such as the patient or his/her physician, has determined is the optimum blood glucose range for that patient. The range may be selected by using drop down boxes, as shown, or in any other suitable manner, such as a graphical selection or a text box entry.

Also shown in FIG. 40 is a meal and other patient event selection section 1110. Other patient events may include bedtime to wake-up events, medicine ingestion or delivery events, and other time based events. For example, a user may want to monitor a patient's reaction to ingestion of a certain medication. By creating a medication ingestion event, it would be possible to easily review the effect of the medication on the user during a selected report time period. In this section, the user may enter meal or other patient events. In the embodiment shown in FIG. 40, there are three meal event bands 1112, a wakeup event band 1116 and a bedtime event band 1114. The meal event bands 1112 represent meal timeframes. In alternative embodiments, meal timeframes could be preset by the system. Meal events may alternatively be set by other methods than by the meal event bands 1112 shown in FIG. 40. For example, they could be entered in text boxes. In the embodiment shown in FIG. 40, the meal markers may be adjusted in several ways. For example, they may be adjusted by dragging the edges of the markers to change the start and end times. In addition, meal markers 1113 may be included in the meal and other event selection section 1110. These meal markers may be retrieved by the DDMS from one or more devices (e.g., a patient may indicate to his pump that he is taking a meal bolus or provide any other input that tells the pump he is eating a meal, or the pump may be programmed to associate any bolus as a meal). The user would preferably create meal event bands 1112 that encompass all meal markers 1113 for a particular meal. However, if a meal marker is far separate from the other meal markers, the user may want to exclude that meal marker from the meal event band. Similarly, the user can set a wakeup band 1116 and a bedtime band 1116. If the patient takes fingerstick blood glucose measurements every day, and these have been read into the DDMS through a pump, a blood glucose monitor or other device, the wakeup and bedtime bands preferably correspond to the first and last fingersticks of the day. The first and last fingersticks of the day may be indicated by fingerstick markers 1115. As with the meal events, wakeup and bedtime events may be set by different methods than illustrated in FIG. 40, such as through text boxes.

In the embodiment shown in FIG. 40, a meal information section 1130 is included in the report settings menu. The meal information section 1130 may represent another way to select and/or add meal events. For example, in the embodiment shown in FIG. 40, the meal information section may include inputs for the meal name (e.g., breakfast, lunch, or dinner), a range for the meal/search period, a pre-meal blood glucose target range, a pre-meal analysis period, a post-meal blood glucose target range, and a post-meal analysis period. In certain embodiments, the user may add up to a predefined number of meal events, such as five. The blood glucose target ranges may be used to select the range of blood glucose values that the user, such as the patient or his/her physician, has determined is the optimum blood glucose range for that patient before and after eating. The range may be selected by using drop down boxes, as shown, or in any other suitable manner, such as a graphical selection or a text box entry. The search period, pre-meal analysis period, and post-meal analysis period may also be entered through drop down boxes, graphical selection, text box entries, or any other suitable method. Also shown in FIG. 40, as part of the meal information section 1130 is a preview graph 1132. the preview graph 1132 shows a sample overlay of glucose readings within a meal search period. The meals have been overlayed so that the actual meal intake on each day is aligned and so that their high and low readings are aligned. Example meal overlay graphs are discussed in further detail below. By showing a preview graph 1132, the DDMS allows a user to decide whether or not there is enough information in a selected search period to define a meal event.

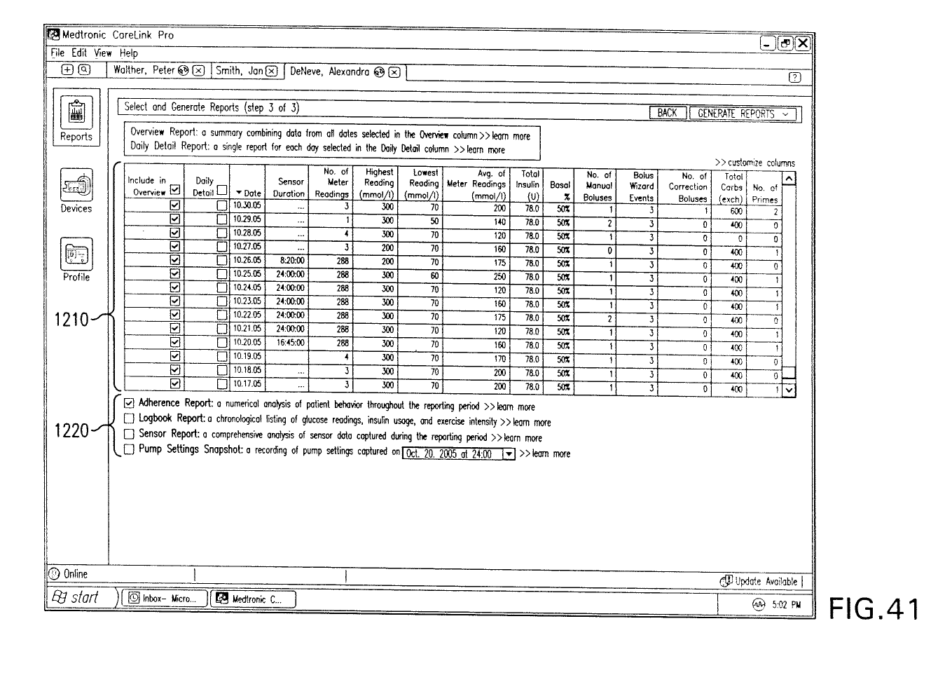

After the report settings menu has been completed, the user may continue to a generate reports menu. FIG. 41 shows one embodiment of a generate reports menu. The embodiment shown in FIG. 41 includes a daily data spreadsheet 1210 and a report selection section 1220. The daily data spreadsheet 1210 includes information about the data in the DDMS for each date of the period selected to generate the reports. The daily data spreadsheet 1210 may include an overview column with an option to include an overview report, which is a summary combining data from all dates selected in the overview column and/or a daily detail column with an option to include a single report for each day selected in the daily detail column. In the embodiment shown in FIG. 41, the daily data spreadsheet also includes dates, the sensor duration of each of those days as recorded in the DDMS, the number of meter readings recorded on each of those days in the DDMS, the highest reading recorded on each of those days in the DDMS, the lowest reading recorded on each of those days in the DDMS, the average of the meter readings recorded on each of those days in the DDMS, the total insulin given on each of those days as recorded in the DDMS, the percentage of insulin given that was given as a basal rate on each of those days as recorded on the DDMS, the number of manual boluses on each of those days as recorded in the DDMS, the number of bolus wizard events on each of those days as recorded in the DDMS, the number of correction boluses given on each of those days as recorded in the DDMS, the total carbohydrates eaten on each of those days as recorded in the DDMS, and the number of times the pump was primed on each of those days as recorded in the DDMS. More or fewer columns could be included in the daily data spreadsheet, as desired. For example, other columns could include the sensor average (e.g., in mg/dl), the number of hypoglycemic and/or hyperglycemic events, suspend durations, number of rewinds of the pump, prime volume used during primes, the amount of insulin administered as basal, the amount of insulin administered as bolus, the percentage of bolus, the total number of boluses (including meal boluses, correction boluses, and manual boluses), and the number of meal boluses. In addition, the user may customize the columns. There may be a “customize columns” icon or other way for the user to link to a page that allows for customization and selection of columns.

In the embodiment shown in FIG. 41, the report selection section 1220 includes check boxes to select which additional reports the user would like to view. For example, the report selection section 1220 may include selection for an adherence report, which is a numerical analysis of patient behavior throughout the reporting period, a logbook report, which is a chronological listing of glucose readings, insulin usage, and exercise intensity, a sensor report, which is a comprehensive analysis of sensor data captured during the report period, a pump settings snapshot, which is a recording of pump settings captured on a certain date (which may be entered by the user through drop down box or other method), or any other desired report. In embodiments of the invention, the user may view the reports on screen, print the reports directly, or save the reports as a viewable file type, such as pdf or tiff.

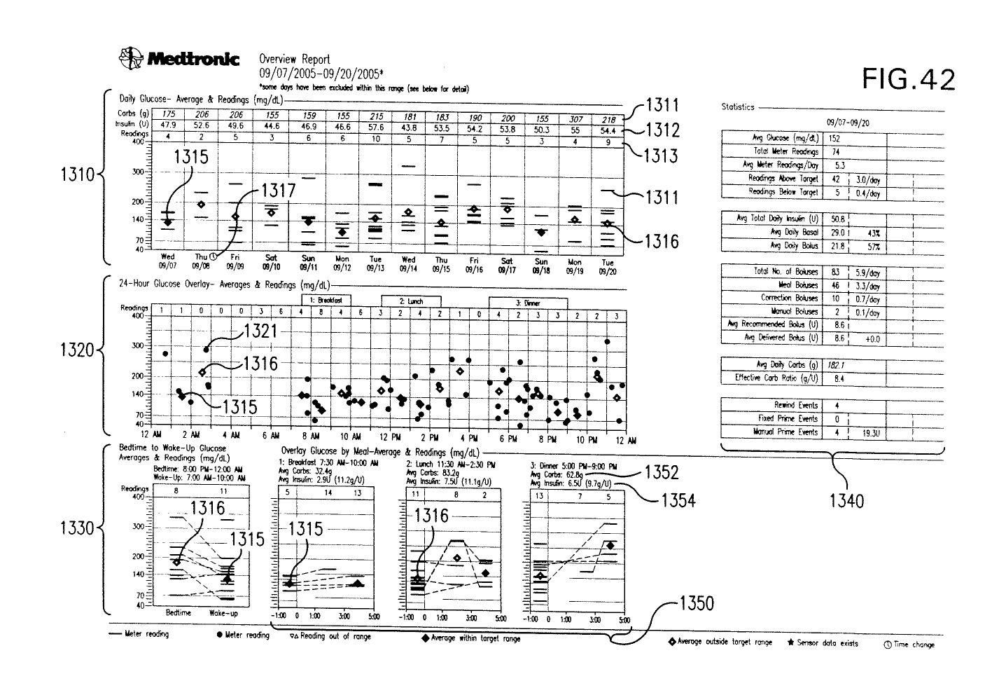

FIGS. 42-46 each illustrate embodiments of reports in accordance with the present invention. Each report includes representations of medical information that has been read into the DDMS. There may be a number of separately identifiable regions in any one of the reports, which may each show one or more representations of certain medical information. For example, many of the figures, as discussed below, show a first region with a representation of carbohydrate information, insulin information, and glucose information.

FIG. 42 illustrates an embodiment of an overview report in accordance with the present invention. In the embodiment illustrated in FIG. 42, a daily glucose chart 1310 is included, which shows both average readings 1315, 1316 and daily readings 1314. A daily glucose chart may include either averages or daily readings or both. The daily readings 1314 may be from one or more blood glucose meters, such as the type that take a blood glucose measurement after a patient performs a finger stick, places a drop of blood on a test strip, and inserts the test strip into the blood glucose meter. The daily glucose chart includes carbohydrate information, such as the number of carbohydrates 1311 ingested each day, insulin information, such as the amount of insulin given 1312 each day, and glucose information, such as the number of blood glucose readings taken 1313 each day. Carbohydrate information, insulin information, and glucose information is shown both by using numbers and graphics in the various charts. In the embodiment shown, the carbohydrates 1311 and amount of insulin given 1312 are shown next to each other and directly above the daily glucose readings 1314, to show the relationship between carbohydrate intake, insulin delivery, and glycemic control. The average readings 1315, 1316 are divided into separate symbols, one for averages within the target range 1315 and one for averages outside the target range 1314. In FIG. 42, the target range has been set as 70-140 mg/dL. This range is also shaded darker than the remainder of the chart. So blood glucose averages within this range are depicted by the symbol for averages within the target range 1315. The symbols used in FIG. 42 are merely illustrate. Alternative symbols could be used. Displaying carbohydrates per day and insulin per day allows a user to easily correlate the amount of insulin being taken to the amount of carbohydrates being consumed. Also as shown in FIG. 42, the weekends may be offset by a different color, shading, or lines demarcating the change between weekday and weekend. By having the weekend offset, it is easier for a user to analyze weekends differently, for example to see whether a user is consistently out of range for blood glucose measurements on weekends as opposed to weekdays. Also shown in the daily glucose chart 1310 is a time change indicator 1317 that indicates when a time change was made, for example daylight savings time based time changes. A time change indicator can help the user relate any changes to the change in time.

In the embodiment illustrated in FIG. 42, a 24-hour glucose overlay 1320 is included. The 24-hour glucose overlay 1320 shows all days in the selected period laid on top of each other. This gives a good graphical summary of how consistent the days are with each other. For example, if there are highs or lows around the same time every day, it could indicate that a patient's program needs to be changed. The 24-hour glucose overlay 1320 shows meter readings 1321 which are shaded depending on whether they are within the target blood glucose range or outside the target blood glucose range. In the embodiment shown in FIG. 42, the darker shaded meter readings 1321 are outside of the target blood glucose range of 70-140 mg/dL. The average readings 1315, 1316 are also shown.

In the embodiment illustrated in FIG. 42, several additional overlay charts are included. A bedtime to wake-up glucose chart 1330 is included, which shows the glucose readings and averages at the bedtime and wakeup ranges selected. Where there is a reading for a particular day at bedtime and at wakeup, a dashed line is shown between the two. This overlay may help show a user what is happening overnight to the patient. By providing a line connecting each of the sets of reading, the user can see the pattern, or lack of pattern, of change in blood glucose for the patient during the night. Also included are overlay glucose by meal charts 1350, which include overlays for each of the meal event ranges selected. Like in the bedtime to wake-up glucose chart 1330, related readings are shown as connected by dashed lines. The overlay glucose by meal charts 1350 align the time of meal for each of the days within the selected time period. Glucose readings for up to an hour prior to a meal are displayed. Alternatively, the most recent glucose reading prior to a meal could be displayed. The glucose reading could be from a glucose sensor or blood glucose meter, or both. Glucose readings for up to five hours after a meal are also shown. In alternative embodiments, the time before or after a meal that is displayed could be greater or smaller and could be customizable by a user. Averages within the meal event ranges in the overlay glucose by meal charts 1350 and in the bedtime to wake-up glucose chart 1340 are also shown using the same symbols 1315, 1316 as in the daily glucose chart 1310. Average readings 1315, 1316 are also shown of the bedtime to wake-up glucose chart 1330. The overlay glucose by meal charts 1350 each include the average carbohydrates 1352 consumed and the average insulin 1354 for each meal period. This will give the user an idea of the typical amount of carbohydrates eaten and insulin given during meal events. In the embodiment shown in FIG. 42, the readings in each meal event chart begin an hour prior to the meal event. By having overlays by bedtime to wake-up and by meal event, the DDMS allows the user to correlate the patient's blood glucose levels based upon everyday events, as opposed to over an entire 24 hour period that may have meal events at different times of the day. In further embodiments, there may be additional meal events, or fewer meal events, depending on how often the user or patient defines a meal event. In still further embodiments, other events, such as exercise events may be included in the reports. In still further embodiments, the overlays may exclude certain days, for example where a correction bolus was administered, to get a truer picture of what is happening at certain events.

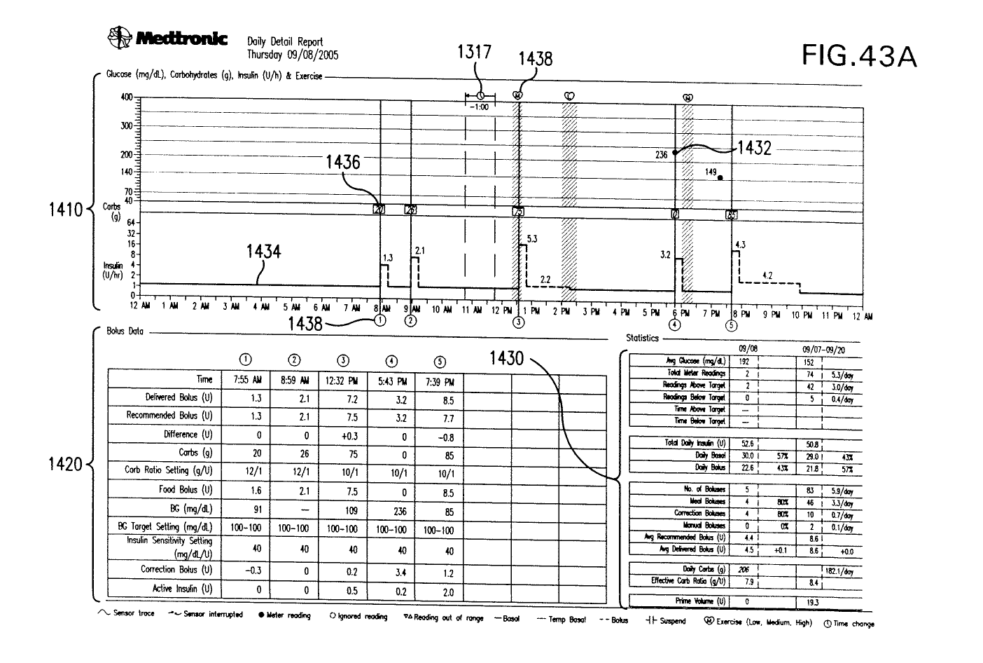

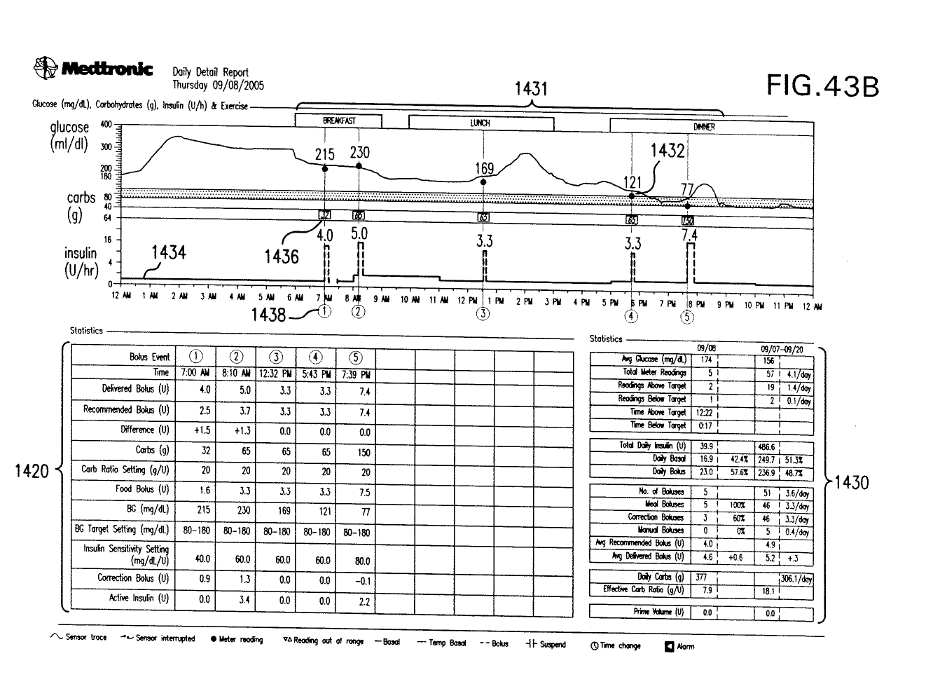

FIG. 43A illustrates a daily detail report in accordance with an embodiment of the present invention. The daily detail report shows data for a particular day, which may be selected in the earlier described selection menus. The embodiment shown in FIG. 43A includes a daily data chart 1410 that graphically shows glucose information, insulin information, and carbohydrate information, e.g., glucose readings 1432, insulin taken 1434, carbohydrates ingested 1436, and exercise 1438. The glucose readings 1432 display when glucose readings were taken and what they were. If they are within the selected target glucose range, in this embodiment 70-140 mg/dL, the glucose readings are shown in a darker shading, as in the overview report shown in FIG. 42. The insulin taken 1434 is shown along the whole 24 hours of the day. The insulin taken 1434 profile shows a basal profile as a solid line and boluses as dashed lines. Each bolus is matched with a number 1438, so that in this particular embodiment, five boluses are shown. The carbohydrates ingested 1436 are shown along a dark line that highlights that the carbohydrates are on a different scale than the insulin taken 1434 or the glucose readings 1432. In further embodiments, a patient may be receiving constant carbohydrates, for example in a hospital on a carbohydrate drip. Thus, the carbohydrates may be shown in a line similar to the insulin delivery 1434 line. Alternatively, a total amount of carbohydrates given throughout the day or the amount of carbohydrates given in addition to the carbohydrates ingested at discrete times could be shown along the same dark line as the rest of the carbohydrates ingested 1436. As in FIG. 42, time changes are shown by a time change symbol 1317. In further embodiments, if there is a suspension of the basal delivery it may be shown by a break in the insulin delivery 1434 line. The exercise 1438 indicators are shown with different letters based on the intensity of the exercise, for example “L” for low intensity, “M” for medium intensity, and “H” for high intensity. Other indicators may be used to show intensity of exercise, and there may be more or fewer intensities than the three shown in FIG. 43A. The daily data chart 1410 would also show a line indicating continuous-type sensor glucose readings if a sensor had been used. These types of continuous sensor glucose lines 1439 are illustrated in FIG. 43B. Thus, the user would be able to look at the continuous sensor glucose lines 1439 with the other glucose readings 1432 taken and see how all of the other data (carbohydrates, exercise, etc.) affects glucose levels on one chart. In FIG. 43B, meal event bands 1431 are also indicated so that the user may see what the graphical data looks like during meal events.

Also in FIG. 43A is a bolus data chart 1420. The bolus data chart 1420 includes a summary of data for each bolus, which was numbered in the daily data chart 1410. The bolus data chart 1420 includes the time of the bolus, the amount of units delivered in each bolus, the amount of units recommended to be delivered in each bolus, the difference between the amount of units delivered and the amount of units recommended in each bolus, the number of carbohydrates consumed at each bolus, the carbohydrate to insulin ratio setting at each bolus, the food bolus based on the carbohydrate to insulin ratio setting at each bolus, the blood glucose of the patient, the blood glucose target setting, the insulin sensitivity setting, any correction bolus that was necessary, and the active insulin.

Also in FIG. 43A is the statistic chart 1430 that summarizes the particular day of the daily report and the total selected period. The data included in the embodiment shown in FIG. 43A includes the average glucose, the total meter readings, the readings above the target, the readings below the target, if relevant the time above the target and the time below the target, the total daily insulin, the daily basal amount, the daily bolus amount, the number of boluses, the number of meal boluses, the number of correction boluses, the number of manual boluses, the average recommended boluses, the average delivered boluses, the daily carbohydrates ingested, the effective carbohydrate ratio (in grams per units), and the prime volume.

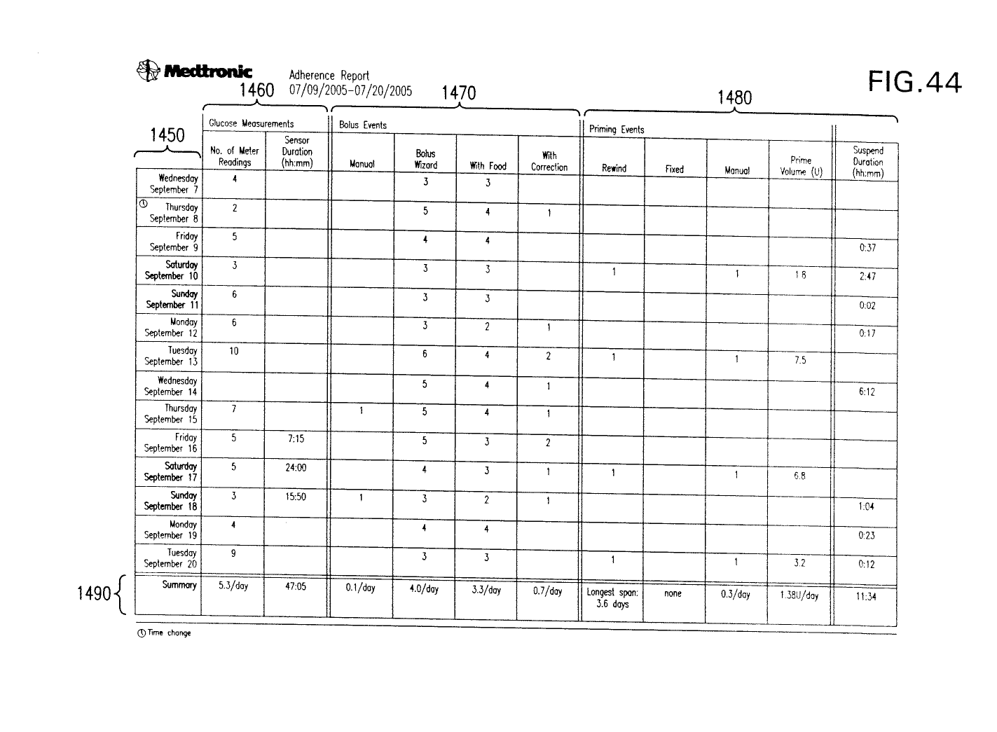

FIG. 44 shows an embodiment of an adherence report in accordance with the present invention. An adherence report may help to report the patient behavior and the patient's adherence to the prescribed regimen. The adherence report may include glucose measurement information, bolus information, priming event information, sensor duration information, and any other information that would assist a user in assessing the adherence of a patient, as well as any desired summary by day, week, month, or other desired time period. The adherence report includes data for each day 1450 in the selected period. The data for each day includes glucose measurement data 1460 which shows the number of meter readings taken on each day and the sensor duration on each day. The data for each day also includes bolus event data 1470, which shows the number of manual boluses, the number of bolus wizard boluses, the number of times a bolus was taken with food, and the number of times a bolus was taken as a correction. Although the bolus event data 1470 may alternatively show only generic bolus data, e.g. the total number of bolus events, by separating out correction and manual boluses, the DDMS helps highlight potential problems. For example, if a patient is giving themselves a lot of correction boluses in a day, there may be a problem with the program set up for them. The user may then, after viewing the adherence report, recommend changes for the patient's program to decrease the number of correction boluses the patient is taking. In further embodiments, the bolus event data 1470 may track delivery of oral medication and/or injections of medication as well. The data for each day also includes priming event data 1480, which includes the number of times the patient's pump was rewound, fixed, manually primed, the prime volume for all of the priming events of each day, and the total of suspend durations in hours:minutes (hh:mm) for any day. The rewind column may be important to inform the user whether the patient is waiting too long between changing infusion tips, which would involve a rewind at each change. In further embodiments, there may be a threshold of number of days between rewinds, where a flag of other indicator may highlight when a patient has not rewound the pump for more than a certain number of days, for example three or five days. The suspend duration may give an indication to a user of whether or not the patient is cheating by not keeping his/her medication pump on. For example, some people cease using their pumps to get a rush from too much blood sugar. By keeping track of suspend duration, the DDMS allows accountability for such cheating.

Finally, a summary 1490 is included for each type of data for the entire selected duration. Additionally, in the adherence report, there may be a summary of the number of test strips used during each day and/or the entire period, the number of infusion sets used during the period and/or how often the infusion set was changed, and the number of sensors used during the period and/or how often the sensor was changed. This data may help keep track of how often a patient needs to purchase new equipment. Additionally, there may be graphical or textual data indicating whether a patient was on a menstrual period during any of the days in the selected period of time. In further embodiments the user could choose to only see those days where the patient was on a menstrual period, or only those days that were weekends or weekdays.

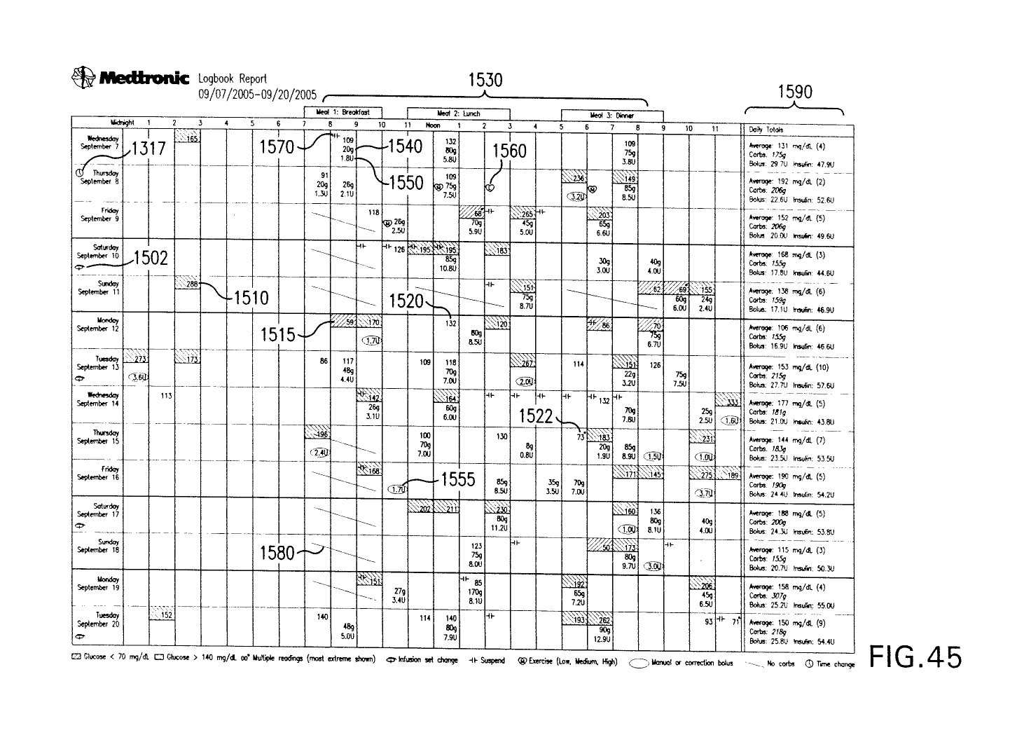

FIG. 45 shows an embodiment of a logbook report in accordance with the present invention. The logbook as shown includes hourly information for each day, which are taken from the data read into the DDMS, as opposed to having been entered in manually by the patient. Automatic population of a logbook avoids misrepresentation by patients or a scenario in which a patient forgets to enter data. The logbook shown includes various insulin information, carbohydrate information, and glucose information, in text and graphical format. Included are symbols representing any time change 1317 and representing any change of an infusion set 1502. Glucose measurements 1510, 1515, 1520 are shown in this embodiment as numbers representing the mg/dL of the glucose measurement taken. If multiple readings were taken within a particular hour in a particular day, the fact that there are multiple readings is indicated by an asterisk 1522. In the embodiment shown, the most extreme reading is shown when there are multiple readings, but it could be an average reading or an exemplary reading. By showing the most extreme reading, it is ensured that a user does not miss an outlying glucose reading. Moreover, it is likely that the most clinically significant numbers are the most extreme numbers. In further embodiments, those numbers that are lower than the target range are considered the most significant, so if there are multiple readings, the lowest number lower than the target range is reported. If there are no numbers lower than the target range, then the highest number higher than the target range is reported. The numbers may be shown in shaded boxes to represent that they are above or below the designated target glucose range. The shading is merely an illustration of how to designate that glucose values are above or below a designated range. Being outside the target range may be designated, for example, by bolded numbers, a symbol next to the numbers, or other methods. In the embodiment shown in FIG. 45, glucose values less than the target range of 70-140 mg/dL is in a dark shaded box, and glucose values above the target range are shown in a light shaded box. Glucose values within the target range are shown without shading. Also shown in the logbook are the meal events 1530 to illustrate the time periods designated as meal events. By having the meal events viewable, it is easy for the user to view the data that is within each meal event.

Also shown in the logbook in FIG. 45 are the carbohydrates ingested 1540 each time they have been recorded as having been ingested, and the number of units of insulin taken 1550 each time a bolus is administered. Whenever a bolus is a manual or correction bolus, the number is circled to so indicate 1555. A manual or correction bolus may be indicated in any other way, such as shading or another symbol. Also shown in FIG. 45 is a symbol every time the user's pump is suspended 1570. On days where no carbohydrates are ingested during a meal event, the lack of carbohydrates 1580 is indicated by a symbol. Daily totals 1590 are also shown, including the average glucose reading, the total carbohydrates ingested, the total amount of insulin taken and the total amount of insulin taken by bolus.

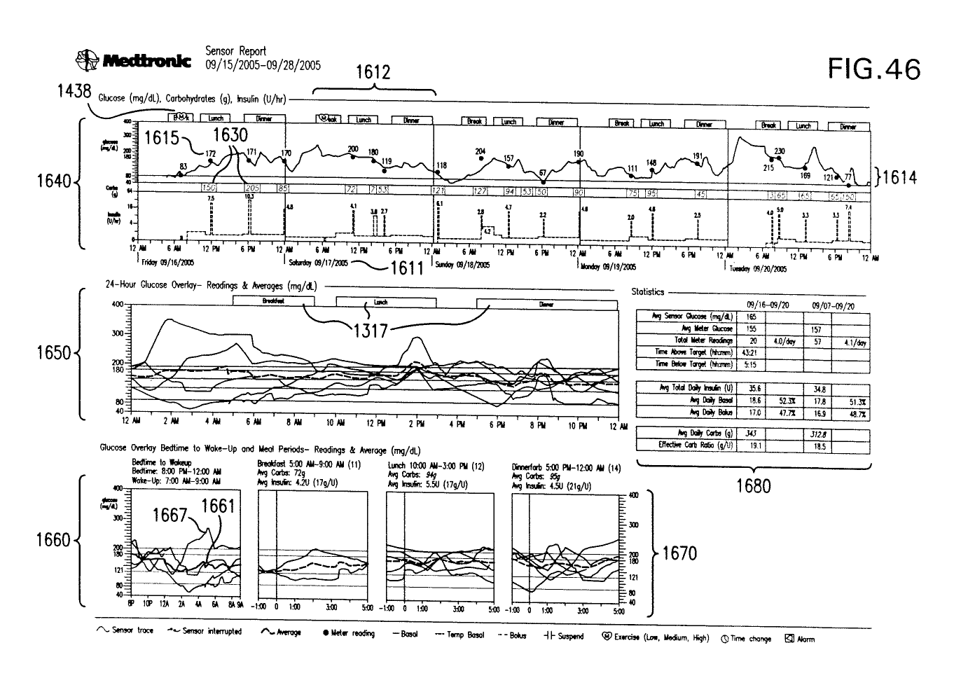

FIG. 46 illustrates a sensor report in accordance with an embodiment of the invention. The sensor report may include graphical and/or textual information about the sensor data that has been read into the DDMS. The sensor report may include carbohydrate information, glucose information, and insulin information, as discussed above, along with any other desired information. In the embodiment shown in FIG. 46, the sensor report includes a sensor data graph 1610. The sensor data graph 1610 includes information about glucose, carbohydrates, insulin, and exercise across a period of time. In the embodiment shown, five days are included on the sensor data graph 1610, but more or fewer days could be shown. The particular day shown 1611 is listed below the graph, but could be listed above or within the graph. In the embodiment shown weekend days are bolded, but this is not necessary. By bolding or otherwise highlighting weekend days, it becomes easier for the user to separate weekdays from weekends at a quick glance. The sensor data graph 1610 as shown includes meal event bars 1612 to highlight the times of the day that were meal events. In the embodiment shown, the meal event bars 1612 include 3 meal events, but there could be more or fewer meal events, depending on the settings. The meal event bars 1612 are labeled “breakfast,” “lunch,” and “dinner” in FIG. 46, but could be otherwise labeled, for example, “1,” “2,” and “3.” In the sensor data graph, the time change is also indicated by a time change arrow 1613 showing graphically how the time change fits into the sensor data graph 1610. The sensor data graph 1610 includes blood glucose readings 1614, 1615 from one or more blood glucose meters. As in other reports, the glucose readings 1614, 1615 may be shaded, or otherwise indicated, differently for glucose readings outside the target range 1615 and glucose readings within the target range 1614.

The sensor data graph 1610 includes a sensor data line 1620 that graphically shows data from the glucose sensor. As can be seen, the sensor data is from a continuous-type sensor, which may take sensor readings once every few minutes, such as five or ten minutes, or more or less frequently, such as once every few seconds, or once every few hours. In the embodiment shown in FIG. 46, the target blood glucose range is from 70 to 140 mg/dL. This range may be shaded, as shown in the figure, for ease of viewing by the user. In further embodiments, as shown in FIG. 46, the area between the sensor data line 1620 and the target blood glucose range may be shaded when the sensor data line 1620 is outside the target blood glucose range. Where there is no sensor data, the sensor data line 1620 may cease.

The sensor data graph 1610 may also include carbohydrate data 1630, for example the number of carbohydrates ingested. The sensor data graph 1610 may also include insulin data 1640, which includes insulin administered at basal rates and as boluses. Where there is a time change 1317, there may be no insulin data 1640, because the time of day may move forward as a result of the time change.

The sensor report may also include a 24-hour glucose overlay graph 1650, which includes an overlay of the sensor data for all days within the selected time period for reports. It is possible to have overlay graphs for fewer or more days, as desired. In the 24-hour glucose overlay graph 1650 shown in FIG. 46, the sensor data lines 1652 are shown for each of the days in the selected period for reports. The average sensor data line 1651 shows the average for all of the glucose readings during the selected period for reports. In FIG. 46, the target glucose range is from 70 to 140 mg/dL. In further embodiments, the area between a sensor data line 1652 and the target glucose range may be shaded. In still further embodiments, when multiple glucose data lines 1652 are not within the target glucose range, the shading may darken depending on how many of the areas between the sensor data lines 1652 and the target glucose range overlap. In this way, it is possible for a user to quickly see whether a patient tends to go outside of the target glucose range at a particular time. When the sensor is interrupted, the 24-hour glucose overlay may show a sensor interrupt symbol 1653, such as a small square. Also shown in this embodiment are the meal events 1317, which are labeled as “1: Breakfast,” “2: Lunch,” and “3: Dinner,” but may be labeled differently as desired.

The sensor report may also include an overnight glucose graph 1660, which shows an overlay of sensor glucose readings for “overnight.” Overnight may be, for example, 10:00 PM-8:00 AM, or any other range desired. It may be selectable by the user or preset. In the embodiment shown, the overnight glucose graph 1660 has the same set-up as the 24-hour glucose overlay graph 1650, with sensor data lines 1662 and an average sensor data line 1661. In further embodiments, the sensor report includes glucose overlay by meal graphs 1670. The glucose overlay by meal graphs 1670 have the same set-up as the 24-hour glucose overlay graph 1650, with sensor data lines 1672 and an average sensor data line 1671. Where data does not exist for a particular meal, the glucose overlay by meal graph 1670 may be empty.

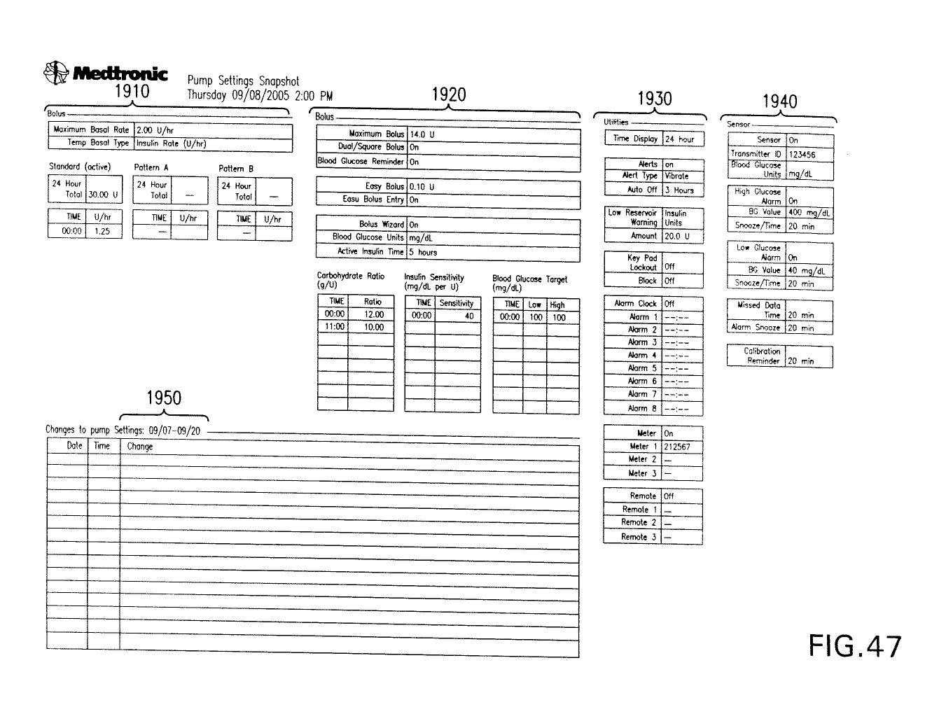

FIG. 47 illustrates a pump settings snapshot for a particular day. The pump settings snapshot includes a basal snapshot 1910, which shows the maximum basal rate for the particular day and the temporary basal rate type for the day. In some pumps there may be programmed more than one basal profile, for example as shown in FIG. 47 a standard, pattern a, and pattern b profile. The basal snapshot 1910 includes data to show the 24 hour total of insulin delivered for each total, and the number of units per hour given during time ranges in each of the profiles.

The pump settings snapshot shown in FIG. 47 also includes a bolus snapshot 1920. The bolus snapshot 1920 may include a maximum bolus delivered. It may include an indication of what type of bolus was delivered, for example if a dual or square wave bolus was delivered (e.g., by an “on” or “off” indication). It may also include an indication of whether a blood glucose reminder was on or off. The bolus snapshot 1920 may further include an indication of how many units are given in an “easy bolus” setting, and whether the easy bolus entry was on or off. The bolus snapshot 1920 may further include an indication of whether the bolus wizard was on or off during the day, the units of blood glucose, and the active insulin time. The bolus snapshot 1920 may further include the carbohydrate to insulin ratio at certain times, the insulin sensitivity at particular times, and the blood glucose target at particular times.

The pump settings snapshot also includes a utilities snapshot 1930 for the day. The utilities snapshot 1930 may include the time display, such as 24 hour or 12 hour, whether alerts were on or off, the type of alert, such as vibrate or audible, and how long the alarm is activated until it automatically turns off. The utilities snapshot 1930 may further include an indication of what type of low reservoir warning is set up, e.g., insulin units, and the threshold for setting off the low reservoir warning, e.g., 20.0 U. The utilities snapshot may further include an indication of whether or not the keypad lockout is on, for example if a user likes to carry the device in his/her pocket, it may be desirable to lockout the keypad to avoid accidentally entering values. The utilities snapshot may also include an indication of whether or not a block is on, which would indicate that someone has blocked the keypad from being used. The block feature may be used by a parent, guardian, or doctor to prevent a child from using the keypad. The utilities display 1930 may further include data regarding an alarm clock, for example whether an alarm clock is activated and what, if any alarm times are set up. In the embodiment shown in FIG. 47, eight potential alarms are shown, but there may be more or fewer alarms in a particular setting. The utilities display 1930 may also show meter data, for example, whether one or more blood glucose meters were on, and the identification number of any blood glucose meters. The utilities display 1930 may also show remote data, for example, whether one or more remotes were on, and the identification number of any remotes.

In FIG. 47, the pump settings snapshot also includes a sensor snapshot 1940. The sensor snapshot 1940 may include sensor data, for example, whether or not the sensor was on, the transmission identification number of the sensor and the units set up for blood glucose. The sensor snapshot 1940 may also include information indicating whether a high glucose alarm was on or off, the blood glucose value that is the threshold value for the high glucose alarm, and the snooze time for the high glucose alarm. The sensor snapshot 1940 may also include information indicating whether a low glucose alarm was on or off, the blood glucose value that is the threshold value for the low glucose alarm, and the snooze time for the low glucose alarm. The sensor snapshot 1940 may also include an indication of how many minutes glucose data was missing for, and how many minutes an alarm was snoozed. The sensor snapshot 1940 may also include the length of time for reminding the patient of need for calibration.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. A computing device to generate a diabetes management report for a patient, comprising:
a processor for executing computer instructions;
a database including infusion pump information, wherein the infusion pump information includes bolus event information and priming event information;
a display for displaying a report including information presented in a plurality of separately identifiable regions, a first region including a representation of the bolus event information and a second region including a representation of the priming event information; and
a computer readable storage medium containing executable computer program instructions, which when executed by the processor cause the report to be generated on the display.

2. The computing device of claim 1, wherein the bolus event information includes at least one type of information selected from the group consisting of manual bolus event information and correction bolus event information.

3. The computing device of claim 2, wherein the bolus event information further includes at least one type of information selected from the group consisting of bolus wizard event information and bolus with food event information.

4. The computing device of claim 1, wherein the priming event information includes at least one type of information selected from the group consisting of rewind information, fixed priming information, manual priming information, prime volume information, and suspend duration information.

5. The computing device of claim 4, wherein the infusion pump information further includes glucose information indicating the number of glucose readings taken during a report time period and the display includes a third region indicating a representation of the glucose information.

6. A program code storage device, comprising:
a computer-readable storage medium;
computer-readable program code, the computer-readable program code including instructions, which when executed cause a computing device to:
receive medical information including infusion pump information, wherein the infusion pump information includes bolus event information and priming event information; and
display a report including information presented in a plurality of separately identifiable regions, a first region including a representation of the bolus event information and a second region including a representation of the priming event information.

7. The program code storage device of claim 6, wherein the bolus event information includes at least one type of information selected from the group consisting of manual bolus event information and correction bolus event information.

8. The program code storage device of claim 6, wherein the bolus event information further includes at least one type of information selected from the group consisting of bolus wizard event information and bolus with food event information.

9. The program code storage device of claim 8, wherein the priming event information includes at least one type of information selected from the group consisting of rewind information, fixed priming information, manual priming information, prime volume information, and suspend duration information.

10. The program code storage device of claim 6, wherein the infusion pump information further includes glucose information indicating the number of glucose readings taken during a report time period, and the display includes a third region indicating a representation of the glucose information.
